(19) United States
(12) Patent Application Publication
(10) Pub. No.: US 2005/0095492 A1
(43) Pub. Date: May 5, 2005

(54) Fuel cell stack

(75) Inventors: David Frank, Scarborough (CA); Mario Dzamarija, Toronto (CA); Raymond Candido, Toronto (CA); Nathaniel Ian Joos, Toronto (CA); Antonio Gennaro Mazza, Whitby (CA)

Correspondence Address: BERESKIN AND PARR, 40 KING STREET WEST, BOX 401, TORONTO, ON, M5H 3Y2, CA

(73) Assignee: Hydrogenics Corporation, Mississauga (CA)

(21) Appl. No.: 10/948,651

(22) Filed: Sep. 24, 2004

Related U.S. Application Data
(63) Continuation-in-part of application No. 09/854,362, filed on May 15, 2001, now Pat. No. 6,852,439.
(63) Continuation-in-part of application No. 10/762,729, filed on Jan. 23, 2004.

(51) Int. Cl. H01M 2/08; H01M 8/02

(52) U.S. Cl. 429/35; 429/39

(57) ABSTRACT

A sealing technique is provided for forming complex and multiple seal configurations for fuel cells and other electrochemical cells. To provide a seal, for sealing chambers for oxidant, fuel and/or coolant, a groove network is provided extending through the various elements of the fuel cell assembly and a seal material is then injected into the groove network. Several structural improvements have been made to cell components in relation to this seal in place process to reduce manufacturing cost and improve the performance of the electrochemical cells.

### CROSS-REFERENCE TO RELATED APPLICATIONS

This application claims priority from U.S. patent application Ser. No. 09/854,362 filed on May 15, 2001 and from U.S. patent application Ser. No. 10/762,729 filed on Jan. 23, 2004.

### FIELD OF THE INVENTION

This invention relates to fuel cells, and more particularly is concerned with a fuel cell stack having enhanced fuel cell components for improved operation.

### BACKGROUND OF THE INVENTION

There are various known types of fuel cells. One form of fuel cell that is currently believed to be practical for usage in many applications is a fuel cell employing a proton exchange membrane (PEM). A PEM fuel cell enables a simple, compact fuel cell to be designed, which is robust, which can be operated at temperatures not too different from ambient temperatures and which does not have complex requirements with respect to fuel, oxidant and coolant supplies.

Conventional fuel cells generate relatively low voltages. In order to provide a useable amount of power, fuel cells are commonly configured into fuel cell stacks, which typically may have 10, 20, 30 or even 100's of fuel cells in a single stack. While this does provide a single unit capable of generating useful amounts of power at usable voltages, the design can be quite complex and can include numerous elements, all of which must be carefully assembled.

For example, a conventional PEM fuel cell requires two flow field plates, an anode flow field plate and a cathode flow field plate. A membrane electrode assembly (MEA), including the actual proton exchange membrane is provided between the two plates. Additionally, a gas diffusion media (GDM) is provided, sandwiched between each flow field plate and the proton exchange membrane. The gas diffusion media enables diffusion of the appropriate gas, either the fuel or oxidant, to the surface of the PEM, and at the same time provides for conduction of electricity between the associated flow field plate and the PEM.

This basic cell structure itself requires two seals, each seal being provided between one of the flow field plates and the PEM. Moreover, these seals have to be of a relatively complex configuration. In particular, as detailed below, the flow field plates, for use in the fuel cell stack, have to provide a number of functions and a complex sealing arrangement is required.

For a fuel cell stack, the flow field plates typically provide apertures or openings at either end, so that a stack of flow field plates then define elongate channels extending perpendicularly to the flow field plates. As a fuel cell requires flows of a fuel, an oxidant and a coolant, this typically requires three pairs of ports or six ports in total. This is because it is necessary for the fuel and the oxidant to flow through each fuel cell. A continuous flow through ensures that, while most of the fuel or oxidant as the case may be is consumed, any contaminants are continually flushed through the fuel cell.

The foregoing assumes that the fuel cell would be a compact type of configuration provided with water or the like as a coolant. There are known stack configurations, which use air as a coolant, either relying on natural convection or by forced convection. Such fuel cell stacks typically provide open channels through the stacks for the coolant, and the sealing requirements are lessened. Commonly, it is then only necessary to provide sealed supply channels for the oxidant and the fuel.

Consequently, each flow field plate typically has three apertures at each end, each aperture representing either an inlet or outlet for one of fuel, oxidant and coolant. In a completed fuel cell stack, these apertures align, to form distribution channels extending through the entire fuel cell stack. It will thus be appreciated that the sealing requirements are complex and difficult to meet. However, it is possible to have multiple inlets and outlets to the fuel cell for each fluid depending on the stack/cell design. For example, some fuel cells have 2 inlet ports for each of the anode, cathode and coolant, 2 outlet ports for the coolant and only 1 outlet port for each of the cathode and anode. However, any combination can be envisioned.

For the coolant, this commonly flows across the back of each fuel cell, so as to flow between adjacent, individual fuel cells. This is not essential however and, as a result, many fuel cell stack designs have cooling channels only at every 2nd, 3rd or 4th (etc.) plate. This allows for a more compact stack (thinner plates) but may provide less than satisfactory cooling. This provides the requirement for another seal, namely a seal between each adjacent pair of individual fuel cells. Thus, in a completed fuel cell stack, each individual fuel cell will require two seals just to seal the membrane electrode assembly to the two flow field plates. A fuel cell stack with 30 individual fuel cells will require 60 seals just for this purpose. Additionally, as noted, a seal is required between each adjacent pair of fuel cells and end seals to current collectors. For a 30 cell stack, this requires an additional 31 seals. Thus, a 30 cell stack would require a total of 91 seals (excluding seals for the bus bars, current collectors and endplates), and each of these would be of a complex and elaborate construction. With the additional gaskets required for the bus bars, insulator plates and endplates the number reaches 100 seals, of various configurations, in a single 30 cell stack.

Commonly the seals are formed by providing channels or grooves in the flow field plates, and then providing prefabricated gaskets in these channels or grooves to effect a seal. In known manner, the gaskets (and/or seal materials) are specifically polymerized and formulated to resist degradation from contact with the various materials of construction in the fuel cell, various gasses and coolants which can be aqueous, organic and inorganic fluids used for heat transfer. However, this means that the assembly technique for a fuel cell stack is complex, time consuming and offers many opportunities for mistakes to be made. Reference to a resilient seal here refers typically to a floppy gasket seal molded separately from the individual elements of the fuel cells by known methods such as injection, transfer or compression molding of elastomers. By known methods, such as insert injection molding, a resilient seal can be fabricated on a plate, and clearly assembly of the unit can then be simpler, but forming such a seal can be difficult and expensive due to inherent processing variables such as mold wear, tolerances in fabricated plates and material changes. In addition custom made tooling is required for each seal and plate design.

An additional consideration is that formation or manufacture of such seals or gaskets is complex. There are typically two known techniques for manufacturing them.

For the first technique, the individual gasket is formed by molding in a suitable mold. This is relatively complex and expensive. For each fuel cell configuration, it requires the design and manufacture of a mold corresponding exactly to the shape of the associated grooves in the flow field plates. This does have the advantage that the designer has complete freedom in choosing the cross-section of each gasket or seal, and in particular, it does not have to have a uniform thickness.

A second, alternative technique is to cut each gasket from a solid sheet of material. This has the advantage that a cheaper and simpler technique can be used. It is simply necessary to define the shape of the gasket, in a plan view, and to prepare a cutting tool to that configuration. The gasket is then cut from a sheet of the appropriate material of appropriate thickness. This does have the disadvantage that, necessarily, one can only form gaskets having a uniform thickness. Additionally, it leads to considerable wastage of material. For each gasket, a portion of material corresponding to the area of a flow field plate must be used, yet the surface area of the seal itself is only a small fraction of the area of the flow field plate.

A fuel cell stack, after assembly, is commonly clamped to secure the elements and ensure that adequate compression is applied to the seals and active area of the fuel cell stack. This method ensures that the contact resistance is minimized and the electrical resistance of the cells are at a minimum. To this end, a fuel cell stack typically has two substantial end plates, which are configured to be sufficiently rigid so that their deflection under pressure is within acceptable tolerances. The fuel cell also typically has current bus bars to collect and concentrate the current from the fuel cell to a small pick up point and the current is then transferred to the load via conductors. Insulation plates may also be used to isolate, both thermally and electrically, the current bus bars and endplates from each other. A plurality of elongated tension rods, bolts and the like are then provided between the pairs of plates, so that the fuel cell stack can be clamped together between the plates, by the tension rods. Rivets, straps, piano wire, metal plates and other mechanisms can also be used to clamp the stack together. To assemble the stack, the rods are provided extending through one of the end plates. An insulator plate and then a bus bar (including seals) are placed on top of the endplate, and the individual elements of the fuel cell are then built up within the space defined by the rods or defined by some other positioning tool. This typically requires, for each fuel cell, the following steps:
(a) placing a first seal to separate the fuel cell from the preceding fuel cell;
(b) locating a first flow field plate on the first seal;
(c) locating a second seal on the first flow field plate;
(d) placing a GDM within the second seal on the first flow field plate;
(e) locating an MEA on the second seal;
(f) placing an additional GDM on top of the MEA; and,
(g) preparing a second flow field plate with a seal and placing this on top of the additional GDM, while ensuring the seal of the second plate falls around the additional GDM.

This process needs to be repeated until the last fuel cell is formed and it is then topped off with a bus bar, insulator plate and the final end plate.

It will be appreciated that each seal has to be carefully placed, and the installer has to ensure that each seal is fully and properly engaged in its sealing groove. It is very easy for an installer to overlook the fact that a small portion of a seal may not be properly located. The seal between adjacent pairs of fuel cells, for the coolant area, may have a groove provided in the facing surfaces of the two flow field plates. Necessarily, an installer can only locate the seal in one of these grooves, and must rely on feel or the like to ensure that the seal properly engages in the groove of the other plate during assembly. It is practically impossible to visually inspect the seal to ensure that it is properly seated in both grooves.

As mentioned, it is possible to mold seals directly onto the individual cells. While this does offer an advantage during assembly when compared to floppy seals, such as better tolerances and improved part allocation, it still has many disadvantages over the technique of the present invention namely, alignment problems with the MEA, multiple seals and molds required to make the seals. In addition, more steps are required for a completed product than the methods proposed by the present invention.

Thus, it will be appreciated that assembling a conventional fuel cell stack is difficult, time consuming, and can often lead to sealing failures. After a complete stack is assembled, it is tested, but this itself can be a difficult and complex procedure. Even if a leak is detected, this may initially present itself simply as an inability of the stack to maintain pressure of a particular fluid, and it may be extremely difficult to locate exactly where the leak is occurring, particularly where the leak is internal. Even so, the only way to repair the stack is to disassemble it entirely and to replace the faulty seal. This will result in disruption of all the other seals, so that the entire stack and all the different seals then have to be reassembled, again presenting the possibility of misalignment and failure of any one seal.

A further problem with conventional techniques is that the clamping pressure applied to the entire stack is, in fact, intended to serve two quite different and distinct functions. These are providing a sufficient pressure to ensure that the seals function as intended, and to provide a desired pressure or compression to the gas diffusion media, sandwiched between the MEA itself and the individual flow field plates. If insufficient pressure is applied to the GDM, then poor electrical contact is made; on the other hand, if the GDM is over compressed, flow of gas can be compromised. Unfortunately, in many conventional designs, it is only possible to apply a known, total pressure to the overall fuel cell stack. There is no way of knowing how this pressure is divided between the pressure applied to the seals and the pressure applied to the GDM. In conventional designs, this split in the applied pressure depends entirely upon the design of the individual elements in the fuel cell stack and maintenance of appropriate tolerances. For example, the GDM commonly lie in center portions of flow field plates, and if the depth of each center portion varies outside acceptable tolerances, then this will result in incorrect pressure being applied to the GDM. This depth may depend to what extent a gasket is compressed also, affecting the sealing properties, durability and lifetime of the seal.

For all these reasons, manufacture and assembly of conventional fuel cells is time consuming and expensive. More particularly, present assembly techniques are entirely unsuited to large-scale production of fuel cells on a production line basis.

### SUMMARY OF THE INVENTION

In accordance with a first aspect, at least one embodiment of the invention provides an electrochemical cell assembly comprising a plurality of separate elements; at least one groove network extending through a portion of the electrochemical cell assembly and including at least one filling port for the at least one groove network; and, a seal within the at least one groove network that has been formed in place after assembly of the separate elements, wherein the seal provides a barrier between at least two of the separate elements to define a chamber for a fluid for operation of the electrochemical cell. The at least one groove network comprises a plurality of closed groove segments, each of which comprises at least a groove segment in one of the separate elements that faces and is closed by another of the separate elements, the volume of the closed groove segments being substantially similar such that each of the groove segments fills at the same rate.

In accordance with a second aspect, at least one embodiment of the invention provides an electrochemical cell assembly comprising a plurality of separate elements; at least one groove network extending through a portion of the electrochemical cell assembly and including at least one filling port for the at least one groove network; and, a seal within the at least one groove network that has been formed in place after assembly of the separate elements, wherein the seal provides a barrier between at least two of the separate elements to define a chamber for a fluid for operation of the electrochemical cell. The at least one groove network comprises a plurality of closed groove segments including a first groove segment on one side of one of the separate elements offset from a corresponding groove segment on the other side of the one of the separate elements or a facing side of adjacent one of the separate elements.

In accordance with another aspect, at least one embodiment of the invention provides a flow field plate for an electrochemical cell assembly comprising at least two apertures for reactant gas flow; reactant gas flow channels on a front face including inlet distribution channels, primary flow channels and outlet collection channels, the inlet distribution and outlet collection channels being connected by the primary flow channels; and, a feed structure connecting the inlet distribution channels to one of the at least two apertures and the outlet collection channels to another of the at least two apertures. The feed structure includes a plurality of backside feed channels located on the rear face of the flow field plate and a single slot from the front face to the rear face of the flow field plate, the plurality of backside feed channels extending from the single slot to a corresponding one of the at least two apertures and the inlet distribution channels extending from the primary flow channels to the single slot.

In accordance with yet another aspect, at least one embodiment of the invention provides an electrochemical cell assembly comprising an anode flow field plate and a cathode flow field plate, each of the flow field plates including at least two apertures for reactant gas flow; reactant gas flow channels on a front face including inlet distribution channels, primary flow channels and outlet collection channels, the inlet distribution and outlet collection channels being connected by the primary flow channels; and, a feed structure connecting the inlet distribution channels to one of the at least two apertures and the outlet collection channels to another of the at least two apertures. For one of the flow field plates the feed structure includes a plurality of backside feed channels located on the rear face of the flow field plate and a first slot from the front face to the rear face of the one of the flow field plates, the plurality of backside feed channels extending from the slot to a corresponding one of the at least two apertures and one of the inlet distribution channels and outlet collection channels extending from the primary flow channels to the slot, and wherein for another of the flow field plates the feed structure includes a second slot and an aperture extension, the backside feed channels being provided by the one of the flow field plates.

### BRIEF DESCRIPTION OF THE DRAWING FIGURES

For a better understanding of the present invention and to show more clearly how it may be carried into effect, reference will now be made to the accompanying drawings which show, by way of example, preferred embodiments of the invention and in which:

FIG. 1a shows, schematically, a sectional view through part of a fuel cell stack in accordance with a first embodiment of the invention;

FIGS. 1b-1e show various seal arrangements for use in the embodiment of FIG. 1, and other embodiments, of the invention;

FIG. 2 shows, schematically, a sectional view through part of a fuel cell stack in accordance with a second embodiment of the invention;

FIG. 3 shows a sectional view of an assembly device, for assembling a fuel cell stack in accordance with a further embodiment of the invention;

FIG. 4 shows an isometric view of a fuel cell stack in accordance with a fourth embodiment of the invention;

FIG. 5 shows an isometric exploded view of the fuel cell stack of FIG. 4, to show individual components thereof;

FIGS. 6a and 6b show, respectively, a twenty cell and a one hundred cell fuel cell stack according to the fourth embodiment of the present invention;

FIGS. 7 and 8 show, respectively, front and rear views of an anode bipolar flow field plate of the fuel cell stack of FIGS. 5 and 6;

FIGS. 9 and 10 show, respectively, front and rear views of a cathode bipolar flow field plate of the fuel cell stack of FIGS. 5 and 6;

FIG. 11 shows a rear view of an anode end plate;

FIG. 12 shows a view, on a larger scale, of a detail 12 of FIG. 11;

FIG. 13 shows a cross-sectional view along the lines 13 of FIG. 12;

FIG. 14 shows a rear view of a cathode end plate;

FIG. 15 shows a view, on a larger scale, of a detail 15 of FIG. 14;

FIGS. 16a and 16b show schematically different configurations for pumping elastomeric sealing material into a fuel cell stack;

FIG. 17 shows a variant of one end of the front face of the anode bipolar flow field plate, the other end corresponding;

FIG. 18 shows a variant of one end of the rear face of the anode bipolar flow field plate, the other end corresponding;

FIG. 19 shows a variant of one end of the front face of the cathode bipolar flow field plate, the other end corresponding;

FIG. 20 shows a variant of one end of the rear face of the cathode bipolar flow field plate, the other end corresponding;

FIG. 21 is a perspective, cut-away view showing details at the end of one of the plates, showing the variant plates;

FIG. 22 shows an isometric exploded view of an alternative embodiment of a fuel cell stack in accordance with the invention;

FIGS. 23a and 23b show, respectively, front and rear views of a cathode insulator plate of the fuel cell stack of FIG. 22;

FIGS. 24a and 24b show, respectively, front and rear views of a cathode current collector plate of the fuel cell stack of FIG. 22;

FIGS. 25a and 25b, show, respectively, front and rear views of a cathode end plate of the fuel cell stack of FIG. 22;

FIG. 25c shows an enlarged view of a flanged connection employed by the cathode end plate of the fuel cell stack of FIG. 22;

FIGS. 26a and 26b show, respectively, front and rear views of an anode flow field plate of the fuel cell stack of FIG. 22 FIGS. 27a and 27b show, respectively, front and rear views of a cathode flow field plate of the fuel cell stack of FIG. 22; and,

FIG. 28 is a rear view of an alternative embodiment of a cathode flow field plate that may be used in the fuel cell stack of FIG. 22.

### DESCRIPTION OF THE PREFERRED EMBODIMENT

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. In addition, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention.

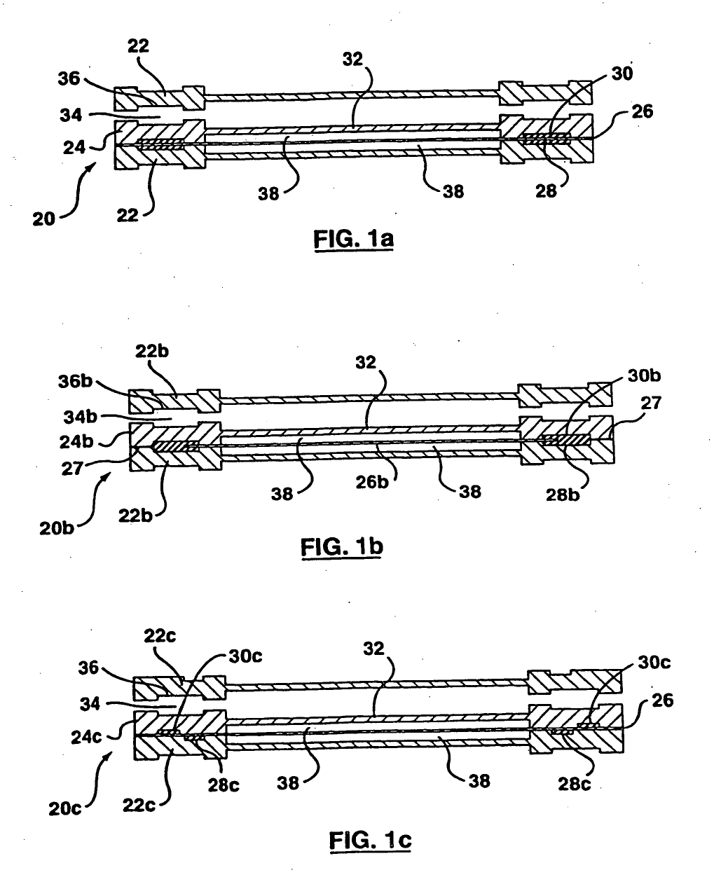

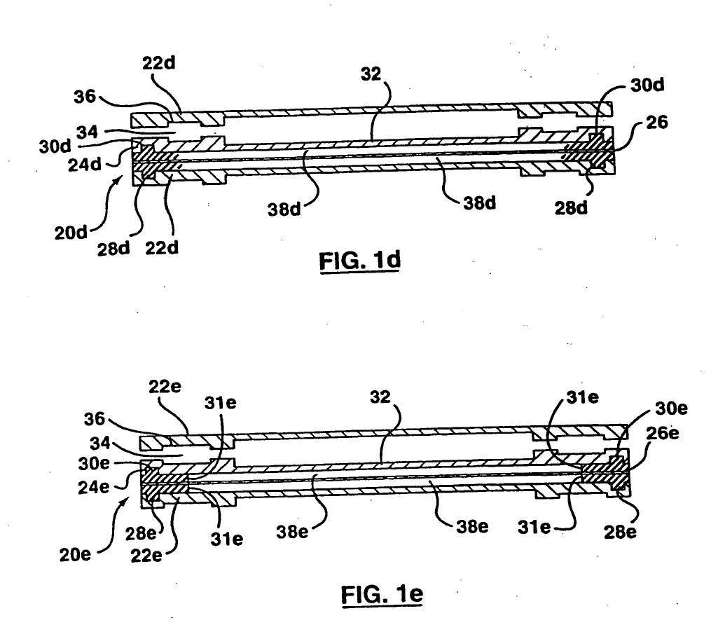

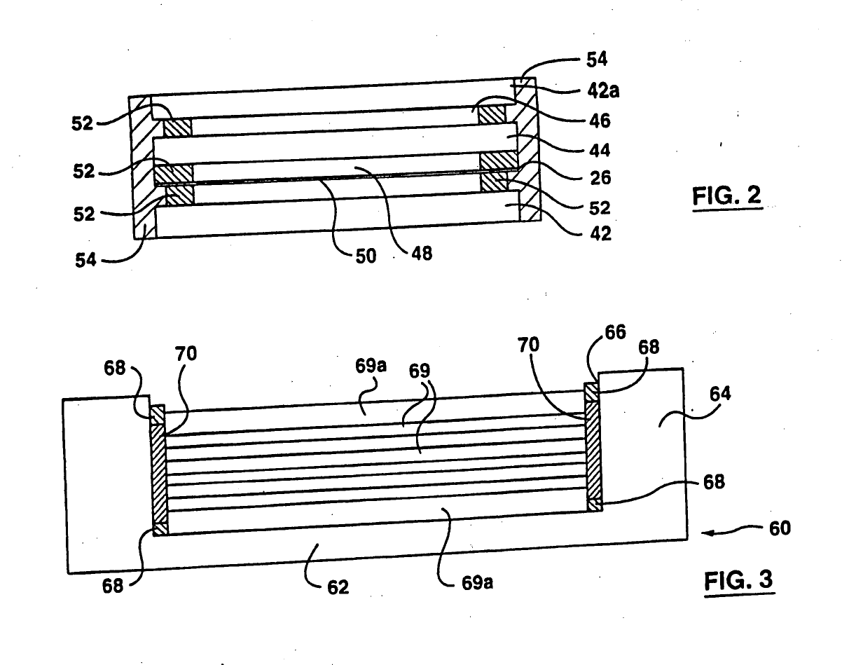

The first embodiment of the apparatus is shown in FIG. 1a and indicated generally by the reference 20. For simplicity, this Figure shows just part of a fuel cell stack, as does FIG. 2. It will be understood that the other fuel cells in the stack correspond, and that the fuel cell stack would include conventional end elements, clamping elements and the like. In general, FIGS. 1a-3 are intended to indicate the essential elements of the individual embodiments of the invention, and it will be understood by someone skilled in this art that the fuel cell stacks would be otherwise conventional. Also in FIGS. 1a-e and 2, the proton exchange membrane is shown, for clarity, with exaggerated thickness, and as is known, it has a small thickness. In FIGS. 1a-e, the grooves for the seal material are shown schematically, and it is expected that the grooves will usually have a depth and width that are similar, i.e. a generally square cross-section. Note also that the bottom of the grooves can have any desired profile.

The first embodiment 20 shows a fuel cell including an anode bipolar plate 22 and a cathode bipolar plate 24. In known manner, sandwiched between the bipolar plates 22, 24 is a membrane electrode assembly (MEA) 26. In order to seal the MEA, each of the bipolar plates 22, 24 is provided with a respective groove 28, 30. This is a departure from conventional practice, as it is common to provide the flow plates with channels for gases but with no recess for gas diffusion media (GDM) or the like. Commonly, the thickness of seals projecting above the flow plates provides sufficient space to accommodate the GDM. Here, the flow plates are intended to directly abut one another, thereby giving much better control on the space provided for a complete MEA 26 and hence the pressure applied to the GDM. This should ensure better and more uniform performance from the GDM.

As in conventional fuel cells, the MEA is considered to comprise a total of three layers, namely: a central proton exchange membrane layer (PEM); on both sides of the PEM, a layer of a finely divided catalyst, to promote reaction necessary on either side of the PEM. There are also two layers of gas diffusion media (GDM) located on either side of the PEM abutting the catalyst layers, and usually maintained pressed against the catalyst layers to ensure adequate electrical conductivity, but these two layers of GDM are not considered to be part of the MEA itself.

As shown for the cathode bipolar plate 24, this has a rear face that faces the rear face of another anode bipolar plate 22 of an adjacent fuel cell, to define a coolant channel 32. To seal the cathode bipolar plate 24 and the upper anode bipolar plate 22, again, grooves 34 and 36 are provided.

It will be understood that the anode and cathode bipolar plates 22, 24 define a chamber or cavity for receiving the MEA 26 and for gas distribution media (GDM) on either side of the MEA. The chambers or cavities for the GDM are indicated at 38.

Conventionally, for each pair of grooves 28, 30 and 34, 36, some form of pre-formed gasket will be provided. Now, in accordance with the present invention, the various grooves are connected together by suitable conduits to form a continuous groove or channel. Then, a seal material is injected through these various grooves, so as to fill the grooves entirely. The sealant is then cured, e.g. by subjecting it to a suitable elevated temperature, to form a complete seal. This has a number of advantages. It does not require any pre-formed gasket to be formed, and as noted, this is identified as a “seal in place” construction. Yet, at the same time, the final seal can take on any desired shape, and in particular, can flow to fill in imperfections and allow for variations in tolerances on the various components.

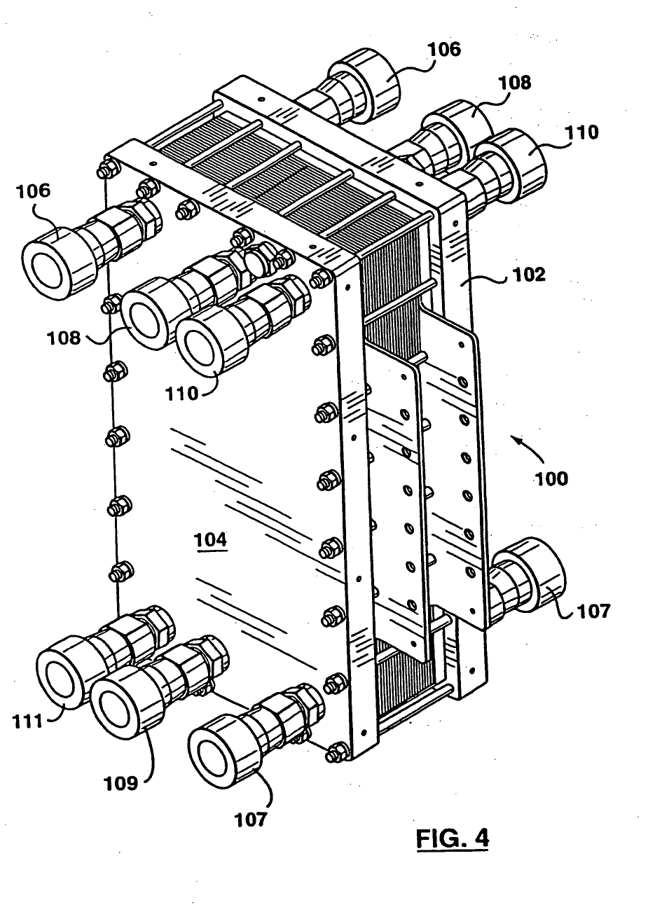

It will be appreciated that FIG. 1a is intended simply to show the basic principle behind the invention, and does not show other elements essential for a complete fuel cell stack. For example, FIG. 1a does not address the issue of providing flows of gases and coolant to the individual fuel cells. The sealing technique of FIG. 1a is incorporated in the embodiment of FIG. 4 and later Figures, and these further aspects of the invention are further explained in relation to those Figures.

FIG. 2 shows an alternative arrangement. Here, the anode and cathode bipolar plates are indicated at 42, 44 and 42a, corresponding to plates 22, 24 and 22a of FIG. 1a. The MEA is again indicated at 26. A coolant cavity is formed at 46, and cavities or chambers 48, 50 are provided for the GDM.

Here, as for FIG. 1a, the plates 42, 44 are designed to provide various cavities or grooves for seals 52 to be formed. Thus, a lowermost seal 52 provides a seal between the MEA 26 and the anode bipolar plate 42. On top of the MEA 26, a further seal 52 provides a seal to the cathode bipolar plate 44. These seals 52 are formed as in FIG. 1a, by first providing a network of grooves or channels across the flow field plate surface.

Now, in accordance with this second embodiment of the present invention, to provide an additional seal and additional security in sealing, a seal-in-place seal 54 is provided around the entire exterior of the fuel cell stack, as indicated. As for FIG. 1a, conventional ports and openings (not shown) is provided for flow of gases and coolant to the fuel cell stack. To form this seal, the entire stack is enclosed and ports and vents are provided to enable seal material to be injected to form the outer seal 54 and all the inner seals simultaneously. For this purpose, communication channels and ducts are provided between the grooves for the seals 52 and the exterior of stack where the seal 54 is formed. As before, once the material has been injected, it is cured at room (ambient) temperature or by heating at an elevated temperature. The final sealing material on the surface of the stack will serve two purposes, namely to seal the entire stack, and to electrically insulate the fuel cell stack.

In a variant of the FIG. 2 arrangement, rather than provide complete enclosed grooves, the grooves are open to sides of the fuel cell stack. Then, to form the seals, the sides of the fuel cell stack are closed off by a mold or the like, somewhat as in FIG. 3 (described below), but without providing any space for a complete external seal around the whole fuel cell stack.

FIG. 3 shows an assembly device indicated generally at 60, for forming a seal, somewhat as for the embodiment of FIG. 2. Here, it is anticipated that a fuel cell stack will first be assembled following known practice, but without inserting any seals. Thus, the various elements of the stack, principally the flow field plates and the MEAs will be sequentially assembled with appropriate end components. To align the components, clamping rods can be used by first attaching these to one end plate, or the components can be assembled in a jig dimensioned to ensure accurate alignment. Either way, with all the components in place the entire assembly is clamped together, commonly by using clamping rods, as mentioned, engaging both end plates. The assembly device 60 has a base 62 and a peripheral wall 64 defining a well 66. Additionally, there are upper and lower projections 68, for engaging the end plates to locate a fuel cell stack in position. Although FIG. 3b shows the projections 68 on just two sides of the fuel cell stack, it will be understood that they are provided on all four sides.

Then, an assembly of elements for a fuel cell stack comprising cathode and anode plates, MEAs, insulators, current bus bars, etc. is positioned within the well 66, with the projections 68 ensuring that there is a space around all of the anode and cathode plates and around at least parts of the end plates. Current collector plates usually have projecting tabs, for connection to cables etc. and accommodation and seals are provided for these. The various layers or plates of the stack are indicated schematically at 69 in FIG. 3, with the end plates indicated at 69a.

Then, in accordance with the present invention, a layer of material is injected around the outside of the stack, as indicated at 70. This then provides a seal somewhat in the manner of FIG. 2. Again, connections are made to the groove network within the fuel cell stack, so that internal seals are formed simultaneously. In this case, venting is provided in the end plates. Vent channels may be provided extending through the stack and out of the ends of the stack, and in communication with the groove networks within the stack itself.

It is also to be understood that prior to assembly, it will usually be necessary to clean these surfaces of the elements, and in some cases, to apply a primer. Thus, cleaning could be effected using first acetone, followed by isopropyl alcohol, where the surfaces are wiped down in between the two cleaning treatments.

As to the use of the primer, it is believed that this may be necessary in cases where the sealing material does not form an adequate bond for sealing to the large variety of different materials are used in fuel cells. For example, materials could include: titanium; stainless steel; gold; graphite; composite graphite; GRAFOIL® (trade mark of United Carbide); ABS (acrylonitrile-butadiene-styrene); polycarbonate, polysulfone, thermoplastics; thermal set plastics; aluminum; teflon; or high density polyethylene. The primer can be applied, by brushing, rolling, spray application, screen transfer, or other known manner, as a liquid composition, optionally with a solvent carrier that evaporates, or the primer can be plated or dip coated onto the appropriate surfaces. It will be appreciated that the list does not cover all possible materials. Alternatively, the carrier can be incorporated into the material used to make a particular component, so that the surface properties of the component or element are altered, to form a good bond with the material used for forming the seal. In a further embodiment, the primer may be added to the sealant material prior to injection into the stack.

The primer can be a dilute solution of various types of reactive silanes and/or siloxanes in a solvent, as represented for example, in U.S. Pat. No. 3,377,309 (Apr. 9, 1968), U.S. Pat. No. 3,677,998 (Jul. 18, 1972), U.S. Pat. No. 3,794,556 (Feb. 26, 1974), U.S. Pat. No. 3,960,800 (Jun. 1, 1976), U.S. Pat. No. 4,269,991 (May 26, 1981), U.S. Pat. No. 4,719,262 (Jan. 12, 1988), and U.S. Pat. No. 5,973,067 (Oct. 26, 1999), all to Dow Corning Corporation, and the contents of which are incorporated by reference.

To cure the seal material, a curing temperature can usually be selected by selecting suitable components for the seal material. Curing temperatures of, for example, 30° C., 80° C., or higher can be selected. Curing temperature must be compatible with the materials of the fuel cells. It is also anticipated that, for curing at elevated temperatures, heated water could be passed through the stack which should ensure that the entire stack is promptly brought up to the curing temperature, to give a short curing cycle. As noted above, it also anticipated that the invention could use a seal material that cures at ambient temperature, so that no separate heating step is required.

To vent air from the individual grooves during filling with the seal material, vents can be provided. It has been found in practice that a pattern of fine scratches, designed to provide adequate venting and to eliminate air bubble formation, can provide sufficient venting. The vents, where required, can have a variety of different configurations. Most simply, they are formed by providing a simple scratch with a sharp tool to surfaces of flow field plates and the like. However, the vents could be rectangular, oval, circular or any other desired profile. Preferably, the vents open to the exterior. However, the vents could open to any part of the stack that, at least during initial manufacture, is open to the atmosphere. For example, many of the interior chambers intended, in use, for reaction gases or coolant, will during manufacture be open to the atmosphere, and for some purposes, it may be permissible to have vents opening into these chambers. Alternatively, each individual element can be clamped lightly together so that pressure generated within the groove network is sufficient to force air out. The clamping, at the same time, maintains the flow field plates sufficiently close together such that material is prevented from escaping.

The invention is described in relation to a single groove network, but it is to be appreciated that multiple groove networks can be provided. For example, in complex designs, it may prove preferable to have individual, separated networks, so that flow of seal material to the individual networks can be controlled. Multiple, separate networks also offer the possibility of using different seal material for different components of a fuel cell assembly. Thus, as noted, a wide variety of different materials can be used in fuel cells. Finding seal materials and a primer that are compatible with the wide range of materials may be difficult. It may prove advantageous to provide separate networks, so that each seal material and primer pair need only be adapted for use with a smaller range of materials.

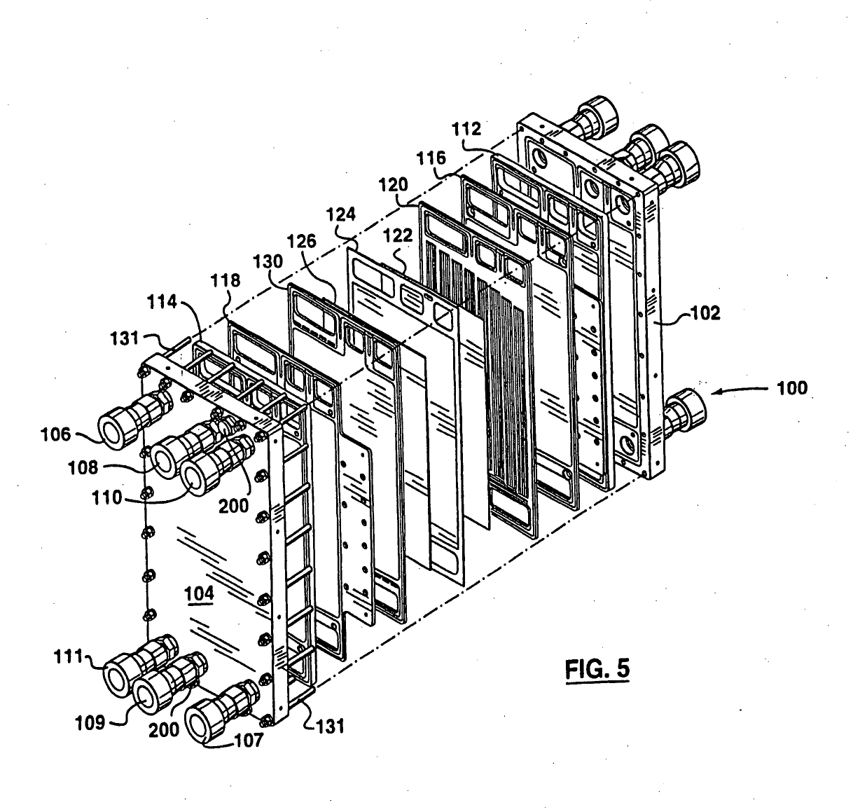

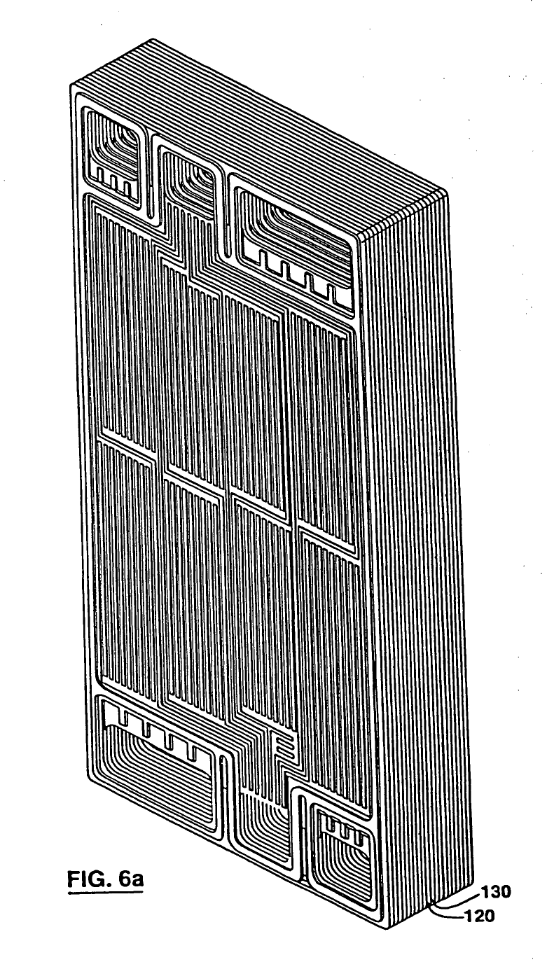

Reference will now be made to FIGS. 5-13 which show a preferred embodiment of the invention, and the fuel cell stack in these Figures is generally designated by the reference 100.

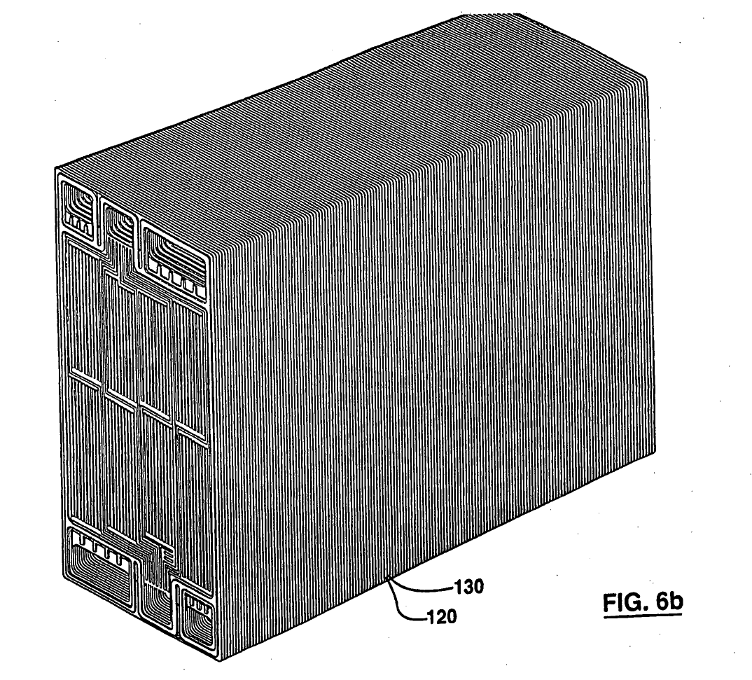

Referring first to FIGS. 5 and 6, there are shown the basic elements of the stack 100. Thus, the stack 100 includes an anode endplate 102 and cathode endplate 104. In known manner, the endplates 102, 104 are provided with connection ports for supply of the necessary fluids. Air connection ports are indicated at 106, 107; coolant connection ports are indicated at 108, 109; and hydrogen connection ports are indicated at 110, 111. Although not shown, it will be understood that corresponding air, coolant and hydrogen ports, corresponding to ports 106-111 are provided on the anode side of the fuel cell stack. The various ports 106-111 are connected to distribution channels or ducts that extend through the fuel cell stack 100, as for the earlier embodiments. The ports are provided in pairs and extend all the way through the fuel cell stack 100, to enable connection of the fuel cell stack to various equipment necessary. This also enables a number of fuel cell stacks to be connected together, in known manner.

Immediately adjacent the anode and cathode endplates 102, 104, there are insulators 112 and 114. Immediately adjacent the insulators, in known manner, there are an anode current collector 116 and a cathode current collector 118.

Between the current collectors 116, 118, there is a plurality of fuel cells. In this particular embodiment, there are ten fuel cells. FIG. 5, for simplicity, shows just the elements of one fuel cell. Thus, there is shown in FIG. 5 an anode flow field plate 120, a first or anode gas diffusion layer or media 122, a MEA 124, a second or cathode gas diffusion layer 126 and a cathode flow field plate 130.

To hold the assembly together, tie rods 131 are provided, which are screwed into threaded bores in the anode endplate 102, passing through corresponding plain bores in the cathode endplate 104. In known manner, nuts and washers are provided, for tightening the whole assembly and to ensure that the various elements of the individual fuel cells are clamped together.

Now, the present invention is concerned with the seals and the method of forming them. As such, it will be understood that other elements of the fuel stack assembly can be largely conventional, and these will not be described in detail. In particular, materials chosen for the flow field plates, the MEA and the gas diffusion layers are the subject of conventional fuel cell technology, and by themselves, do not form part of the present invention.

Reference will now be made to FIGS. 6a and 6b, which show configurations with respectively, 20 and 100 individual fuel cells. These Figures show the fuel cells schematically, and indicate the basic elements of the fuel cells themselves, without the components necessary at the end of the stack. Thus, endplates 102, 104, insulators 112, 114, and current collectors 106, 108 are not shown. Instead, these Figures simply show pairs of flow field plates 120, 130.

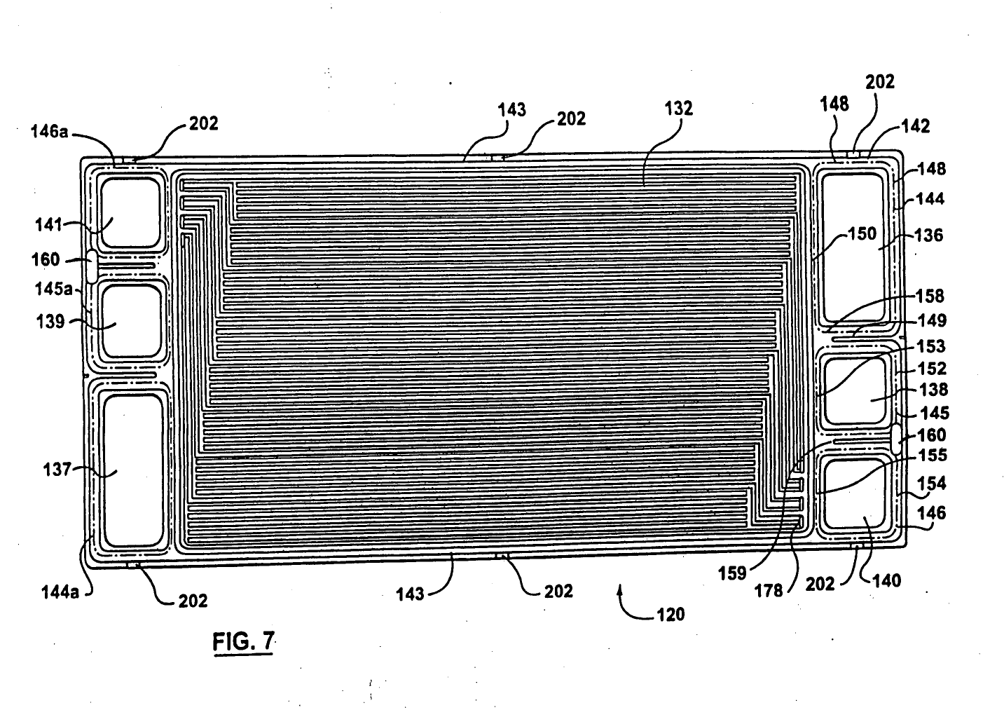

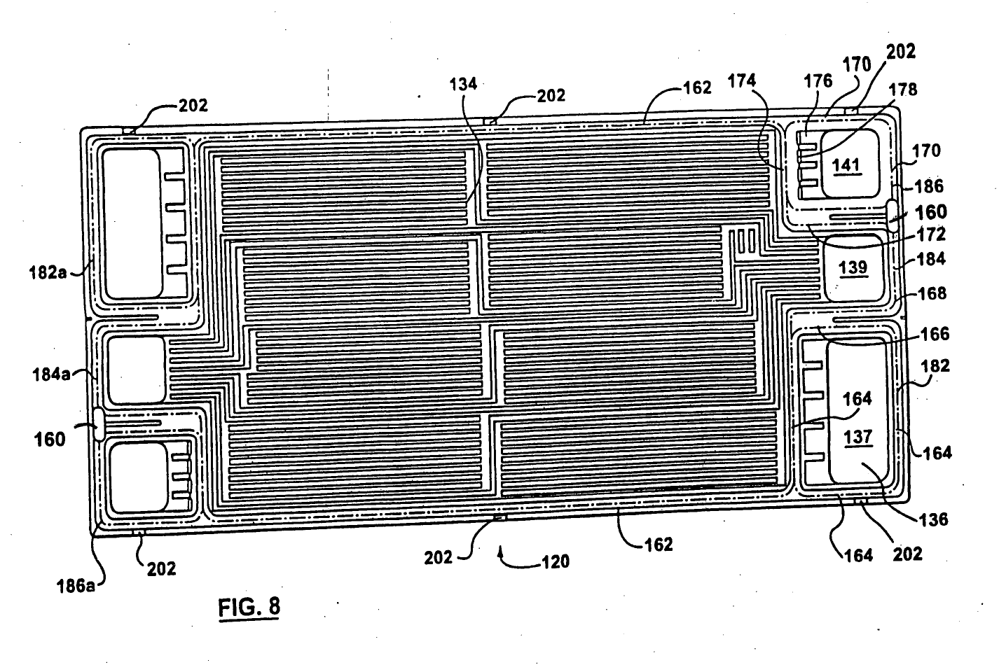

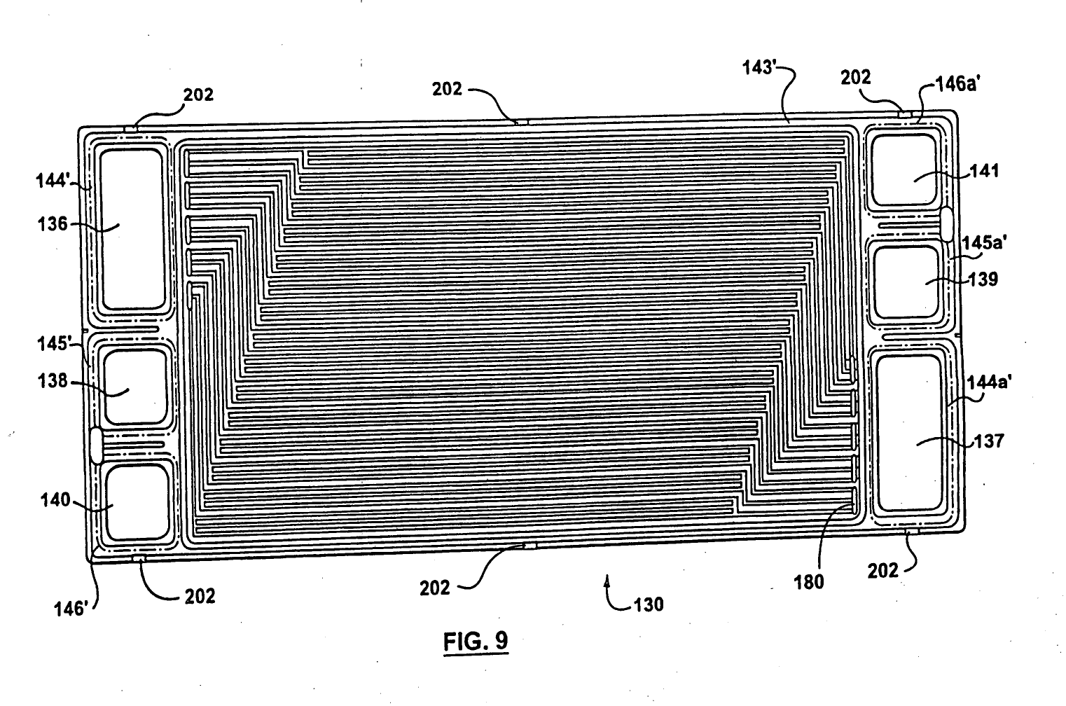

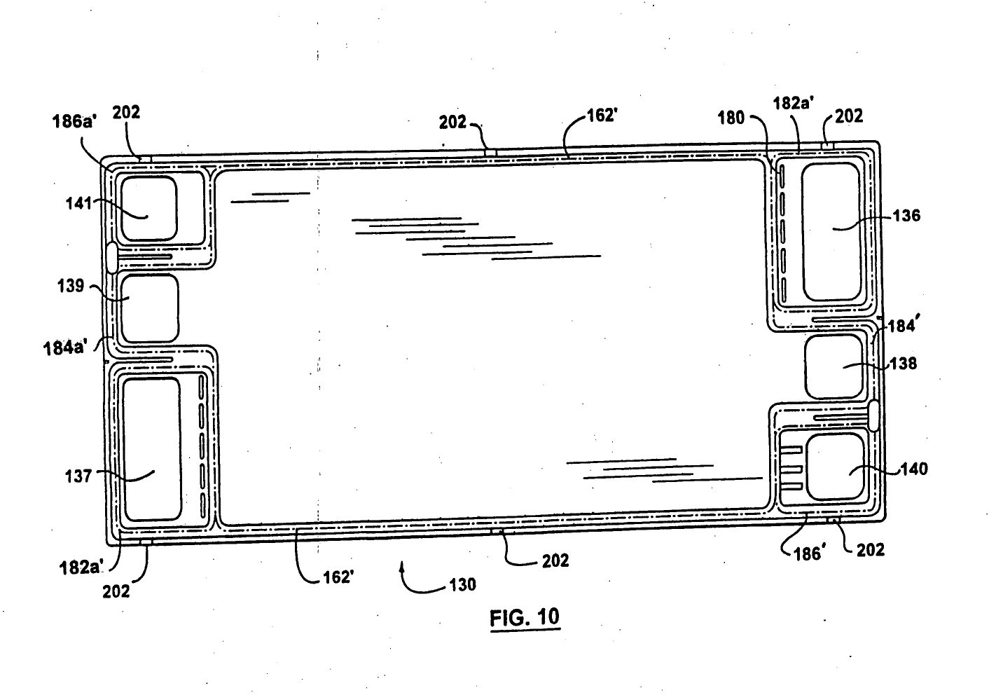

In the following description, it is also to be understood that the designations “front” and “rear” with respect to the anode and cathode flow field plates 120, 130, indicates their orientation with respect to the MEA. Thus, “front” indicates the face towards the MEA; “rear” indicates the face away from the MEA. Consequently, in FIGS. 8 and 10, the configuration of the ports is reversed as compared to FIGS. 7 and 9.

Reference will now be made to FIGS. 7 and 8 which show details of the anode bipolar plate 120. As shown, the plate 120 is generally rectangular, but can be any geometry, and includes a front or inner face 132 shown in FIG. 7 and a rear or outer face 134 shown in FIG. 8. The front face 132 provides channels for the hydrogen, while the rear face 134 provides a channel arrangement to facilitate cooling.

Corresponding to the ports 106-111 of the whole stack assembly, the flow field plate 120 has rectangular apertures 136, 137 for air flow; generally square apertures 138, 139 for coolant flow; and generally square apertures 140, 141 for hydrogen. These apertures 136-141 are aligned with the ports 106-111. Corresponding apertures are provided in all the flow field plates, so as to define ducts or distribution channels extending through the fuel cell stack in known manner.

Now, to seal the various elements of the fuel cell stack 100 together, the flow field plates are provided with grooves to form a groove network, that as detailed below, is configured to accept and to define a flow of a sealant that forms seal through the fuel cell stack. The elements of this groove network on either side of the anode flow field plate 120 will now be described.

On the front face 132, a front groove network or network portion is indicated at 142. The groove network 142 has a depth of 0.024″ and the width varies as indicated below.

The groove network 142 includes side grooves 143. These side grooves 143 have a width of 0.153″.

At one end, around the apertures 136, 138 and 140, the groove network 142 provides corresponding rectangular groove portions.

Rectangular groove portion 144, for the air flow 136, includes outer groove segments 148, which continue into a groove segment 149, all of which have a width of 0.200″. An inner groove segment 150 has a width of 0.120″. For the aperture 138 for cooling fluid, a rectangular groove 145 has groove segments 152 provided around three sides, each again having a width of 0.200″. For the aperture 140, a rectangular groove 146 has groove segments 154 essentially corresponding with the groove segments 152 and each again has a width of 0.200″. For the groove segments 152, 154, there are inner groove segments 153, 155, which like the groove segment 150 have a width of 0.120″.

It is to be noted that, between adjacent pairs of apertures 136, 138 and 138, 140, there are groove junction portions 158, 159 having a total width of 0.5″, to provide a smooth transition between adjacent groove segments. This configuration of the groove junction portion 158, and the reduced thickness of the groove segments 150, 153, 155, as compared to the outer groove segments, is intended to ensure that the material for the sealant flows through all the groove segments and fills them uniformly.

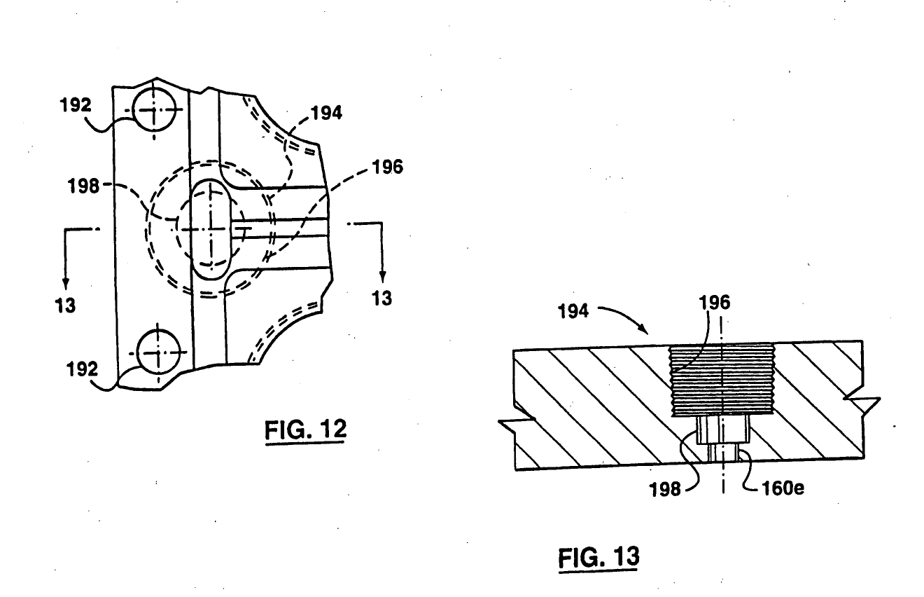

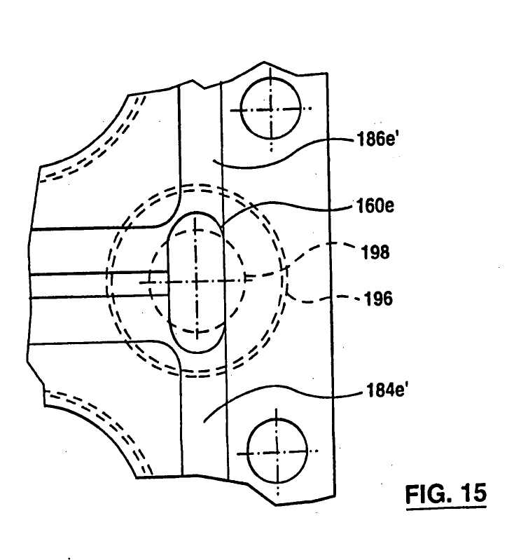

To provide a connection through the various flow field plates and the like, a connection aperture 160 is provided, which has a width of 0.25″, rounded ends with a radius of 0.125″ and an overall length of 0.35″. As shown, in FIG. 7 connection aperture 160 is dimensioned so as to clearly intercept the groove segments 152, 154. This configuration is also found in the end plates, insulators and current collection plates, as the connection aperture 160 continues through to the end plates and the end plates have a corresponding groove profile. It is seen in greater detail in FIGS. 12 and 15, and is described below.

The rear seal profile of the anode flow field plate is shown in FIG. 8. This includes side grooves 162 with a larger width of 0.200″, as compared to the side grooves on the front face. Around the air aperture 136, there are groove segments 164 with a uniform width also of 0.200″. These connect into a first groove junction portion 166.

For the coolant aperture 138, groove segments 168, also with a width of 0.200″, extend around three sides. As shown, the aperture 138 is open on the inner side to allow cooling fluid to flow through the channel network shown. As indicated, the channel network is such as to promote uniform distribution of cooling flow across the rear of the flow field plate.

For the fuel or hydrogen aperture 140 there are groove segments 170 on three sides. A groove junction portion 172 joins the groove segments around the apertures 138, 140.

An innermost groove segment 174, for the aperture 140 is set in a greater distance, as compared to the groove segment 155. This enables flow channels 176 to be provided extending under the groove segment 155. Transfer slots 178 are then provided enabling flow of gas from one side of the flow field plate to the other. As shown in FIG. 7, these slots emerge on the front side of the flow field plate, and a channel network is provided to distribute the gas flow evenly across the front side of the plate. The complete rectangular grooves around the apertures 136, 138 and 140 in FIG. 8 are designated 182, 184 and 186 respectively.

As shown in FIGS. 7 and 8, the configuration for the apertures 137, 139 and 141 at the other end of the anode flow field plate 120 corresponds. For simplicity and brevity the description of these channels is not repeated. The same reference numerals are used to denote the various groove segments, junction portions and the like, but with a suffix “a” to distinguish them, e.g. for the groove portions 144a, 145a and 146a, in FIG. 7.

Reference is now being made to FIGS. 9 and 10, which show the configuration of the cathode flow field plate 130. It is first to be noted that the arrangement of sealing grooves essentially corresponds to that for the anode flow field plate 120. This is necessary, since the design required the MEA 124 to be sandwiched between the two flow field plates, with the seals being formed exactly opposite one another. It is usually preferred to design the stack assembly so that the seals are opposite one another, but this is not essential. It is also to be appreciated that the front side seal path (grooves) of the anode and cathode flow field plates 120, 130 are mirror images of one another, as are their rear faces. Accordingly, again for simplicity and brevity, the same reference numerals are used in FIGS. 9 and 10 to denote the different groove segments of the sealing channel assembly, but with an apostrophe to indicate their usage on the cathode flow field plate.

Necessarily, for the cathode flow field plate 130, the groove pattern on the front face is provided to give uniform distribution of the oxidant flow from the oxidant apertures 136, 137. On the rear side of the cathode flow field plate transfer slots 180 are provided, providing a connection between the apertures 136, 137 for the oxidant and the network channels on the front side of the plate. Here, five slots are provided for each aperture, as compared to four for the anode flow field plate. In this case, as is common for fuel cells, air is used for the oxidant, and as approximately 80% of air comprises nitrogen, a greater flow of gas has to be provided, to ensure adequate supply of oxidant.

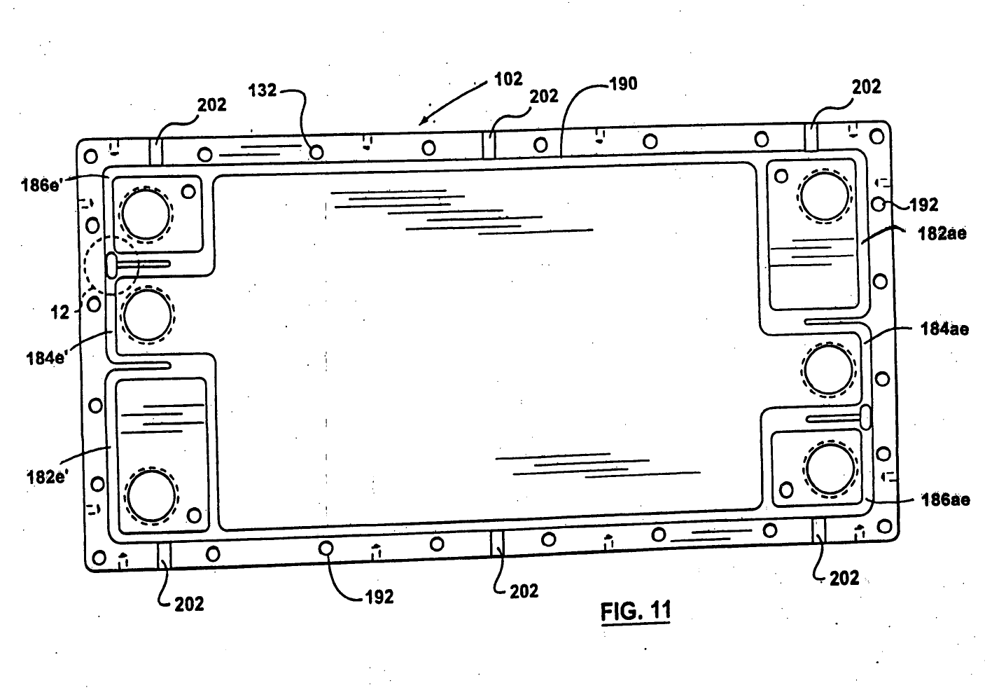

On the rear of the cathode flow field plate 130, no channels are provided for cooling water flow, and the rear surface is entirely flat. Different depths are used to compensate for the different lengths of the flow channels and different fluids within. However, the depths and widths of the seals will need to be optimized for each stack design. Reference will now be made to FIGS. 11 through 15, which show details of the anode and cathode end plates. These end plates have groove networks corresponding to those of the flow field plates.

Thus, for the anode end plate 102, there is a groove network 190, that corresponds to the groove network on the rear face of the cathode flow field plate 120. Accordingly, similar reference numerals are used to designate the different groove segments of the anode and anode end plates 102, 104 shown in detail in FIGS. 11-13 and 14-15, but identified by the suffix “e”. As indicated at 192, threaded bores are provided for receiving the tie rods 131.

Now, in accordance to the present invention, a connection port 194 is provided, as best shown in FIG. 13. The connection port 194 comprises a threaded outer portion 196, which is drilled and tapped in known manner. This continues into a short portion 198 of smaller diameter, which in turn connects with the connection aperture 160e. However, any fluid connector can be used.

Corresponding to the flow field plates, for the anode end plate 102, there are two connection ports 194, connecting to the connection apertures 160e and 160ae, as best shown in FIGS. 12 and 13.

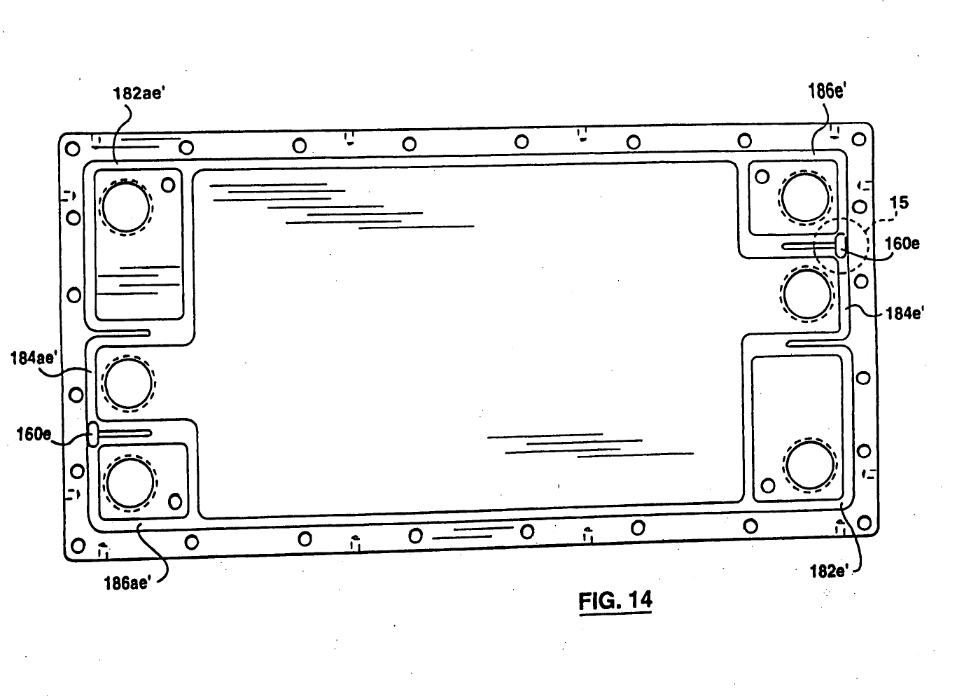

Correspondingly, the cathode end plate is shown in detail in FIGS. 14 and 15, with FIG. 15, as FIG. 12, showing connection through to the groove segments. The groove profile on the inner face of the cathode end plate corresponds to the groove profile on the rear of the anode flow field plate. As detailed below, in use, this arrangement enables a seal material to be supplied to fill the various seal grooves and channels. Once the seal has been formed, then the supply conduits for the seal material are removed, and closure plugs are inserted, such closure plugs being indicated at 200 in FIG. 5.

Now, unlike conventional gaskets, the seals for the fuel cells of the present invention are formed by injecting liquid silicone rubber material into the various grooves between the different elements of the fuel stack. As these grooves are closed, this necessarily requires air present in these channels to be exhausted. Otherwise, air pockets will be left, giving imperfections in the seal. For this purpose, it has been found sufficient to provide very small channels or grooves simply by scratching the surface of the plates at appropriate locations. The locations for these scratches can be determined by experiment or by calculation.

In use, the fuel cell stack 100 is assembled with the appropriate number of fuel cells and clamped together using the tie rods 131. The stack would then contain the elements listed above for FIG. 5, and it can be noted that, compared to conventional fuel cell stacks, there are, at this stage, no seals between any of the elements. However insulating material is present to shield the anode and cathode plates touching the MEA (to prevent shorting) and is provided as part of the MEA. This material can be either part of the lonomer itself or some suitable material (fluoropolymer, mylar, etc.) An alternative is that the bipolar plate is non-conductive in these areas.

The ports provided by the threaded bores 196 are then connected to a supply of a liquid silicone elastomeric seal material. Since there are two ports or bores 196 for each end plate, i.e. a total of four ports, this means that the seal material is simultaneously supplied from both the anode and the cathode ends of the stack; it is, additionally, supplied from both ends or edges of each of the cathode and the anode. It is possible, however, to supply from any number of ports and this is dictated by the design.

A suitable seal material is then injected under a suitable pressure. The pressure is chosen depending upon the viscosity of the material, the chosen values for the grooves, ducts and channels, etc., so as to ensure adequate filling of all the grooves and channels in a desired time.

Material flows from the inner ports provided by the threaded bores 196 through the connection apertures 160 to each individual fuel cell. Within these individual fuel cells, it then flows through the groove networks detailed above. This is described, by way of example, in relation to just the groove profile of the anode flow field plate 120. It will be understood that as the groove networks are generally similar, similar flow patterns will be realized for the other groove networks.

It will be appreciated that the two ends of the front face of the anode flow field plate 120 exhibit rotational symmetry, although this is merely convenient and is not essential. Thus, the flow patterns will generally be similar. Again, for simplicity, this will be described for the right hand end of the groove network 142, as seen in FIG. 7, and it will be understood that a corresponding flow pattern takes place for the left hand end.

The seal material flows out of the connection aperture 160 into the groove segments 152, 154. The materials simultaneously flow along the outer edges of these segments and also the portions of these segments directed inwardly towards the groove junction portion 159. When the material reaches the junction portion 159 it will then be diverted into the narrower groove segments 153, 155. Simultaneously, the material continues to flow around the outside of the apertures 138, 140 through the groove segments 152, 154.

The two flows around the aperture 140 will eventually lead into the side groove 143. It will be appreciated that the dimensions of the grooves 154, 155 and the location of the connection aperture 160 are chosen such that the two flows will meet approximately simultaneously, and in particular, that no air pocket will be left.

Correspondingly, the flows around the aperture 138 will meet at the groove junction portion 158. Again, the dimensions of the groove segments 152, 153 and also the groove junction portion 159 are sized to ensure that these flows meet approximately simultaneously. The flow then diverges again and flows in two paths around the larger aperture 136 for the oxidant flow. Note that again the groove segment 148 has a larger width than the groove segment 149, to promote approximately equal travel time around the aperture 136, so that the two flows arrive generally simultaneously at a junction with the topmost groove 143 in FIG. 7. The flows then combine to pass down the side groove 143.

As noted, a generally similar action is taking place at the other, left hand end of the anode flow field plate 120, as viewed in FIG. 7. Consequently, for each side groove 143, there are then two flows approaching from either end. These two flows will meet at the vents 202. These vents are dimensioned so as to permit excess air to be vented to the exterior, but small enough to allow fill pressures to build up to a level that allows all of the groove segments in the assembly to fill completely. The design of the groove segment patterns allow for multiple uncured seal material fronts to advance simultaneously during the filling operation. When one flow front meets another flow front, air can potentially be trapped, and the internal air pressure may prevent the groove segments from filling completely with seal material. To prevent this from happening, the vents 202 are placed where seal material flow fronts converge. Typically these vents are 0.5 to 3.0 mm wide and 0.0003″ (0.0075 mm) to 0.002″ (0.05 mm) deep with many alternate configurations known to work, such as round vents, circular grooves as a result of regular grinding marks, and crosshatched patterns. Location of the vents is a critical parameter in the filling function and these are typically located using a combination of computer simulation and empirical design. As shown, additional vents 202 can be provided at either end, to give a total of six vents on the face of the plate.

These vents 202 can be provided for the front and back faces of both the anode and cathode flow field plates. It will be understood that for plated surfaces that face one another, it will often be sufficient to provide vent grooves on the face of one plate. Also, as shown in FIG. 11, vents 202 are also provided on the end plates at corresponding locations.

In practice, for any particular fuel stack assembly, tests will be run to establish the filling time required to ensure complete filling of all grooves and channels. This can be done for different materials, dimensions, temperatures etc. With the filling time established, material is then injected into the complete stack assembly 100, for the determined filling time, following which the flow is terminated, and the seal material supply is detached.

The connection ports 194 are then closed with the plugs 200. The entire fuel stack assembly 100 is then subjected to a curing operation. Typically this requires subjecting it to an elevated temperature for a set period of time. The seal material is then chosen to ensure that it cures under these conditions.

Following curing, the fuel cell stack 100 would then be subjected to a battery of tests, to check for desired electrical and fluid properties, and in particular to check for absence of leaks of any of the fluids flowing through it.

If any leaks are detected, the fuel cell will most likely have to be repaired. Depending on the nature of the leak and details of an individual stack design, it may be possible simply to separate the whole assembly at one seal, clear out the defective seal and then form a new seal. For this reason, it may prove desirable to manufacture relatively small fuel cells stacks, as compared to other conventional practice. While this may require more inter-stack connections, it will be more than made up for by the inherent robustness and reliability of each individual fuel cell stack. The concept can be applied all the way down to a single cell unit (identified as a Membrane Electrode Unit or MEU) and this would then conceivably allow for stacks of any length to be manufactured.

This MEU is preferably formed so that a number of such MEU's can be readily and simply clamped together to form a complete fuel cell stack of desired capacity. Thus, an MEU would simply have two flow field plates, whose outer or rear faces are adapted to mate with corresponding faces of other MEU's, to provide the necessary functionality. Typically, faces of the MEU are adapted to form a coolant chamber for cooling fuel cells. One outer face of the MEU can have a seal or gasket preformed with it. The other face could then be planar, or could be grooved to receive the preform seal on the other MEU. This outer seal or gasket is preferably formed simultaneously with the formation of the internal seal, injected-in-place in accordance with the present invention. For this purpose, a mold half can be brought up against the outer face of the MEU, and seal material can then be injected into a seal profile defined between the mold half and that outer face of the MEU, at the same time as the seal material is injected into the groove network within the MEU itself. To form a complete fuel cell assembly, it is simply a matter of selecting the desired number of MEU's, clamping the MEU's together between endplates, with usual additional end components, e.g. insulators, current collectors, etc. The outer faces of the MEU's and the preformed seals will form necessary additional chambers, especially chambers for coolant, which will be connected to appropriate coolant ports and channels within the entire assembly. This will enable a wide variety of fuel cell stacks to be configured from a single basic unit, identified as an MEU. It is noted, the MEU could have just a single cell, or could be a very small number of fuel cells, e.g. 5. In the completed fuel cell stack, replacing a failed MEU, is simple. Reassembly only requires ensuring that proper seals are formed between adjacent MEU's and seals within each MEU are not disrupted by this procedure.

The embodiments described have groove networks that include groove segments in elements or components on either side of the element or component. It will be appreciated that this is not always necessary. Thus, for some purposes, e.g. for defining a chamber for coolant, it may be sufficient to provide the groove segments in one flow plate with a mating surface being planar, so that tolerances are less critical. The invention has also been described as showing the MEA extending to the edges of the flow field plates. Two principal issues are to be noted. Firstly, the material of the MEA is expensive and necessarily must be quite thin typically of the order of one to two thousands of an inch with current materials, so that it is not that robust. For some applications, it will be preferable to provide a peripheral flange or mounting layer bonded together and overlapping the periphery of the PEM itself. Typically the flange will then be formed from two layers each one to two thousands of an inch thick, for a total thickness of two to four thousands of an inch. It is this flange or layer which will then be sealed with the seal.

A second consideration is that providing the MEA, or a flange layer, bisecting a groove or channel for the seal material may give problems. It is assumed that flow of the seal material is uniform. This may not occur in practice. For example, if the MEA distorts slightly, then flow cross-sections on either side will distort. This will lead to distortions in flow rates of the seal material on the two sides of the MEA, which will only cause the distortion to increase. Thus, this will increase the flow on the side already experiencing greater flow, and restrict it on the other side. This can result in improper sealing of the MEA. To avoid this, the invention also anticipates variants, shown in FIGS. 1b-1e. These are described below, and for simplicity like components in these figures are given the same reference numerals as in FIG. 1a, but with the suffixes b,c,d as appropriate, to indicate features that are different.

A first variant, in FIG. 1b, provides a configuration in which the periphery of the MEA 26b, or any mounting flange, is dimensioned to terminate at the edge of the groove itself, i.e. the MEA 26b would not extend all the way across the groove. This will require more precise mounting of the MEA 26b. Additionally, it would mean that mating surfaces of endplates and the like, outside of the groove network would not then be separated by the MEA. To obtain insulation between the flow field plates, a separate layer of insulation, indicated at 27 would be provided, for example, by screen printing this onto the surface of flow field plates 22b and 24b. As shown, the grooves 28b, 30b can be largely unchanged.

A second variant, in FIG. 1c, overcomes the potential problem of different flow rates in opposed grooves causing distortion of the MEA, by providing offset grooves, shown at 28c, 30c. In this arrangement, each groove 28c in the plate 22c would be closed by a portion of the MEA 26c, but the other side of that portion of the MEA 26c would be supported by the second plate 24c, so as to be incapable of distortion. Correspondingly, a groove 30c in the second plate 24c, offset from the groove 28c in the plate 22c, would be closed by MEA 26c, and the MEA 26c would be backed and supported by the plate 22c.

Referring to FIG. 1d, in a further variant, the GDM cavities 38 are effectively removed, by providing GDM layers that extend to the peripheries of the plates 22d and 24d. The grooves 28d, 30d are still provided as shown, opening onto edges of the GDM layers. The seal then flows out of the grooves 28d, 30d, to fill the voids in the GDM, until the seal material reaches the surface of the MEA 26d. It is expected that the seal material will flow around individual particles of the catalyst layer, so as to form a seal to the actual proton exchange membrane, even if the seal material does not fully penetrate the catalyst layer. As required, the MEA 26d layer can terminate either flush with the peripheries of the plates 22d, 24d, or set in from the plate peripheries; in the later case, a seal, itself flush with the plate peripheries, will effectively be formed around the outer edges of the MEA 26d and the GDM layers. In either case, it is possible to provide an extension of the seal, outside of the grooves 28d, 30d and beyond the plate peripheries, possibly extending around the fuel cell stack as a whole.

In FIG. 1e, the construction is similar to FIG. 1d. However, the GDM layers terminate short of the plate peripheries as indicated at 31e. The grooves 28e, 30e are then effectively formed outside of the GDM layers to the peripheries of the plates 22e, 24e.

In FIGS. 1d and 1e, the anode and cathode flow field plates have flat, opposing faces, although it will be understood that these faces, in known manner, would include flow channels for gases. As these faces are otherwise flat, this greatly eases tolerance and alignment concerns, and in general it is expected that the MEA 26d-e can be inserted without requiring any tight tolerances to be maintained.

In all of FIGS. 1a-1e, the PEM layer 26a-e can be replaced with a PEM layer that has an outer mounting flange or border. This usually makes the PEM layer stronger and saves on the more expensive PEM material. This has advantages that the flange material can be selected to form a good bond with the seal material, and this avoids any potential problems of forming a seal involving the catalyst layers.

In FIGS. 1d and 1e, facing projections can be provided around the outer peripheries of the plates to control spacing of the plates and hence pressure on the GDM layers without affecting flow of the seal material. These can additionally assist in aligning the PEM layers 26 and the GDM layers. Alternatively, projections can be omitted, and the entire stack clamped to a known pressure prior to sealing. Unlike known techniques, all the pressure is taken by the GDM layers, so that each GDM layer is subject to the same pressure. This pressure is preferably set and maintained by tie rods or the like, before injecting the seal material.

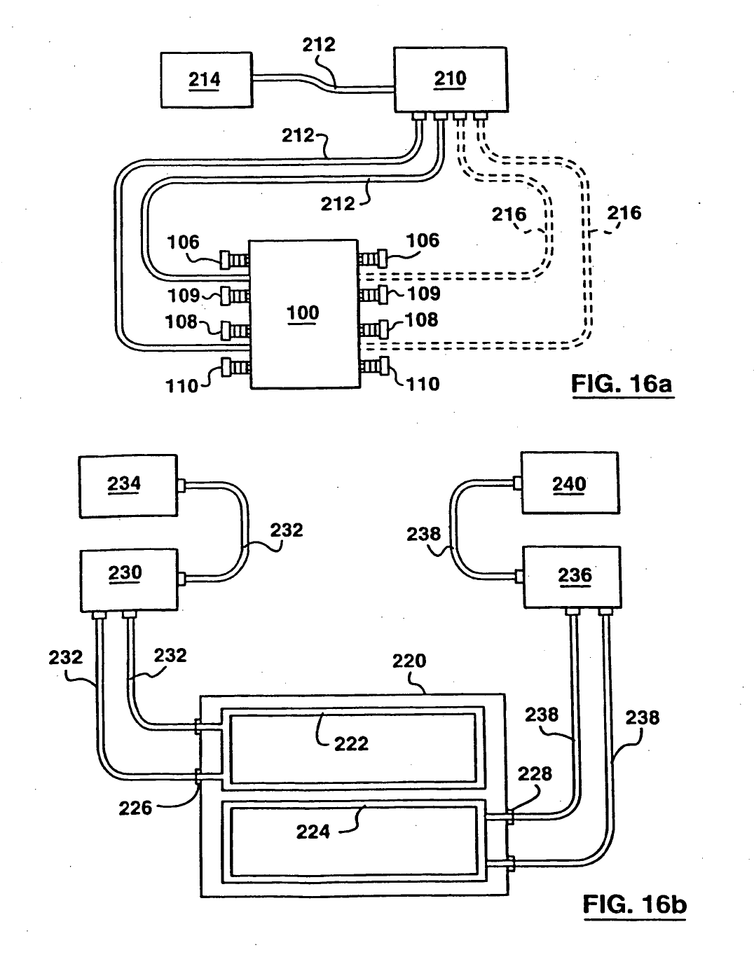

Referring now to FIGS. 16a and 16b, there is shown schematically the overall arrangement for supplying the seal material with FIG. 16b showing an arrangement for supplying two different seal materials.

In FIG. 16a, the fuel cell stack 100 of FIG. 5 is shown. A pump 210 is connected by hoses 212 to two ports at one end of the fuel cell stack 100. An additional hose 212 connects the pump 210 to a silicone seal material dispensing machine, that includes a static mixer, and which is indicated at 214.

In this arrangement, the seal material is supplied to just from one end of the stack 100. As such, it may take some time to reach the far end of the stack, and this may not be suitable for larger stacks. For larger stacks, as indicated in dotted lines 216, additional hoses can be provided, so that the seal material is supplied from both ends of the stack 100. As detailed elsewhere, the material is supplied at a desired pressure, until the stack is filled, and all the air has been displaced from the stack. Typically, this timing will be determined by experimentation and testing, e.g. by filling stacks and then dismantling them to determine the level of filling. Commonly, this will give a minimum fill time required to ensure displacement of all air from the stack, and it also enables checking that appropriate vent locations have been provided.

Once the stack has been filled, the hoses 212, and 216 if present, are disconnected. Preferably, closure plugs, such as those indicated at 200, as shown in FIG. 5, are used to close the stack, although this may not always be necessary. For example, where a fuel cell stack is filled from one side, it may be sufficient to orient the fuel cell stack so the connection ports are at the top and open upwards, so that no closure is required. Indeed, for some designs and choices of materials, this may be desirable, since it will ensure that the seal material is at atmospheric pressure during the curing process.

The fuel cell stack is then subject to a curing operation. This can be achieved in a number of ways. For curing at elevated temperatures other than ambient temperature, the stack can be connected to a source of heated water, which will be passed through the coolant chambers of the stack. Commonly, it will be preferred to pass this water through at a low pressure, since, at this time, cured seals will not have been formed. Alternatively, or as well, the whole stack can be placed in a curing chamber and subject to an elevated temperature to cure the seal material.

Referring to FIG. 16b, this shows an alternative fuel cell stack indicated at 220. This fuel cell stack 220 has two separate groove networks indicated, schematically at 222 and 224. The groove network 222 is connected to ports 226 at one end, while the groove network 224 is connected to ports 228 at the other end. The intention here is that each groove network would be supplied with a separate sealing material, and that each sealing material would come into contact with different elements of the fuel cell stack. This enables the sealing materials to be tailored to the different components of the fuel cell stack, rather than requiring one sealing material to be compatible with all materials of the stack.

For the first groove network 222, there is a pump 230 connected by hoses 232 to a fuel cell stack 220. One hose 232 also connects the pump 230 to a dispensing machine 234. Correspondingly, for the second groove network 224, there is a pump 236 connected by hoses 238 to the stack 220, with a hose 238 also connecting a second dispensing machine 240 to the pump 236.

In use, this enables each groove network 222, 224 to be filled separately. This enables different pressures, filling times and the like selected for each groove network. For reasons of speed of manufacture, it is desirable that the filling times be compatible, and this may necessitate different pressures being used, depending upon the different seal materials.

It is also possible that different curing regimes could be provided. For example, one groove network can be filled first and cured at an elevated temperature that would damage the second seal material. Then, the second groove network is filled with the second seal material and cured at a different, lower temperature. However, in general, it will be preferred to fill and cure the two separate groove networks 222, 224 simultaneously, for reasons of speed of manufacture.

While separate pumps and dispensing machines are shown, it will be appreciated that these components could be integral with one another.

While the invention is described in relation to proton exchange membrane (PEM) fuel cell, it is to be appreciated that the invention has general applicability to any type of fuel cell. Thus, the invention could be applied to: fuel cells with alkali electrolytes; fuel cells with phosphoric acid electrolyte; high temperature fuel cells, e.g. fuel cells with a membrane similar to a proton exchange membrane but adapted to operate at around 200° C.; electrolysers, regenerative fuel cells and (other electrochemical cells as well). The concept would also be used with higher temperature fuel cells, namely molten carbonate and solid oxide fuels but only if suitable seal materials are available.

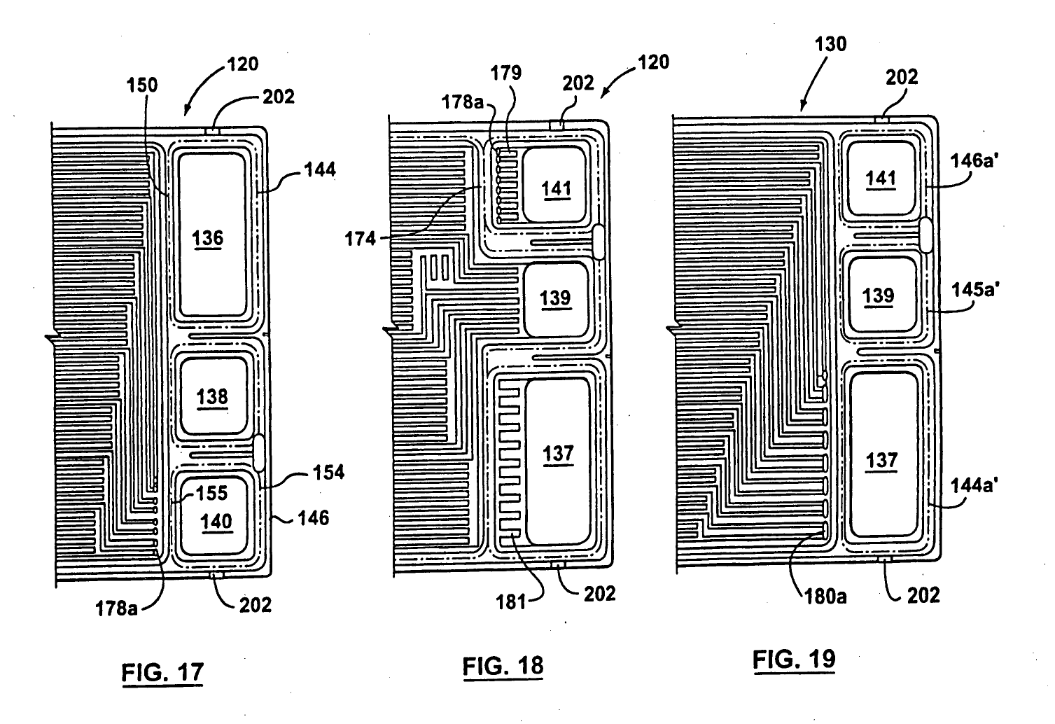

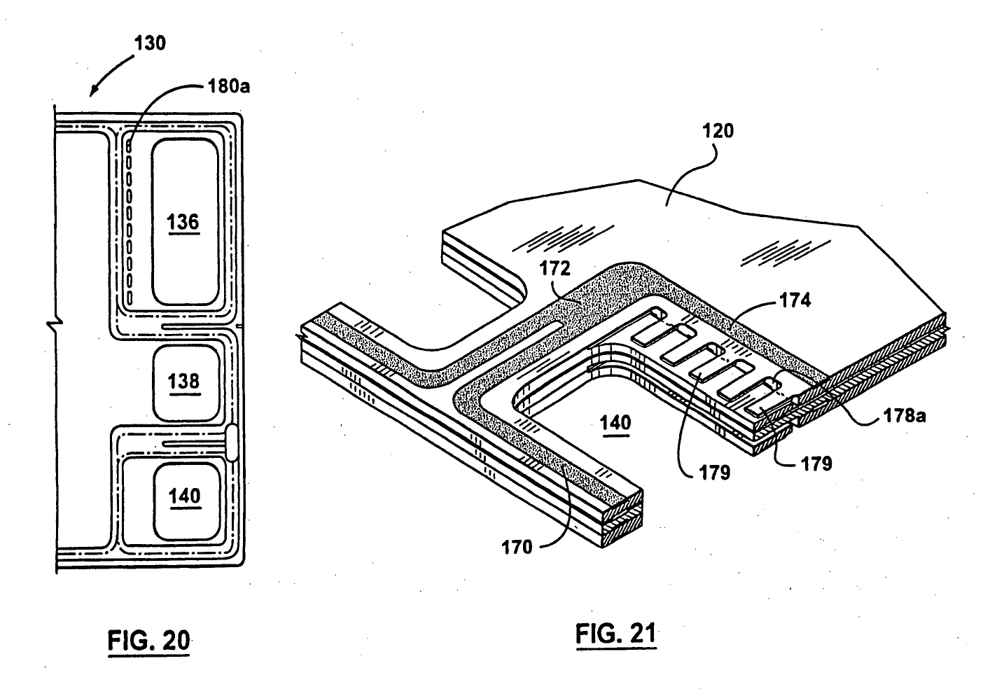

FIGS. 17, 18, 19 and 20 show alternative rib configurations for the plates. Here, the number of ribs adjacent the apertures for the fuel and oxygen flows, to provide a “backside” feed function, have essentially been approximately doubled. This provides greater support to the groove segment on the other side of the plate.

In these FIGS. 17-20, the transfer slots are denoted by the references 178a, for the anode plate 120, and 180a, for the cathode plate 130. The suffixes indicate that the transfer slots have different dimensions, and are more numerous. There are eight transfer slots 178a, as compared to four slots 178, and there are eight transfer slots 180a, as compared to four slots 180. It will also be understood that it is not necessary to provide discrete slots and that, for each flow, it is possible to provide a single relatively large transfer slot. Each of the slots 178a communicates with a single flow channel (FIG. 17), and each of the slots 180a communicates with two flow channels, except for an end slot 180a that communicates with a single channel (FIG. 19).

The transfer slots 178a are separated by ribs 179, and these are now more numerous than in the first embodiment or variant. Here, the additional ribs 179 provide additional support to the inner groove segment on the front face of the anode plate (FIG. 17, 18). Similarly, there is now a larger number of ribs, here designated at 181, between the slots 180a, and these provide improved support for the groove segment 150 (FIGS. 17, 18).

It will also be understood that, as explained above, facing rear faces of the anode and cathode plates abut to form a compartment for coolant. Consequently, the ribs 179 and 181 abut and support the cathode plate to provide support for the inner groove segments around the apertures 137 and 141 of the cathode plate 130 (FIG. 18).

Another aspect of the invention relates to the detailed composition of the elastomeric seal material, which is an organo siloxane composition curable to an elastomeric material and having a pumpable viscosity in the uncured state, allowing it to be cured in situ in a fuel cell cavity to provide seals in distinct zones as detailed above. The composition of the seal material, in this preferred embodiment, comprises:
(a) 100 parts by weight of polydiorganosiloxane containing 2 or more silicon-atom-bonded alkenyl groups in each molecule;
(b) 5 to 50 parts by weight of reinforcing filler;
(c) 1-20 parts by weight of an oxide or hydroxide of an alkaline-earth metal with an atomic weight of 40 or greater;
(d) an organohydrogensiloxane containing 3 or more silicon-atom-bonded hydrogen atoms in each molecule, in an amount providing a molar ratio of the silicon-atom-bonded hydrogen atoms in this ingredient to the silicon-atom-bonded alkenyl groups in ingredient (a) in a range of 0.4:1 to 5:1;
(e) a platinum-type metal catalyst in an amount providing 0.1 to 500 parts by weight of platinum-type metal per 1 million parts by weight of ingredient (a);
(f) optionally, 0.1-5.0 parts by weight of an organic peroxide with or without ingredient (e);
(g) optionally, 0.01-5.0 parts by weight of an inhibitor, as detailed below
(h) optionally, 0-100 parts by weight of non-reinforcing extending fillers; and,
(i) optionally, a release agent.
   Ingredient (a) (Polydiorganosiloxane)

Preferably, the polydiorganosiloxane has a viscosity within a range of about 0.03 to less than 100 Pa·s at 25° C. The polydiorganosiloxane can be represented by the general formula X(R1R2SiO)ₙX where R1 and R2 represent identical or different monovalent substituted or unsubstituted hydrocarbon radicals, the average number of repeating units in the polymer, represented by n, is selected to provide the desired viscosity, and the terminal group X represents an ethylenically unsaturated hydrocarbon radical. For example, when the composition is to be cured by a hydrosilylation reaction with an organohydrogensiloxane or a vinyl-specific peroxide, X is typically vinyl or other alkenyl radical.

The hydrocarbon radicals represented by R1 and R2 include alkyls comprising one to 20 carbons atoms such as methyl, ethyl, and tertiary-butyl; alkenyl radicals comprising one to 20 carbon atoms such as vinyl, allyl and 5-hexenyl; cycloalkyl radicals comprising three to about 20 carbon atoms such as cyclopentyl and cyclohexyl; and aromatic hydrocarbon radicals such as phenyl, benzyl, and tolyl. The R1 and R2 can be substituted with, for example, halogens, alkoxy, and cyano groups. The preferred hydrocarbon radicals are alkyls containing about one to four carbon atoms, phenyl, and halogen-substituted alkyls such as 3,3,3-trifluoropropyl. Most preferably R1 represents a methyl radical, R2 represents at least one of methyl, phenyl and 3,3,3-trifluoropropyl radicals, and X represents methyl or vinyl, and optionally one or more of the R2 radicals is alkenyl. The preferred polydiorganosiloxane is a dimethylvinylsiloxy endblocked polydimethylsiloxane having a viscosity within a range of about 0.3 to less than 100 Pa·s.

The polydiorganosiloxane of the present process can be a homopolymer, a copolymer or a mixture containing two or more different homopolymers and/or copolymers. When the composition prepared by the present process is to be cured by a hydrosilylation reaction, at least a portion of the polydiorganosiloxane can be a copolymer where X represents an alkenyl radical and a portion of the R2 radicals on non-terminal silicon atoms are optionally ethylenically unsaturated radicals such as vinyl and hexenyl.

Methods for preparing polydiorganosiloxanes having a viscosity within a range of about 0.03 to 300 Pa·s at 25° C. are well known and do not require a detailed discussion in this specification. One method for preparing these polymers is by the acid or base catalyzed polymerization of cyclic polydiorganosiloxanes that typically contain three or four siloxane units per molecule. A second method comprises replacing the cyclic polydiorganosiloxanes with the corresponding diorganodihalosilane(s) and an acid acceptor. Such polymerization are conducted under conditions that will yield the desired molecular weight polymer.

Ingredient (b) (Reinforcing Filler)

The type of reinforcing silica filler used in the present process is not critical and can be any of those reinforcing silica filler known in the art. The reinforcing silica filler can be, for example, a precipitated or pyrogenic silica having a surface area of at least 50 square meters per gram (M2/g). More preferred is when the reinforcing silica filler is a precipitated or pyrogenic silica having a surface area within a range of about 150 to 500 M2/g. The most preferred reinforcing silica filler is a pyrogenic silica having a surface area of about 370 to 420 M2/g. The pyrogenic silica filler can be produced by burning silanes, for example, silicon tetrachloride or trichlorosilane as taught by Spialter et al. (U.S. Pat. No. 2,614,906) and Hugh et al. (U.S. Pat. No. 3,043,660). The aforementioned fillers can be treated with a silazane, such as hexamethyldisilazane, an organosilane, organopolysiloxane, or other organic silicon compound. The amount of this ingredient added depends on the type of the inorganic filler used. Usually, the amount of this ingredient is in the range of 5 to 50 parts by weight per 100 parts by weight of ingredient (b).

Ingredient (c), (Oxide or Hydroxide of an Alkaline-Earth Metal)

The oxide or hydroxide of an alkaline-earth metal with an atomic weight of 40 or greater, is the characteristic ingredient of this invention. This ingredient is added to ensure that the cure product of our composition is not deteriorated by the PEM. Examples of the oxides and hydroxides of alkaline-earth metals include the oxides and hydroxides of calcium, strontium, and barium. They may be used either alone or as a mixture of two or more. Also, they may be used in the form of fine powders to ensure their effective dispersion in the silicone composition. Among them, calcium hydroxide and calcium oxide are preferred. The amount of this ingredient with respect to 100 parts by weight of ingredient (a) is in the range of 1 to 20 parts by weight, or preferably in the range of 6 to 12 parts by weight.

Ingredient (d) (Organohydrogensiloxane)

The organohydrogensiloxane containing 3 or more silicon-bonded hydrogen atoms in each molecule, is a crosslinking agent. Examples of organohydrogensiloxanes that are used include methylhydrogenpolysiloxane with both ends blocked by trimethylsiloxy groups, dimethylsiloxane/methyl-hydrogensiloxane copolymer with both ends blocked by trimethylsiloxy groups, methylphenylsiloxane/methyl-hydrogensiloxane copolymer with both ends blocked by dimethylphenylsiloxy groups, cyclic methylhydrogenpoly-siloxane, and a copolymer made of dimethylhydrogen siloxy units and SiO4/2 units. A fluorosilicone crosslinker such as methyltrifluoropropyl/methyl-hydrogen siloxane copolymer with both ends blocked with dimethyl hydrogen groups can be used, particularly when the mole percent of methylotrifluoropropyl is greater than 50%. The amount of organohydrogensiloxane added is appropriate to ensure that the molar ratio of the silicon-bonded hydrogen atoms in this ingredient to the silicon-bonded alkenyl groups in ingredient (a) is in the range of 0.4:1 to 5:1. Otherwise, it is impossible to obtain good curing properties.

Ingredient E, (Platinum Group Catalyst)

The platinum-group catalyst, is a catalyst for curing the composition. Examples of useful catalysts include fine platinum powder, platinum black, chloroplatinic acid, platinum tetrachloride, olefin complexes of chloroplatinic acid, alcohol solutions of chloroplatinic acid, complexes of chloroplatinic acid and alkenylsiloxanes, or like compounds of rhodium and palladium. The amount of the platinum-group catalyst added is usually that providing 0.1 to 500 parts by weight of platinum-type metal atoms per 1 million parts by weight of ingredient (a). If the amount is smaller than 0.1 part, the curing reaction may not proceed sufficiently; if the amount is over 500 parts, the cost effectiveness is very poor.

Optionally ingredient (e) could be in the form of a spherical-shaped fine-grain catalyst made of a thermoplastic resin containing 0.01 wt % or more of platinum metal atoms, as there is no catalyst poisoning effect caused by ingredient (c). Also, to ensure that the platinum-type catalyst ingredient is dispersed quickly into the composition at the conventional molding temperature, the softening point of the thermoplastic resin should be in the range of about 50 to 150° C. Also, the average grain size of the spherical-shaped fine-grain catalyst is in the range of 0.01 to 10 micron.

Exemplary encapsulated catalysts are disclosed in U.S. Pat. No. 4,766,176 (Aug. 23, 1988); U.S. Pat. No. 4,784,879 (Nov. 15, 1988); U.S. Pat. No. 4,874,667 (Oct. 17, 1989; and U.S. Pat. No. 5,077,249 (Dec. 31, 1991), all to Dow Corning Corporation, and the contents of which are hereby incorporated by reference.

Ingredient (f) (Organic Peroxide Curing Agent)

Ingredient (f) consists of a suitable organic peroxide curing agent which aids to forming a cured silicone elastomer. The organic peroxides can be those typically referred to as vinyl-specific, and which require the presence of vinyl or other ethylenically unsaturated hydrocarbon substituent in the polydiorganosiloxane. Vinyl-specific peroxides which may be useful as curing agents in the curable liquid silicone rubber compositions include alkyl peroxides such as 2,5-bis(t-butylperoxy)-2,3-dimethylhexane. The organic peroxide can be those referred to as non-vinyl specific and which react with any type of hydrocarbon radical to generate a free radical.

Optional Ingredient (g) (Inhibitor)

Optionally an inhibitor to allow sufficient the composition to have a suitable working life to allow for processing may be necessary. As exemplified by alkyne alcohols such as 3,5-dimethyl-1-hexyn-3-ol, 1-ethynyl-1-cyclohexanol and phenylbutynol; ene-yne compounds such as 3-methyl-3-penten-1-yne and 3,5-dimethyl-3-hexen-1-yne; tetramethyltetrahexenyl-cyclotetrasiloxane; benzotriazole; and others.

Optional Ingredient (h) (Non-Reinforcing Extending Filler)

Ingredient (h) can be, but is not limited to, a non-reinforcing extending filler selected from the quartz powder, diatomaceous earth, iron oxide, aluminum oxide, calcium carbonate, and magnesium carbonate.

The composition of this invention is easily manufactured by uniformly blending the requisite ingredients. Optionally, other additives may be added, including curing agents, inhibitors, heat resistant agents, flame-retarding agents, and pigments. This blending can be performed by means of a kneader mixer, a pressurized kneader mixer, ROSS™ mixer, and other blenders. The composition may also be prepared as two or more liquids, which are blended immediately before use, to facilitate manufacturing and to improve the workability.

In order to enable the fuel cell stack formed according to the present invention to be more easily disassembled, additives may be added to the sealant material. Such additives will be referred to as a release agent hereafter. A release agent allows the cured sealant to be easily removed from the fuel cell components, e.g. flow field plates, MEAs, between which the sealant resides. Then a fuel cell stack can be disassembled and defective cell or cells or components can be removed or repaired without discarding the whole fuel cell stack or without damaging the components of the fuel cell stack when it is being disassembled. The release agent alters the surface adhesion properties of the seal material so that the adhesion of the seal material can be more easily overcome in the event that at least one component of the fuel cell must be disassembled. The release agent can be added to the seal material or it can be applied to the surface of the fuel cell components upon (or within) which the seal material is applied.

An example of a release agent that may be applied to the surface of a fuel cell component is sodium lauryl sulphate. Other materials that may be used in this case include Teflon sprays or Teflon coatings, vegetable oils, mineral oils, silicone fluids, fluorosilicone fluids or soap solutions. These materials can be solvent or water based. In general, these materials can be classified as lubricating fluids. Before a fuel cell stack is assembled, the release agent may be applied on portions of the surface of individual components which will be in contact with the sealant when the fuel cell stack is formed. These materials may be applied by spraying, brushing, wiping, dipping, screening or rolling and dried by exposure to air or heating. Then the fuel cell stack is assembled and the sealant injected. Experiments have shown that after the sealant is cured, with compression forces applied onto the two ends of the fuel cell stack to hold the fuel cell stack together, the sealant effectively seals between the fuel cell components even in the presence of the release agent.

Alternatively, a release agent may simply be added to the liquid mixture and blended to mix uniformly with other ingredients before the sealant is injected. In case a defective cell is identified, the fuel cell stack is disassembled and the defective cell can be easily removed from adjacent cells in the presence of the release agent. Then a new cell can be put into the stack. In this case, materials that may be added to the silicone sealant material are silanol ended poly dimethyl siloxanes of chain length 4 to 50, typically added in proportion of 0.1 to 1.5 percent with the preferred amount being 0.4 to 0.7%. Also, silicone fluids composed of polydimethylsiloxanes with viscosities of 1 to 1000 Cst may be used in similar amounts. These materials can be added in this proportion to the various examples of seal materials that are discussed in further detail below. Typical release agents that can be added to non-silicone sealing compounds are the same as those used for silicone sealing compounds. Additionally a wide range of commercial release aids can be used where the release aids contain one or more of silicone fluids, fluorosilicone fluids, mineral oils, vegetable oils, fluorocarbon fluids or solids and soaps. However, the release material should not be added to the seal material if it is not compatible with the cure chemistry of the seal material and interferes with the formation of the cured seal material.

Conventional sealing techniques may be used to seal the new cell with adjacent cells. This addresses the concerns of high cost associated with sealing the whole fuel cell stack all at once. This also makes the present invention suitable for mass production of fuel cell stacks while maintaining flexibility in terms of repair and maintenance and further reduces costs.

In the following, this aspect of the invention, the elastomeric seal material, will be explained in more detail with reference to specific examples. In the examples, parts refer to parts by weight and the viscosity refers to the value at 25° C.

### EXAMPLE 1

TABLE I
Composition of Silicone Base Material

| Parts | Ingredient |
|---|---|
| 100 | Dimethylsiloxane, Dimethylvinylsiloxy-terminated |
| 40 | Quartz |
| 40 | Silica, Amorphous, Fumed |
| 13 | Hexamethyldisilazane |
| 0.4 | Tetramethyldivinyldisilazane |
| 3 | Dimethylsiloxane, Hydroxy-terminated |

100 parts of a polydimethylsiloxane which is dimethylvinylsiloxy terminated and has a viscosity of 55,000 cp; 3 parts of dimethylsiloxane which is hydroxy terminated and has an viscosity of 41 cp; 40 parts quartz silica with an average particle size of 5μ; and 40 parts of fumed silica (with an average surface area of 400 m2/g) that has been surface-treated with 13 parts hexamethyldisilazane and 0.4 parts tetramethyldivinyldisilazane were blended until homogeneity was achieved. After blending, material was heat treated under vacuum to remove ammonia and trace volatiles, and note that in general it is desirable to carry out this step for all the compositions described here to form a base material. This provides a shelf stable composition. Final material is a flowable silicone paste that can be extruded through an ⅛″ orifice at a rate of 30 g/min under 90 psig pressure.

TABLE II
Composition of Silicone Material A

| Parts | Ingredients |
|---|---|
| 100 | Silicone Base Material |
| 56 | Dimethylsiloxane, Dimethylvinylsiloxy-terminated |
| 34 | Dimethyl, Methylvinylsiloxane, Dimethylvinylsiloxy-terminated |
| 12 | Calcium Hydroxide |
| 0.7 | 1,3-Diethenyl-1,1,3,3-Tetramethyldisiloxane Platinum Complexes |

100 parts of silicone base material (as mentioned in Table 1 above); 56 parts dimethylpolyiloxane that is dimethylvinylsiloxy-terminated on both ends and has a viscosity of 55,000 cp; 34 parts dimethyl, methylvinylsiloxane which is dimethylvinylsiloxy-terminated and has a viscosity of 350 cp; 12 parts of calcium hydroxide which is certified 99% pure and contains a sulfur content of less than 0.1%; and 0.7 parts of 1,3-diethenyl-1-1,1,3,3-tetramethyldisiloxane platinum complexes which contains an amount of platinum metal atoms equaling 0.52 wt % were blended until homogeneity. Final material is a flowable liquid silicone with a viscosity of 128,000 cp at 23 C.

TABLE III
Composition of Silicone Material B

| Parts | Ingredients |
|---|---|
| 100 | Silicone Base Material |
| 55 | Dimethylsiloxane, Dimethylvinylsiloxy-terminated |
| 34 | Dimethyl, Methylvinylsiloxane Dimethylvinylsiloxy-terminated |
| 5 | Dimethylhydrogensiloxy-Modified Siloxane Resin |
| 0.2 | 1-Ethynyl-1-Cyclohexanol |

100 parts of silicone base material (as mentioned in Table 1 above); 55 parts dimethylpolyiloxane that is dimethylvinylsiloxy-terminated on both ends and has a viscosity of 55,000 cp; 34 parts dimethyl, methylvinylsiloxane which is dimethylvinylsiloxy-terminated and has a viscosity of 350 cp; 5 parts of dimethylhydrogensiloxy-modified siloxane resin with 0.96 wt % silicone-atom-bonded hydrogen atoms and a viscosity of 25 cp; and 0.2 parts 1-ethynyl-1-cyclohexanol which is 99% pure for use as an inhibitor to the mixed system were blended until homogeneity. The final material is a flowable liquid silicone with a viscosity of 84,000 cp.

The final compositions of material A and material B from above when mixed in a 50:50 ratio and press molded at 150° C. for 5 minutes exhibit the following characteristics:

TABLE IV
Results of Test of Cured Elastomer

| Property | ASTM Method* | Result |
|---|---|---|
| Durometer (Shore A) | ASTM D2240 | 43 |
| Tensile, at Break (psi) | ASTM 412 | 655 |
| Elongation at Break (%) | ASTM 412 | 235 |
| Tear, Die B (ppi) | ASTM 625 | 25 |
| Modulus, at 100% (psi) | ASTM 412 | 248 |

*Note tests based on the above referenced ASTM Method.

As stated previously, the seal material must be resistant to degradation by contact with fuel cell components and fluids. Of specific importance is resistance to the PEM operating environment and resistance to swell in various liquids that may be used as coolants or reactant gases.

Several methods were used to determine the resistance to the PEM operating environment. For example, sheets of seal material were placed in contact with sheets of PEM material, rolled tightly and held in position with appropriate banding. Such rolls were then placed in acidic fluids and, separately, heated DI water to provide an accelerated aging test. Such a test was completed with DI water heated to 100° C. for the seal materials listed previously. After 8 months of exposure the material was not hardened or cracked.

Data on general resistance to degradation by the various cooling fluids used in fuel cells is available in generic product literature. An additional specific requirement is that the seal material not be excessively swelled by contact with the coolant. Standard methods for determining volume swell at standard or elevated temperature were completed for the seal materials listed previously. Volume swell of less than 1% at temperature of 82° C. for 72 hours was observed for these materials in DI water, ethylene glycol/water solution and propylene glycol/water solution.

A stack of fuel cell elements was assembled using the following procedure (with reference to the structure of FIG. 5): 1), place an aluminum anode end plate 102 flat on a horizontal surface, with the seal groove segments facing up; 2), place a high-density polyethylene insulator plate 112 on the anode end plate, locating the plate so the seal groove segments on each plate align with each other; 3), place a gold-plated nickel anode bus bar plate 116 on the insulator plate, locating the plate so the seal groove segments on each plate align with each other; 4), place an anode bipolar flow field plate 120 on the insulator plate with the active area facing up, aligning the groove segments and apertures of each plate; 5), place a GDL ply 122, cut to fit in the recessed surface active area of the anode bipolar flow field plate; 6), place a PEM ply 124 on the anode bipolar flow field plate and GDL, making sure that the apertures for flowing seal material are aligned with the aperture on the flow field plate; 7), place a GDL ply 126, cut to fit in the recessed surface active area of the cathode bipolar flow field plate; 8), place a cathode bipolar flow field plate 130 on the assembly, with the active area facing down; 9), place a gold-plated nickel cathode bus bar plate 118 on the assembly, locating the plate so the seal groove segments and apertures align; 10), place a high-density polyethylene insulator plate 114 on the assembly, locating the plate so the seal groove segments and the apertures on each plate align with each other; 11), place the aluminum cathode end plate 104 flat on a horizontal surface, with the seal groove segments facing down; 12), place perimeter bolts or tie rods 131 through the cathode end plate 104 that extend to screw into the anode end plate 102; 13), tighten the perimeter bolts 131 to provide even clamping of the assembly elements, items 1) through 11).

As detailed in FIG. 16a, dispensing hoses 212 were connected to a two-part silicone material dispensing machine 214, that includes a static mixer to thoroughly mix the two parts of the silicone seal material described above. The dispensing hoses were also connected to the threaded connection ports 194 on the aluminum cathode end plate 104. The silicone material was then injected into the assembled elements at a pressure that reached 100 psig over a 20-30 second interval. The peak pressure of 100 psig was held until material was seen exiting the vent groove segments in each of the assembly plates. The dispensing pressure was then decreased to zero. The dispensing hoses were removed and the ports 194 closed with the plugs 200. The stack assembly was placed in an oven preheated to 80° C., and kept in the oven until the seal material was completely cured. The stack assembly was then removed from the oven and allowed to cool to room temperature. The perimeter bolts were retightened to a uniform torque. The stack assembly was then ready to be placed in a fuel cell system.

### EXAMPLE 2

As in Example 1 above, elements of the fuel cell stack were assembled as in step (1)-(13) above. Again, a dispensing hose was connected to a threaded connection port 194 on the aluminum cathode end plate 104. The silicone material was dispersed into the assembled elements at a pressure that reached 200 psig over a 30-40 second interval. The peak pressure of 200 psig was held until material was seen exiting the vent groove segments in each of the assembly plates. The dispensing pressure was then decreased to zero. The dispensing hoses were removed, and plugs 200 inserted as before. The stack assembly was placed in an oven preheated to 80° C., and kept in the oven until the seal material was completely cured. The stack assembly was then removed from the oven and allowed to cool to room temperature. The perimeter bolts were tightened to a uniform torque. The stack assembly was then ready to be placed in a fuel cell system.

### EXAMPLE 3

Three additional examples were prepared, and these additional exemplary compositions were injected into a fuel cell stack and cured, as detailed above for examples 1 and 2. For simplicity and brevity, in the following example, details of the assembly and injection technique are not repeated; just the details of the compositions are given.

TABLE I
Composition of Silicone Material A

| Parts | Ingredients |
|---|---|
| 111.0 | Dimethyl, Trifluoropropylmethyl Siloxane, Dimethylvinylsiloxy- |
| | terminated |
| 39.0 | Silica, Amorphous, Fumed |
| 6.6 | Hexamethyldisilazane |
| 5.0 | 1,3-Diethenyl-1,1,3,3-Tetramethyldisiloxane Platinum Complexes |
| 2.9 | Decamethylcyclopentasiloxane |
| 1.0 | Dimethyl, Methylvinyl Siloxane, Hydroxy-terminated |

100 parts of a polydimethylsiloxane which is dimethylvinylsiloxy terminated, is 30 mole % methyltrifluoropropyl, and had a viscosity of 9,300 cst; 1 part of dimethylmethylvinylsiloxane which is hydroxy terminated and had a viscosity of 40 cst; and 39 parts of fumed silica (with an average surface area of 250 m2/g) that had been surface-treated with 6.6 parts hexamethyldisilazane were blended until homogeneity was achieved. After blending, the material was heat treated under vacuum, again to remove volatiles, to form a base material. This was then cut back or diluted with 11 parts of polydimethylsiloxane which is dimethylvinylsiloxy terminated, is 30 mole % methyltrifluoropropyl, and had a viscosity of 680 cst; 2.9 parts decamethylcyclopentasiloxane that had a viscosity of 25 cst; and 5 parts of 1,3-diethenyl-1,1,3,3-tetramethyldisiloxane platinum complexes which contained an amount of platinum metal atoms equaling 0.52 wt %. The complete composition was blended until homogeneity. The final material or composition was a flowable silicone paste that could be extruded through an ⅛″ orifice at a rate of 186.9 g/min under 90 psig pressure.

TABLE II
Composition of Silicone Material B

| Parts | Ingredients |
|---|---|
| 110.0 | Dimethyl, Trifluoropropylmethyl Siloxane, Dimethylvinylsiloxy- |
| | terminated |
| 38.0 | Silica, Amorphous, Fumed |
| 6.4 | Hexamethyldisilazane |
| 3.8 | Dimethyl, Hydrogensiloxy - Modified Silica |
| 1.0 | Dimethyl, Methylvinyl Siloxane, Hydroxy-terminated |
| 0.2 | 1-Ethynyl-1-Cyclohexanol |

100 parts of a polydimethylsiloxane which is dimethylvinylsiloxy terminated, is 30 mole % methyltrifluoropropyl, and had a viscosity of 9,300 cst; 1 part of dimethylmethylvinylsiloxane which is hydroxy terminated and had a viscosity of 40 cst; and 38 parts of fumed silica (with an average surface area of 250 m2/g) that had been surface-treated with 6.4 parts hexamethyldisilazane were blended until homogeneity was achieved. After blending, the material was heat treated under vacuum to drive off volatiles, so as to form a base material. This was then cut back or diluted with 10 parts of polydimethylsiloxane which is dimethylvinylsiloxy terminated, is 30 mole % methyltrifluoropropyl, and had a viscosity of 680 cst; 3.8 parts of dimethyl, hydrogensiloxy—modified silica with 0.96 wt % silicone-atom-bonded hydrogen atoms and a viscosity of 25 cp; and 0.2 parts 1-ethynyl-1-cyclohexanol which was 99% pure, for use as an inhibitor to the mixed system. The complete composition was blended until homogeneity. The final material or composition was a flowable silicone paste that could be extruded through an ⅛″ orifice at a rate of 259.5 g/min under 90 psig pressure.

The final compositions of material A and material B from above when mixed in a 50:50 ratio and press molded at 171° C. for 5 minutes and post cured for 4 hours at 200° C. exhibited the following characteristics:

TABLE III
Results of Test of Cured Elastomer

| Property | ASTM Method* | Result |
|---|---|---|
| Durometer (Shore A) | ASTM D2240 | 44 |
| Tensile, at Break (psi) | ASTM 412 | 693 |
| Elongation at Break (%) | ASTM 412 | 293 |
| Tear, Die B (ppi) | ASTM 625 | 101 |
| Modulus, at 100% Elongation (psi) | ASTM 412 | 193 |

*Note tests based on the above referenced ASTM Method.

### EXAMPLE 4

TABLE I
Composition of Silicone Material A

| Parts | Ingredients |
|---|---|
| 111.0 | Dimethyl, Trifluoropropylmethyl Siloxane, Dimethylvinylsiloxy- |
| | terminated |
| 39.0 | Silica, Amorphous, Fumed |
| 6.6 | Hexamethyldisilazane |
| 5.0 | 1,3-Diethenyl-1,1,3,3-Tetramethyldisiloxane Platinum Complexes |
| 2.9 | Decamethylcyclopentasiloxane |
| 1.0 | Dimethyl, Methylvinyl Siloxane, Hydroxy-terminated |

100 parts of a polydimethylsiloxane which is dimethylvinylsiloxy terminated, is 40 mole % methyltrifluoropropyl, and had a viscosity of 25,000 cst; 1 part of dimethylmethylvinylsiloxane which is hydroxy terminated and had a viscosity of 40 cst; and 39 parts of fumed silica (with an average surface area of 250 m2/g) that had been surface-treated with 6.6 parts hexamethyldisilazane were blended until homogeneity was achieved. After blending, the material was heated to remove volatiles, so as treated under vacuum to form a base material. This was then cut back or diluted with 11 parts of the copolymer which is dimethylvinylsiloxy terminated, is 40 mole % methyltrifluoropropyl, and had a viscosity of 750 cst; 2.9 parts decamethylcyclopentasiloxane that had a viscosity of 25 cst; and 5 parts of 1,3-diethenyl-1,1,3,3-tetramethyldisiloxane platinum complexes which contained an amount of platinum metal atoms equaling 0.52 wt %. The complete composition was blended until homogeneity. The final material was a flowable silicone paste that could be extruded through an ⅛″ orifice at a rate of 184 g/min under 90 psig pressure.

TABLE II
Composition of Silicone Material B

| Parts | Ingredients |
|---|---|
| 110.0 | Dimethyl, Trifrluoropropylmethyl Siloxane, Dimethylvinylsiloxy- |
| | terminated |
| 38.0 | Silica, Amorphous, Fumed |
| 6.4 | Hexamethyldisilazane |
| 3.8 | Dimethyl, Hydrogensiloxy - Modified silica |
| 1.0 | Dimethyl, Methylvinyl Siloxane, Hydroxy-terminated |
| 0.2 | 1-Ethynyl-1-Cyclohexanol |

100 parts of a polydimethylsiloxane which is dimethylvinylsiloxy terminated, is 40 mole % methyltrifluoropropyl, and had a viscosity of 25,000 cst; 1 part of dimethylmethylvinylsiloxane which is hydroxy terminated and had a viscosity of 40 cst; and 38 parts of fumed silica (with an average surface area of 250 m2/g) that had been surface-treated with 6.4 parts hexamethyldisilazane and were blended until homogeneity was achieved. After blending, the material was heat treated to remove volatiles, so as to form a base material. This was then cut back or diluted with 10 parts of polydimethylsiloxane which is dimethylsiloxy terminated, is 40 mole % methyltrifluoropropyl, and had a viscosity of 750 cst; 3.8 parts of dimethyl, hydrogensiloxy—modified silica with 0.96 wt % silicone-atom-bonded hydrogen atoms and a viscosity of 25 cp; and 0.2 parts 1-ethynyl-1-cyclohexanol which was 99% pure for use as an inhibitor to the mixed system. The complete composition was blended until homogeneity. The final material was a flowable silicone paste that could be extruded through an ⅛″ orifice at a rate of 225 g/min under 90 psig pressure.

The final compositions of material A and material B from above when mixed in a 50:50 ratio and press molded at 171° C. for 5 minutes and post cured for 4 hours at 200° C. exhibit the following characteristics:

TABLE III
Results of Test of Cured Elastomer

| Property | ASTM Method* | Result |
|---|---|---|
| Durometer (Shore A) | ASTM D2240 | 42 |
| Tensile, at Break (psi) | ASTM 412 | 900 |
| Elongation at Break (%) | ASTM 412 | 420 |
| Tear, Die B (ppi) | ASTM 625 | 130 |
| Modulus, at 100% Elongation (psi) | ASTM 412 | 260 |

*Note tests based on the above referenced ASTM Method.

As indicated above, in relation to Example 1, the seal material must be resistant to degradation by fuel cell components. Of specific importance is resistance to the PEM operating environment and resistance to swell in various liquids that may be used as coolants.

Several methods were used to determine resistance to the PEM operating environment. For example, sheets of seal material were placed in contact with sheets of PEM material, rolled tightly and held in position with appropriate banding. Such rolls were then placed in acidic fluids and, separately, heated DI water to provide an accelerated aging test. Such a test was completed with DI water heated to 100 degrees C. for the seal materials listed previously. After 1 month of exposure the material was not hardened or cracked.

### EXAMPLE 5

TABLE I
Composition of Silicone Material A

| Parts | Ingredients |
|---|---|
| 111.0 | Dimethyl, Trifluoropropylmethyl Siloxane, Dimethylvinylsiloxy- |
| | terminated |
| 39.0 | Silica, Amorphous, Fumed |
| 6.6 | Hexamethyldisilazane |
| 5.0 | 1,3-Diethenyl-1,1,3,3-Tetramethyldisiloxane Platinum Complexes |
| 2.9 | Decamethylcyclopentasiloxane |
| 1.0 | Dimethyl, Methylvinyl Siloxane, Hydroxy-terminated |

100 parts of a dimethylsiloxane which is dimethylvinylsiloxy terminated, is 70 mole % methyltrifluoropropyl, and had a viscosity of 20,000 cst; 1 part of dimethylmethylvinylsiloxane which is hydroxy terminated and had a viscosity of 40 cst; and 39 parts of fumed silica (with an average surface area of 250 m2/g) that had been surface-treated with 6.6 parts hexamethyldisilazane were blended until homogeneity was achieved. After blending, the material was heat treated under vacuum, to remove volatiles, so as to form a base material. This was then cut back or diluted with 11 parts of polydimethylsiloxane which is dimethylvinylsiloxy terminated, is 70 mole % methyltrifluoropropyl, and had a viscosity of 1500 cst; 2.9 parts decamethylcyclopentasiloxane that had a viscosity of 25 cst; and 5 parts of 1,3-diethenyl-1,1,3,3-tetramethyldisiloxane platinum complexes which contained an amount of platinum metal atoms equaling 0.52 wt %. The complete composition was blended until homogeneity. The final material was a flowable silicone paste that could be extruded through an ⅛″ orifice at a rate of (136) g/min under 90 psig pressure.

TABLE II
Composition of Silicone Material B

| Parts | Ingredients |
|---|---|
| 110.0 | Dimethyl, Trifluoropropylmethyl Siloxane, Dimethylvinylsiloxy- |
| | terminated |
| 38.0 | Silica, Amorphous, Fumed |
| 6.4 | Hexamethyldisilazane |
| 3.8 | Dimethyl, Hydrogensiloxy - modified silica |
| 1.0 | Dimethyl, Methylvinyl Siloxane, Hydroxy-terminated |
| 0.2 | 1-Ethynyl-1-Cyclohexanol |

100 parts of a dimethylsiloxane which is dimethylvinylsiloxy terminated, is 70 mole % methyltrifluoropropyl, and had a viscosity of 20,000 cst; 1 part of dimethylmethylvinylsiloxane which is hydroxy terminated and had a viscosity of 40 cst; and 38 parts of fumed silica (with an average surface area of 250 m2/g) that had been surface-treated with 6.4 parts hexamethyldisilazane and were blended until homogeneity was achieved. After blending, the material was heat treated under vacuum, to remove volatiles, so as to form a base material. This was then cut back or diluted with 10 parts of the polydimethylsiloxane which is dimethylvinylsiloxy terminated, is 70 mole % methyltrifluoropropyl, and had a viscosity of 1500 cst; 3.8 parts of dimethyl, hydrogensiloxy—modified silica with 0.96 wt % silicone-atom-bonded hydrogen atoms and a viscosity of 25 cp; and 0.2 parts 1-ethynyl-1-cyclohexanol which was 99% pure for use as an inhibitor to the mixed system. The complete composition was blended until homogeneity. The final material was a flowable silicone paste that could be extruded through an ⅛″ orifice at a rate of (189) g/min under 90 psig pressure.

The final compositions of material A and material B from above when mixed in a 50:50 ratio and press molded at 171° C. for 5 minutes and post cured for 4 hours at 200° C. exhibit the following characteristics:

TABLE III
Results of Test of Cured Elastomer

| Property | ASTM Method* | Result |
|---|---|---|
| Durometer (Shore A) | ASTM D2240 | 46 |
| Tensile, at Break (psi) | ASTM 412 | 822 |
| Elongation at Break (%) | ASTM 412 | 384 |
| Tear, Die B (ppi) | ASTM 625 | 112 |

*Note tests based on the above referenced ASTM Method.

The material was tested for degradation and compatibility with other PEM components, as for Examples 1 and 4. Thus sheets of seal material were placed in contact with sheets of PEM material, rolled tightly and held in position with appropriate banding. Such rolls were then placed in acidic fluids and, separately, heated DI water to provide an accelerated aging test.

Such a test was completed with DI water heated to 100 degrees C. for the seal materials listed previously. After 1 month of exposure the material was not hardened or cracked.

Several alternative elastomeric materials may be used to form the seals instead of the polysiloxane elastomeric materials described above providing they have a suitable viscosity and rheology. These alternative elastomeric materials may, for example, include one or more of the following: Ethylene Acrylic Polymers such as those sold under the brand Vamac™, Fluoro elastomers such as those sold under the brand Viton™ and Ethylene Propylene Terpolymers such as those sold under the brand Nordel™ (Viton™ and Nordel™ are all Registered trademarks of Du Pont Dow Elastomers L.L.C Corp. and Vamac™ is a registered trademark of E.I. du Pont de Nemours and Co Corp.). Other alternative elastomeric materials may include Epoxy resins and thermoplastic elastomers. It is to be noted however that in some cases these materials would need to be heated prior to filling the stack seal area and/or would not require curing.

Seal compositions in accordance with the invention are detailed below, and it is noted that these are suitable for temperatures in the range of −55° C. to 250° C. In accordance with the present invention a seal that has been formed in place in a fuel cell assembly, which comprises at least one individual fuel cell, or as detailed below, some other electrochemical cell, is designated as a “seal in place” cell stack, or construction.

The method of the invention provides a number of advantages over conventional constructions employing separate gaskets. Firstly, the invention allows efficient and accurate clamping and position of the membrane active area of each fuel cell. In contrast, in conventional techniques, all the elements of a multi-cell stack are assembled with the elements slightly spaced apart, and it is only the final clamping that draws all the elements together in their final, clamped position; this can make it difficult to ensure accurate alignment of different elements in the stack. The tolerance requirements for grooves for the seal can be relaxed considerably, since it is no longer necessary for them to correspond to a chosen gasket dimension. The liquid material injected can compensate for a wide range of variations in groove dimensions. Combining these attributes of the invention allows the utilization of significantly thinner plate constructions. The current trend in fuel cell design calls for thinner and thinner flow plates, with the intention of reducing the overall dimensions of fuel cell stack of a given power. Using the sealing technique of the invention the grooves can have a relatively thin bottom wall, i.e. the wall opposite of the open side of the groove. This is because when the stack is first assembled, there is no pressure in the groove, and, in an assembled condition, the configuration can be such as to provide support for any thin-walled sections. Only after assembly is the sealing material injected and cured.

Use of a liquid sealant that is cured to form an elastomeric material allows the use of materials designed to chemically bond to various elements of the fuel cell stack, thereby ensuring and/or enhancing the seal performance. This should also increase the overall durability of the fuel cell stack. Also, it is anticipated that some fuel cell stack designs will use aggressive coolants, e.g. glycols, and with the invention it is a simple matter to select a seal material compatible with the coolant and other fluids present.

The invention also provides for a more economic construction. As noted, it is not necessary for grooves to be formed to accurate dimensions. Additionally, no complex tooling is required for gaskets and there is no wastage of gasket material as that which occurs when cutting gaskets from sheet material. Thus, when designing a fuel cell stack in accordance with the present invention, it is simply necessary to design and manufacture the individual elements of the stack, and it is not necessary to provide for separate manufacture of new and different gaskets.

In addition, the ability of the seal to bond the elements together facilitates the production of membrane electrode units (MEU). The MEUs could each comprise a single fuel cell or a small number of fuel cells. Each unit may have end surfaces adapted for mating within surfaces of corresponding MEUs, e.g. to form coolant chambers; for this purpose, a seal may be molded on one or both ends of each MEU. The MEUs can then be assembled and clamped together to form a fuel cell stack of a desired power level.

If a release agent is employed, whether applied on the surface of fuel cell components or added to the seal material, the release agent enables the fuel cell stack to be easily disassembled and defective cells be repaired without discarding the whole fuel cell stack. In particular, one cell may be disassembled, several cells may be disassembled or the entire fuel cell stack may be disassembled. This renders the invention suitable for mass production while maintaining flexibility in terms of repair and maintenance and further reduces the cost of building and using fuel cell stacks.

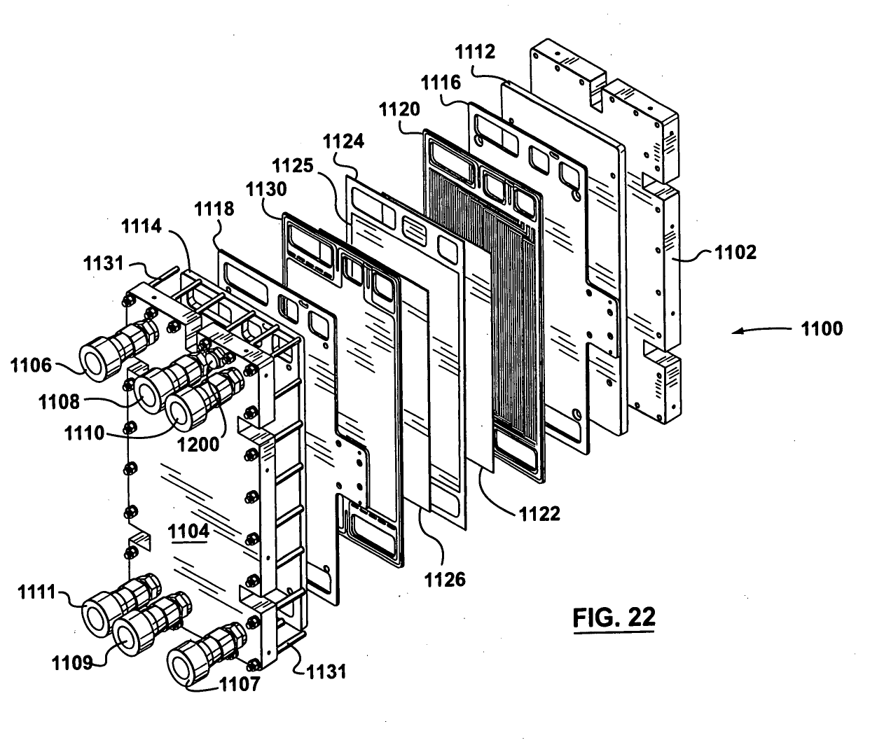

Referring now to FIG. 22, shown therein is an alternative embodiment of the basic elements of a fuel cell stack 1100 in accordance with the invention. The fuel cell stack 1100 includes an anode endplate 1102 and a cathode endplate 1104. In contrast to fuel cell stack 100, only the endplate 1104 is provided with connection ports for supply of the necessary fluids. Air connection ports are indicated at 1106, 1107; coolant connection ports are indicated at 1108, 1109; and hydrogen connection ports are indicated at 1110, 1111. In other alternatives, the connection ports may only be located at the anode end of the fuel cell stack 1100. In another alternative, both ends of the fuel cell stack 1100 may have connection ports.

The various ports 1106-1111 are connected to distribution channels or ducts that extend through the fuel cell stack 1100, as for the earlier embodiments. However, since the ports 1106-1111 are only on one end of the fuel cell stack 1100, the fuel cell stack 1100 operates in closed-end mode, i.e. the reactant fluids and the coolant are supplied to and discharged from the same end of the fuel cell stack 1100. Accordingly, the anode end plate 1102 does not come into contact with the reactant fluids and the coolant while the cathode end plate 1104 does come into contact with the reactant fluids and the coolant. This simplifies the sealing requirements for the components on the anode end of the fuel cell stack 1100.

Immediately adjacent the anode and cathode endplates 1102, and 1104, there is an anode insulator plate 1112 and a cathode insulator plate 1114, respectively. Immediately adjacent the insulators plates 1112 and 1114, in known manner, there is an anode current collector plate 1116 and a cathode current collector plate 1118, respectively. Between the current collector plates 1116 and 1118, there is a plurality of fuel cells, the elements of only one of which is shown for simplicity. Thus, there is shown an anode flow field plate 1120, a first GDM 1122, an MEA 1124, a second GDM 1126 and a cathode flow field plate 1130.

To hold the assembly together, tie rods 1131 are provided, which are screwed into threaded bores in the anode endplate 1102, passing through corresponding plain bores in the cathode endplate 1104. As known to those skilled in the art, nuts and washers are provided, for tightening the whole assembly and to ensure that the various elements of the individual fuel cells are clamped together. The fuel cell stack 1100 also includes a closure plug 1200 for closing off a sealing groove network comprising various seal grooves and channels for receiving a seal material to provide seals for the various components of the fuel cell stack 1100 as explained previously.

The anode endplate 1102 may be made from aluminum and is anodized. The anode endplate 1102 may be 1.5 inches in thickness. Accordingly, the anode endplate 1102 is thicker than the anode endplates of prior fuel cells. The increased thickness provides increased rigidity and strength for the fuel cell stack 1100 and prevents bending and compression buoying. The cathode endplate 1104 may also have an increased thickness of 1.5 inches and may also be made from aluminum. The increased thickness of both of the anode and cathode endplates 1102 and 1104 allow the endplates 1102 and 1104 to be as flat and parallel as possible. This helps to prevent flashing of the seal material during the seal-in-place process.

The use of aluminum allows the anode and cathode endplates 1102 and 1104 to be more resistant to temperature. In addition, the anode and cathode endplates 1102 and 1104 are anodized to prevent corrosion in the event that the endplates 1102 and 1104 come into contact with a corrosive liquid. In the case of the anode endplate 1102, the exterior of the anode endplate 1102 may come into contact with a liquid. In addition, since ports are not needed for the anode endplate 1102, seals are not required. Accordingly, the sealing procedure for the fuel cell stack 1100 is simplified which results in a cost savings for manufacturing the fuel cell stack 1100. The anode endplate 1102 also includes four apertures (not shown) for receiving additional fastening means, such as Teflon™ screws, which can be used in addition to the tie rods for holding the assembly together.

The anode and cathode insulator plates 1112 and 1114 may be 0.275 inches in thickness and may be made from Noryl™ which allows the insulator plates 1112 and 1114 to have increased dimensional stability, low water absorption and increased heat resistance. Noryl™ also provides excellent electrical properties and increased chemical resistance which allows the insulator plates 1112 and 1114 to be more resistant to various types of environments. The anode and cathode insulator plates 1112 and 1114 also include additional apertures for receiving the additional fastening means. Other materials which can also be used include polyphenalyne-oxide (PPO) and polyphenalyne-epoxide (PPE). Many other suitable polymers may also be used for the insulator plates which can provide thermal and electrical isolation in the fuel cell stack 1100 and not deform under the load and temperature conditions that are typically experienced in practice.

The anode insulator plate 1112 is on the dry end of the fuel cell stack 1100 and accordingly does not require any through holes or sealing grooves. This also results in increased simplicity and cost reduction for manufacturing the fuel cell stack 1100.

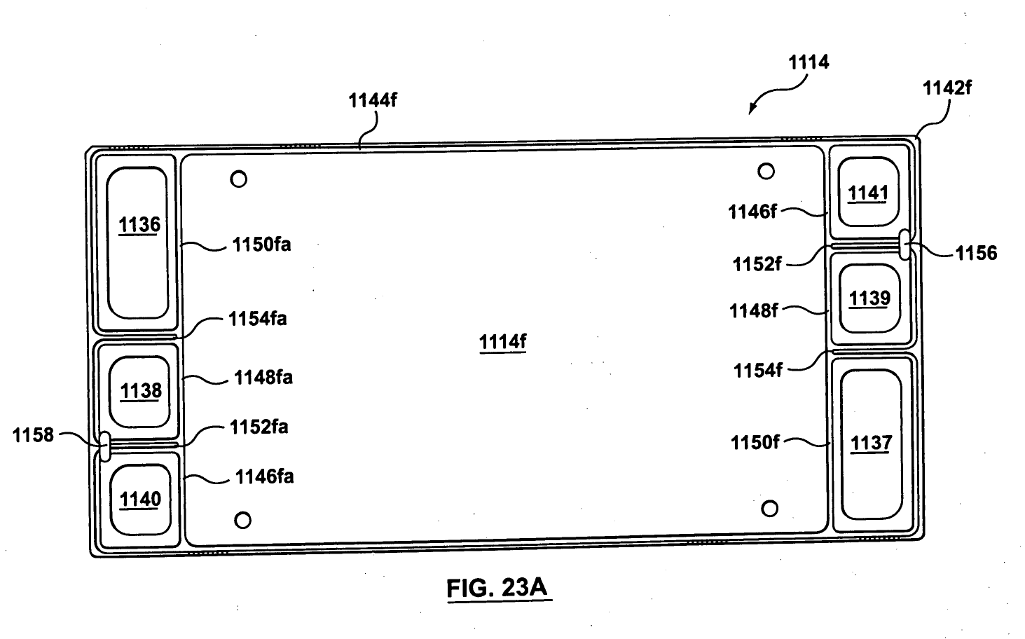

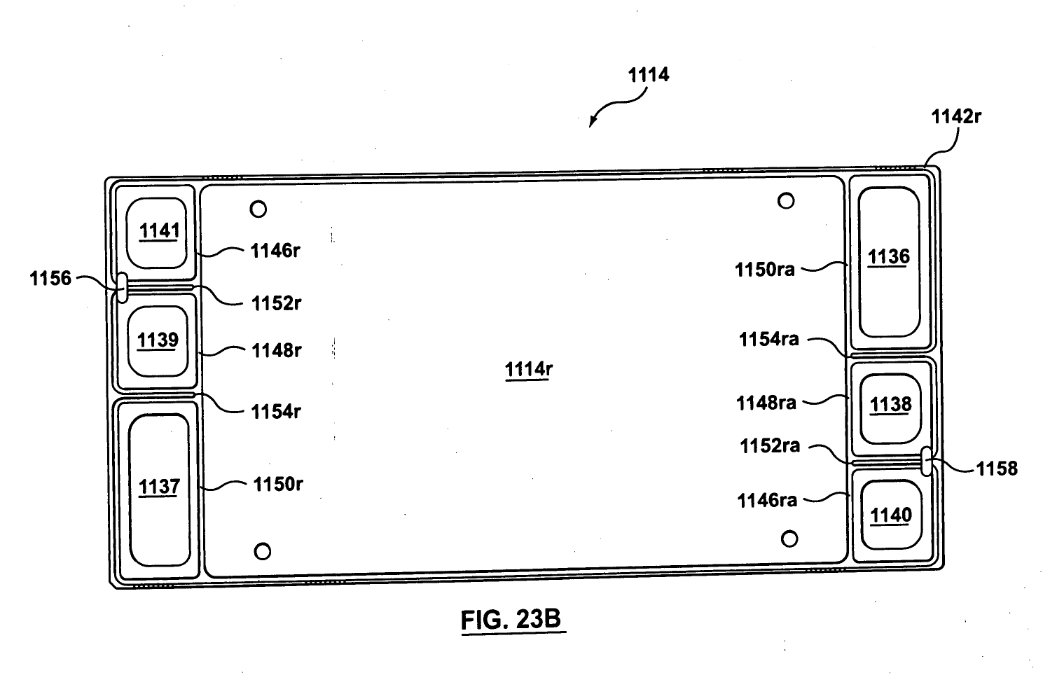

Referring now to FIGS. 23a and 23b, shown therein, respectively, are front and rear views of the cathode insulator plate 1114. The cathode insulator plate 1114 is on the wet end of the fuel cell stack 1100 and accordingly includes six apertures 1136-1141. Corresponding to the ports 1106-1111 of the fuel cell stack 1100, the cathode insulator plate 1114 has rectangular apertures 1136, 1137 for air flow; generally square apertures 1138, 1139 for coolant flow; and generally square apertures 1140, 1141 for hydrogen flow. These apertures 1136-1141 are aligned with the ports 1106-1111. Corresponding apertures are provided in all the components on the wet end of the fuel cell stack 1100, so as to define ducts or distribution channels extending through the fuel cell stack in known manner and accordingly are numbered in a likewise fashion.

To provide a good seal for the fuel cell stack 1100, the cathode insulator plate 1114 includes seal grooves on both surfaces. The seal grooves are part of a larger groove network. The seal grooves are configured to accept and to define a flow of a sealant material that forms a seal throughout the fuel cell stack. The use of Noryl™ allows the cathode insulator plate 1114 to form a better bond with the seal material.

On the front face 1114f of the cathode insulator plate 1114 there is a seal groove network indicated at 1142f. The seal groove network 1442f may have a depth of 18 thou and the width may vary along the perimeter of the insulator plate 1114. The groove network 1142f includes side grooves 1144f as indicated. These side grooves 1143f may also have a width of 100 thou.

At one end, around the apertures 1141, 1139 and 1137, the groove network 1142f provides corresponding rectangular groove portions 1146f, 1148f and 1150f respectively. There is a groove junction portion 1152f separating groove portions 1146f and 1148f and a groove junction portion 1154f separating groove portions 1148f and 1150f. On the other end of the front face 1114f of the cathode insulator plate 1114, the groove portions and groove junction portions are labeled in a similar fashion except with the addition of an “a”. Also included are two apertures 1156 and 1158 so that the seal material can propagate through the fuel cell stack 1100 during the seal-in-place process.

The rear face 1114r of the cathode insulator plate 1114 has a similar groove network indicated at 1142r. Accordingly, the portions of the groove network 1142r have been labeled similarly to the portions of the groove network 1142f except with the “f” suffix replaced by an “r” suffix.

The anode and cathode current collector plates 1116 and 1118 may have a thickness of approximately 1/8 inches and may be made from aluminum. The plates 1116 and 1118 may be coated with a suitable metallic coating such as a 0.001 inch thick Nickel coating for example. Since the anode current collector plate 1116 is on the dry end of the fuel cell stack 1100, there are no through holes in the anode current collector plate 1116 and the anode current collector plate 1116 is entirely coated with Nickel.

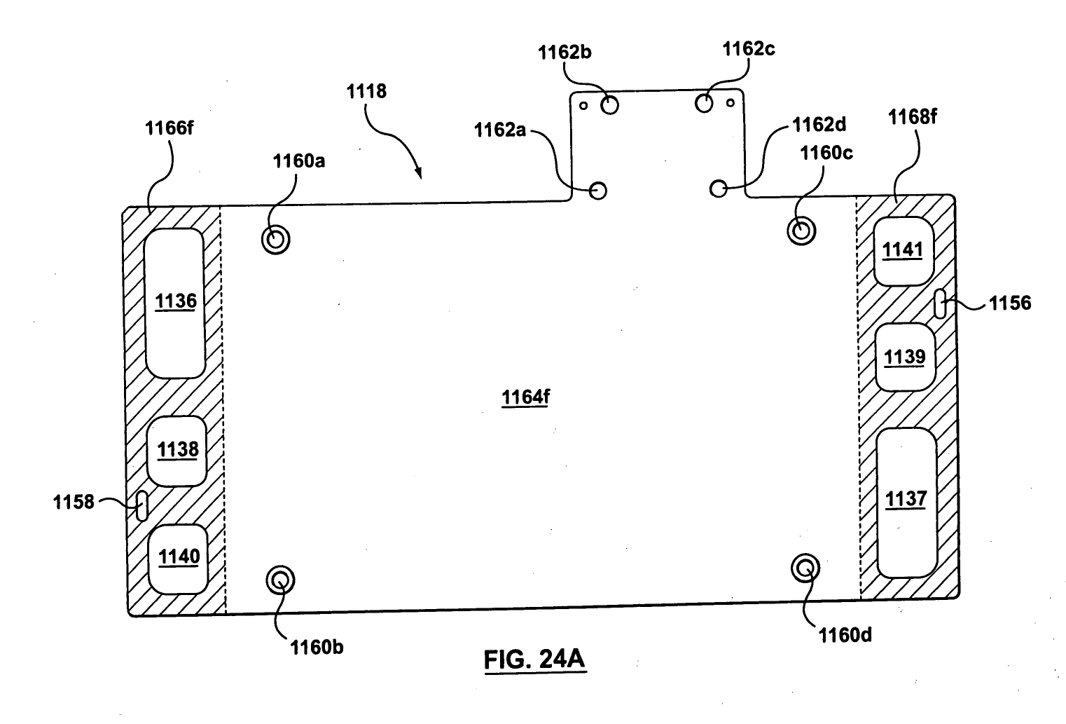

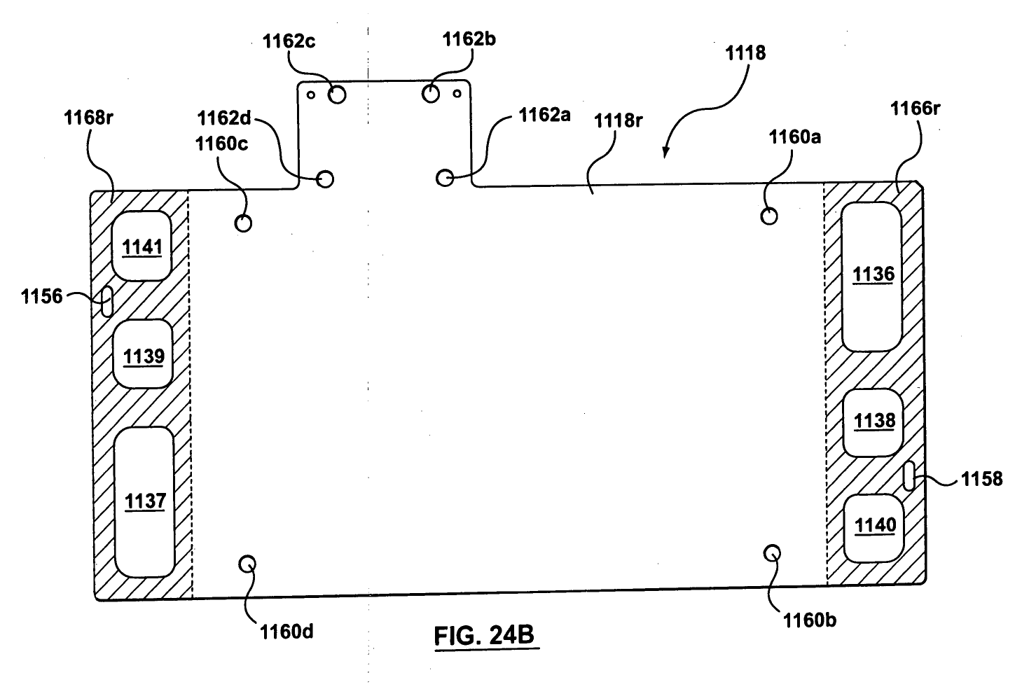

Referring now to FIGS. 24a and 24b, shown therein are front and rear views, respectively, of the cathode current collector plate 1118. Since the cathode current collector plate 1118 is on the wet end of the fuel cell stack 1100, the cathode current collector plate 1118 includes apertures 1136-1141 for the coolant, fuel and oxidant flows. The anode and cathode current collector plates 1116 and 1118 also include four apertures 1160a-1160d for receiving additional fastening means. The cathode current collector plate 1118 also includes apertures 1156 and 1158 for allowing the seal material to pass through the fuel cell stack 1100. The cathode current collector plate 1118 also includes apertures 1162a-1162d for connection to an external electrical circuit.

In addition, on the front face 1118f of the cathode current collector plate 1118, there is a central electroless nickel plated area 1164f, that may be coated with a suitable metallic coating such as a 0.001 inch thick layer of nickel, for example. There are also preferably two hard anodized areas 1166f and 1168f on either end where the apertures 1136-1141 come into contact with various types of fluids. The end portions 1166f and 1168f of the cathode current collector plate 1118 are hard anodized to prevent corrosion. In this exemplary embodiment, the ends of the cathode current collector plate 1118 are hard anodized with a 0.0001 inch think layer of an appropriate oxide, however, other thicknesses may be used as appropriate. The anodization of the cathode current collector plate 1118 is described in more detail in U.S. patent application Ser. No. 10/639,689 filed on Aug. 13, 2003.

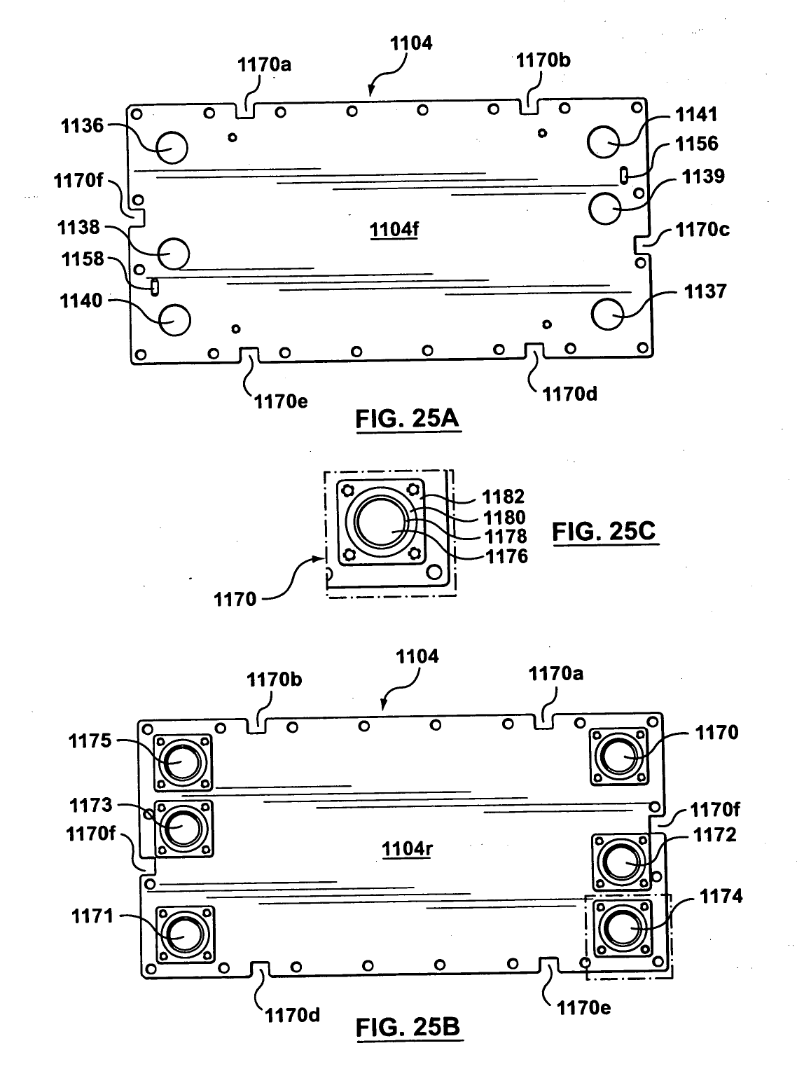

Referring now to FIG. 25a, shown therein is a view of the front 1104f of the cathode endplate 1104. The cathode endplate 1104 includes a plurality of notches 1170a-1170f that are used to align the cathode endplate 1104 to the other fuel cell components during the construction of the fuel cell stack 1100. The cathode endplate 1104 also includes a plurality of apertures for receiving the tie rods to secure the cathode endplate 1104 to the fuel cell stack 1100. Also included are sealing apertures 1156 and 1158 for receiving the seal material during the seal-in-place process. The cathode endplate 1104 also includes apertures 1136-1141 for the air, coolant and hydrogen flows.

Referring now to FIG. 25b, shown therein is a view of the rear 1104r of the cathode endplate 1104. The cathode endplate 1104 includes flange connections 1170 and 1171 that correspond to air ports 1106 and 1107, flange connections 1172 and 1173 that correspond to coolant ports 1108 and 1109 and flange connections 1174 and 1175 that correspond to hydrogen ports 1110 and 1111. The sealing apertures 1156 and 1158 cannot be seen in FIG. 25a because the sealing apertures 1156 and 1158 do not open to the rear of the cathode endplate 1104 (recall that direction is relative to the MEA 1124). Rather, the sealing apertures 1156 and 1158 open to the edges of the cathode endplate 1104, either to the top, bottom or the sides of the cathode endplate 1104. Accordingly, there may be an elbow joint incorporated into the sealing conduit that connects the seal apertures 1156 and 1158 to the respective apertures that open to the side, top or bottom edges of the cathode endplate 1104.

Referring now to FIG. 25c, shown therein is an enlarged view of one of the flange connections 1170. Each flange connection is similar and so only the flange connection 1170 is described in detail. The flange connection 1170 includes an aperture 1176, a raised member 1178 encircling the aperture 1176, and a recessed member 1180 encircling the raised member 1178. The flange connection 1170 also includes an outer base 1182 for attaching the flange connection 1170 to the cathode end plate 1104. The height of the raised member 1178 is at least as high as the outer base 1182 and may be higher than the outer base 1182. This configuration enables a good fit to be made with the corresponding port 1106.

Since the fuel cell stack 1100 has one dry end, there is a reduction in the number of seals that are required for the entire fuel cell stack 1100. Consequently, the fuel cell stack 1100 can be assembled more easily and economically compared to fuel cell stack 100. Further, the fuel cell stack 1100 is more mechanically robust due to the increased thickness used for the cathode and anode endplates 1102 and 1104, and the anode and cathode insulator plates 1112 and 1114. Due to the increased thickness, these plates are flatter and more able to withstand compression forces or pressure and therefore remain flat and substantially parallel to one another which results in more uniform and better performance for the fuel cell stack 1100. The mechanical robustness also results in an increased lifetime for the fuel cell stack 1100.

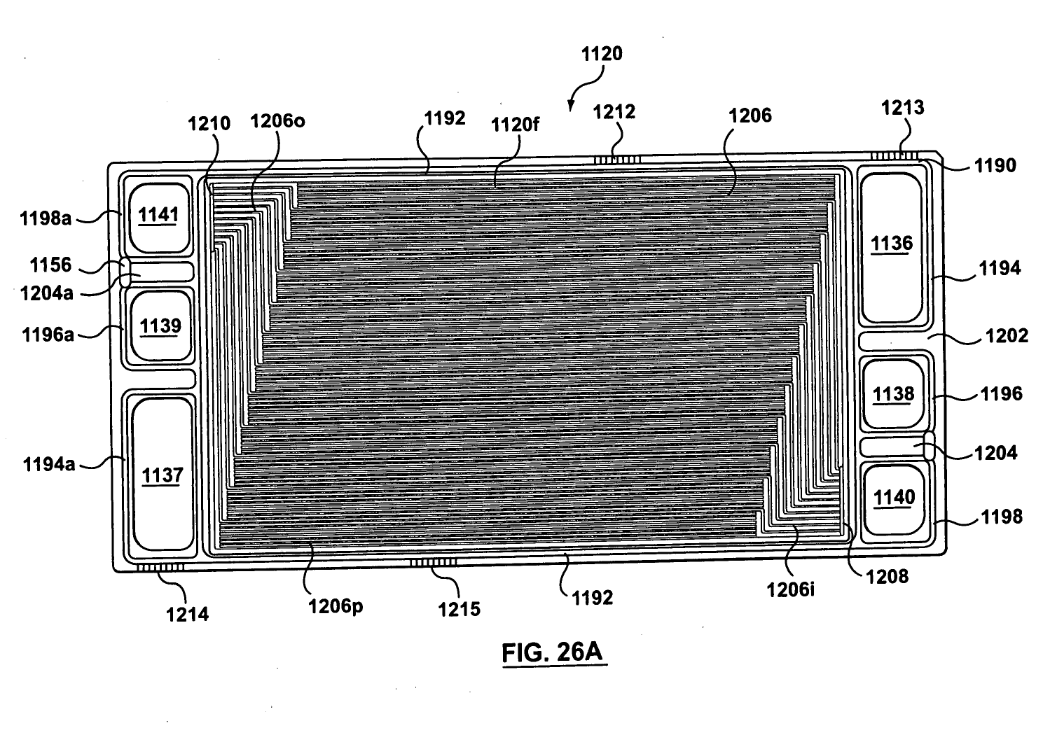

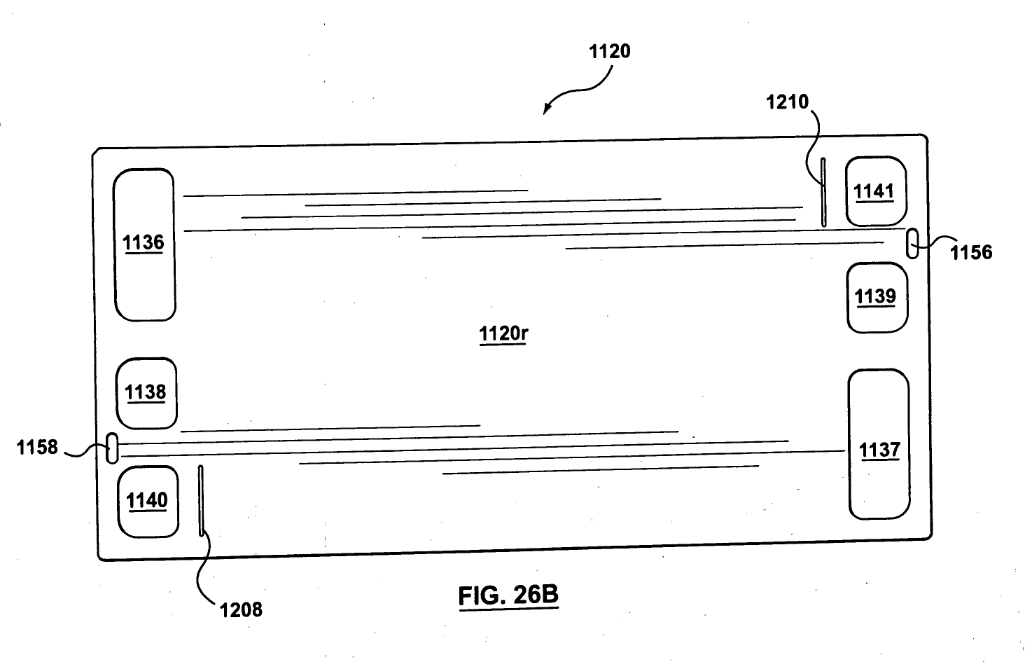

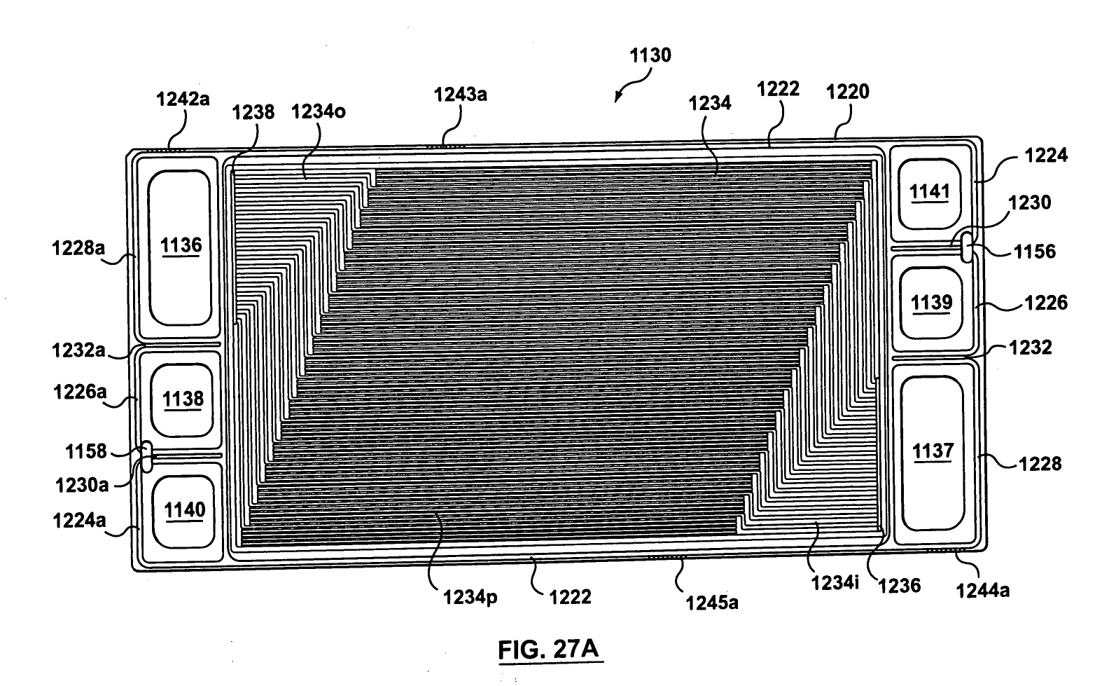

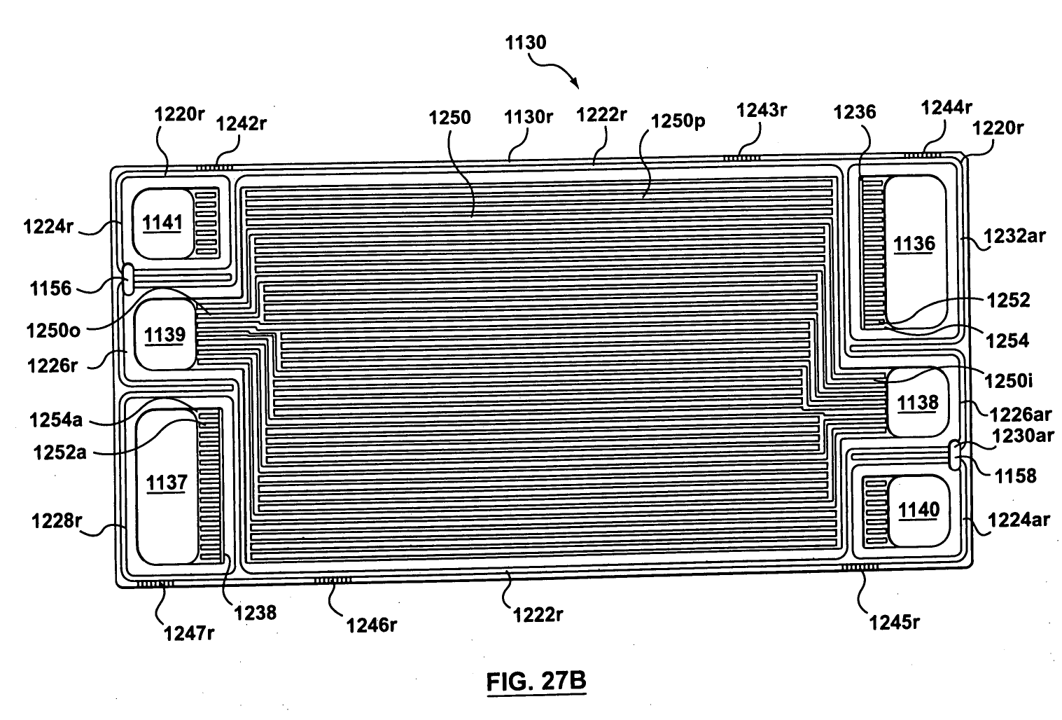

Referring now to FIGS. 26a and 26b shown therein are front and rear views, respectively, of the anode flow field plate 1120. The front face 1120f of the anode flow field plate 1120 may be referred to as the active side and the rear face 1120r of the anode flow field plate 1120 may be referred to as the passive side. In this exemplary embodiment, the thickness of the anode flow field plate 1120 has been reduced to 0.045 inches in comparison to earlier designs. However, a minimum thickness of 0.025 inches may be maintained in certain regions of the anode flow field plate 1120 to ensure that the plate 1120 is mechanically sound when constructed with the usual composite plate materials since too much flex or porosity would otherwise result.

The front face 1120f of the anode flow field plate 1120 includes a seal groove network 1190 that includes side seals 1192, seal groove portions 1194, 1196 and 1198 that encircle apertures 1136, 1138 and 1140 respectively. The seal groove network 1190 also includes a seal groove junction portion 1202 that separates apertures 1136 and 1138 and a seal groove junction portion 1204 that separates apertures 1138 and 1140. Corresponding groove portions and groove junction portions are at the other end of the anode flow field plate 1120 surrounding apertures 1141, 1139 and 1137 and have been labeled similarly with an “a” appended to the labels. The width of the grooves in the seal groove network 1190 are also smaller than the corresponding grooves on the anode flow field plate 120. The width and depth of the sealing grooves in the seal groove network 1190 may be 100 thou and 17 thou respectively. The smaller-sized sealing grooves enables one to choose a smaller thickness for the flow field plates which translates into a smaller stack volume and a higher power density (i.e. the same amount of output power can be derived from a smaller sized stack because thinner flow field plates are used). One approach may be to reduce the thickness of the flow field plates by a desired percentage. A seal material with an appropriate viscosity may also be used in conjunction with the smaller-sized sealing grooves so that the sealing grooves fill at an appropriate rate. The volume for each of the sealing grooves on both sides of the front side of the anode flow field plate 1120 and both sides of the cathode flow field plate 1130 are also preferably selected so that the seal fill time is the same for each sealing groove. In fact, it be preferable to have a reduced seal groove depth in the range of approximately 0.010 to 0.0125 depending on which flow field plate the seal groove is on as well as whether the seal groove is on the active or passive side of the flow field plate.

Further, the rib in the groove junction portions 1202, 1202a, 1204 and 1204a are wider than the corresponding groove junction portions on the anode flow field plate 120. The width may be approximately 0.35 thou. The rib in each of the groove junction portions 1202, 1202a, 1204 and 1204a also extends beyond the apertures that they are adjacent to. Both of these features are beneficial for increased plate support and for reducing the likelihood that flashing occurs during the seal in place process.

In addition, the sealing groove network 1190 is connected to apertures 1156 and 1158 to receive the seal material during the seal-in place process. The apertures 1156 and 1158 are spaced further inward from the edge of the anode flow field plate 1120 in comparison to the anode flow field plate 120 so that the anode flow field plate 1120 is not as likely to break in this region during the seal in place process.

The front face 1120f of the anode flow field plate 1120 also includes a plurality of reactant gas flow channels 1206 that are connected to a slot 1208 at one end of the anode flow field plate 1120 and another slot 1210 at another end of the anode flow field plate 1120. The reactant gas flow channels 1206 include inlet distribution channels 1206i, primary reactant gas flow channels 1206p and outlet collection channels 1206o. The primary reactant gas flow channels 1206p receives reactant gas flow from the inlet distribution channels 1206i and the primary reactant gas flow channels 1206p deliver the remaining reactant gas flow to the outlet collection channels 1206o.

The slots 1208 and 1210 are connected to apertures 1140 and 1141 respectively, in a known backside feed manner as described in U.S. patent application Ser. No. 09/855,018 filed May 15, 2001. However, it should further be noted that, in this exemplary embodiment, the backside feed channels are provided only on the rear of one of the flow field plates; in this case the cathode flow field plate 1130. Accordingly, one set of backside feed channels provides the backside feed for adjacent anode and cathode flow field plates. This reduces manufacturing costs as well as other benefits. The slot 1208 and a first set of corresponding backside feed channels provide a first feed structure that enables reactant gas flow from the aperture 1140 to the inlet distribution channels 1206i. The slot 1210 and a second set of corresponding backside feed channels provide a second feed structure that enables reactant gas flow from the outlet collection channels 1206o to the aperture 1141. The backside feed channels may have a width of 0.09 inches and the ribs forming the walls around the channels may have a width of 0.077 inches. This provides a backside feed channel density of approximately 6 channels per inch.

However, in contrast to the anode flow field plate 120 of the fuel cell 100, the slots 1208 and 1210 are long continuous slots that feed a plurality of reactant gas flow channels rather than a plurality of smaller slots that feed two reactant gas flow channels. The length of the slots 1208 and 1210 are longer than the cumulative length of the transfer slots 178 in the anode flow field plate 120. This allows the slots 1208 and 1210 to deliver a larger amount of reactant gas to the front of the anode flow field plate 1120. The slots 1208 and 1210 may have a length of 1.27 inches and a width of 0.062 inches. Further the length of the slots may be just longer than the length of the adjacent edge of the aperture which provides the reactant gas that is eventually fed through the slots 1208 and 1210.

In addition, there is a larger number of reactant gas flow channels that are fed by the slots 1208 and 1210 as well as a larger number of reactant gas flow field channels across the face of the anode flow field plate 1120 in comparison to anode flow field plate 120. Accordingly, the anode flow field plate 1120 has a higher density of reactant gas flow field channels than anode flow field plate 120. This is achieved by decreasing the width of the flow field channels 1206. The smaller size of the reactant gas flow channels reduces the speed of the reactant gas flow. However, this advantageously allows more of the reactant gas to diffuse across the GDM 1122 for reaction on the MEA 1124. For this exemplary embodiment, the reactant gas flow channels have a width of 0.08 inches and a depth of 0.025 inches and the ribs which separate the reactant gas flow channels have a width of 0.0325 inches. This relates to a reactant gas channel density of approximately 9 channels per inch. The new layout for the reactant gas flow field channels provides upwards of 50 mV of performance improvements for 1 A/cm² current density when compared to previous designs. This translates to an increase of approximately 25 W per fuel cell or an increase of 5-10% in output power.

The front face 1120f of the anode flow field plate 1120 may also include vents 1212-1215 for enabling air to vent from the seal groove network 1192 during the seal-in-place process. This ensures that there are no bubbles in the seal when the seal material cures. The locations of the vents 1212-1215 may be optimized to vent air in an appropriate fashion. The vents may have a length of 0.78 inches and a depth of 0.003 inches. As can be seen, the location and lengths of the vents 1212-1215 have been modified compared to those of the anode flow field plate 120.

The vents 1212-1215 may have a variety of different configurations and may have a rectangular, oval, circular or any other desired profile. Preferably, the vents 1212-1215 open to the exterior. However, the vents 1212-1215 could open to any part of the fuel cell stack 1100 that, at least during initial manufacture, is open to the atmosphere. Furthermore, the vents 1212-1215 are preferably serrated so that each vent 1212-1215 may be considered to comprise several “mini-vents”. The serrations may be provided by several ribs which are placed perpendicularly with respect to the longitudinal extent of each vent. The number of ribs, width of the ribs and width of the grooves between each rib can be varied as needed. The serrations reduces the possibility that a vent can become totally blocked. The serrations also allow one to see which direction the seal material is coming from and allows one to determine if there is one side of the flow field plate that is being sealed quicker than the other side (recall that there are two sealing apertures in the flow field plate).

While, the vents 1212-1215 are dimensioned so as to permit excess air to be-vented to the exterior during the seal filling process, they are small enough to allow fill pressures to build up to a level that allows all of the groove segments in the assembly to fill completely. As explained previously, the vents 1212-1215 may also be located where seal material flows converge since air can potentially be trapped when multiple uncured seal material fronts meet one another. In this embodiment, the vents 1212 and 1215 are offset with respect to the horizontal midpoint of the flow field plate 1120 and are opposite one another in a symmetrical fashion. The vents 1213 and 1214 are located off-center with respect to the mid-point of the reactant and oxidant apertures and are also located in a symmetrical fashion with respect to the horizontal mid-point of the flow field plate 1120.

As can be seen in this exemplary embodiment, the cooling channels, backside feed channels and sealing grooves have been removed from the rear face 1120r of the anode flow field plate 1120. This is in contrast to the anode flow field plate 120 of the fuel cell stack 100. The removal of the cooling channels, backside feed channels and the sealing grooves provides for a reduction in the manufacturing cost and the overall thickness of the anode flow field plate 1120. The backside feed channels are on the rear side of the adjacent cathode flow field plate 1130. Alternatively, all of these modifications may be applied to the anode flow field plate rather than the cathode flow field plate.

Referring now to FIGS. 27a and 27b shown therein, are front and rear views, respectively, of the cathode flow field plate 1130. The front face 1130f of the cathode flow field plate 1130 may also be referred to as the active side and the rear face 1130r of the cathode flow field plate 1130 may also be referred to as the passive side. The thickness of the cathode field plate 1130 has been reduced to 0.07 inches in comparison to earlier designs. However, a minimum thickness of 0.025 inches is maintained for all regions of the cathode flow field plate 1130 to ensure that the plate 1130 is mechanically sound.

The front face 1130f of the cathode flow field plate 1130 has a seal groove network 1220 which includes side grooves 1222 and seal groove portions 1224, 1226 and 1228 that encircle apertures 1141, 1139 and 1137 respectively. The seals in the seal groove network 1220 may have a width of 0.094 inches and a depth of 0.018 inches. The seal groove network 1220 also includes a seal groove junction portion 1230 that separates the groove portions around apertures 1141 and 1139 and a seal groove junction portion 1232 that separates the groove portions around apertures 1139 and 1137. The seal groove junction portions 1230 and 1232 may have a width of 0.1 inches. Corresponding groove portions and groove junction portions are at the other end of the cathode flow field plate 1130 surrounding apertures 1136, 1138 and 1140 and have been labeled similarly with an “a” appended to the labels. The width of the grooves in the seal groove network 1220 are also smaller than the corresponding grooves on the cathode flow field plate 130. This allows the thickness of the cathode flow field plate 1130 to be reduced.

The rib in the grove junction portions 1230, 1230a, 1232 and 1232a extend further than the ribs in the corresponding groove junction portions on the cathode flow field plate 130. The rib in each of the groove junction portions 1230, 1230a, 1232 and 1232a also extend beyond the apertures that it is adjacent to. In addition, the sealing groove network 1220 is connected to apertures 1156 and 1158 to receive the seal material during the seal-in place process. However, the ribs in the groove junction portions 1230, 1230a, 1232 and 1232a are not as wide as the corresponding ribs in the groove junction portions 1202, 1202a, 1204 and 1204a in the anode flow field plate 1130. Accordingly, the seal grooves around the groove junction portions of the anode and cathode flow field plates 1120 and 1130 are offset from one another. This is advantageous since the pressures experienced due to the seal in place process are offset from one another and are better distributed along the anode and cathode flow field plates 1120 and 1130 which reduces the likelihood that these plates will crack during the seal in place process. In addition, this allows a seal to be made at more locations since the seal grooves on the anode flow field plate 1120 are offset from the seal grooves on the cathode flow field plate 1130.

In addition, the apertures 1156 and 1158 are spaced further inward from the edge of the cathode flow field plate 1130 in comparison to the cathode flow field plate 130 so that the cathode flow field plate 1130 is not as likely to break in this region during the seal in place process.

The front face 1130f of the cathode flow field plate 1130 also includes a plurality of reactant gas flow channels 1234 that are connected to a slot 1236 at one end of the cathode flow field plate 1130 and to another slot 1238 at another end of the cathode flow field plate 1130. The reactant gas flow channels 1234 include inlet distribution channels 1234i, primary reactant gas flow channels 1234p and outlet collection channels 1234o. The slots 1236 and 1238 are connected to apertures 1137 and 1136 respectively in a known backside feed manner as described in U.S. patent application Ser. No. 09/855,018 filed May 15, 2001. The slot 1236 and a first set of corresponding backside feed channels provide a first feed structure that enables reactant gas flow from the aperture 1137 to the inlet distribution channels 1234i. The slot 1238 and a second set of corresponding backside feed channels provide a second feed structure that enables reactant gas flow from the outlet collection channels 1234o to the aperture 1136.

However, in contrast to the cathode flow field plate 130 of the fuel cell 100, the slots 1236 and 1238 are long continuous slots that feed a plurality of reactant gas flow channels rather than a plurality of smaller slots that each feed two reactant gas flow channels. The length of the slots 1236 and 1238 are longer than the cumulative length of the transfer slots 180 in the cathode flow field plate 130. This allows the slots 1236 and 1238 to deliver a larger amount of reactant gas to the front of the cathode flow field plate 1130. The length and width of the slots 1236 and 1238 may be 1.27 inches and 0.062 inches respectively.

In addition, there is a larger number of reactant gas flow channels that are fed by the slots 1236 and 1238 as well as a larger number of reactant gas flow field channels across the face of the cathode flow field plate 1130 in comparison to the cathode flow field plate 130. Accordingly, the cathode flow field plate 1130 has a higher density of reactant gas flow field channels than cathode flow field plate 130. This is achieved by decreasing the width of the flow field channels 1234. This reduces the speed of the reactant gas flow through the flow field channels 1234. However, this advantageously allows more of the reactant gas to diffuse across the GDM 1126 for reaction on the MEA 1124. Furthermore, the single slots 1236 and 1238 are easier to manufacture than the plurality of smaller slots 176. The reactant gas flow channels may have a width of 0.03125 inches and a depth of 0.018 inches and the ribs which separate the channels may have a width of 0.044 inches. This provides a channel density of approximately 13 channels per inch. It should be noted that this density is higher than the reactant gas flow channel density on the anode flow field plate 1120. Previous designs used a channel density that was less than or equal to half of the channel density for the anode flow field plate 1120. It should also be noted that the width of the ribs separating the channels is larger than the width of the channels for the reactant gas flow channels on the cathode flow field plate 1130. This is also in contrast to the structure of the reactant gas flow channels on the anode flow field plate 1120.

The rear face 1130r of the cathode flow field plate 1130 also has a seal groove network 1220r that corresponds to the seal groove network 1220. Accordingly, the components of the seal groove network 1220r have been similarly labeled with an “r” suffix. However, it should be noted that the inner edges of the seal groove portions 1224r, 1228r, 1224ar and 1228ar are shifted closer to the central portion of the cathode flow field plate 1130 compared to the inner edges of the seal groove portions 1224, 1228, 1224a and 1228a on the opposite side of the cathode flow field plate 1130. This offset may also be done for the side seal grooves 1222 and 1222r. This has been done for the same reasons given for the fuel cell stack 100, namely to ensure that the stress experienced by the flow field plate during the seal-in-place process is better distributed by employing seal grooves that do not overlap. If the seal grooves were to directly overlap, then these regions of the cathode flow field plate 1130 would be thinner and would be more affected by the seal pressure during the seal-in-place process. In addition, the membrane on the active side would tend to ‘fall into’ one of the two seal grooves when they were overlapping. This prevented seal material from filling in one of the active sides (i.e. the side that filled slower, with a higher pressure drop, had the membrane collapse into it and thus prevent complete seal filling when overlapping seal grooves were used). The seals on the rear seal groove network 1220r may have a width of approximately 0.1 inches and a depth of approximately 0.02 inches. These dimensions are larger than those for the seals in the front seal groove network 1220 since the rear of the cathode flow field plate 1130 provides sealing for both the rear of the anode and cathode flow field plates 1120 and 1130.

It should be noted that the seal path networks 1190 and 1220 on the active sides of the anode and cathode flow field plates 1120 and 1130, respectively, are also offset with respect to one another in accordance with FIG. 1c. This prevents the MEA 1124 from buckling or collapsing either during the seal-in-place process or during regular use. In particular, the side grooves 1222 of the groove network 1220 on the cathode flow field plate face 1130f are closer to the edge of the plate 1130f in comparison to the side grooves 1192 of the groove network 1190 on the anode flow field plate face 1120f. In addition, the seal groove portions 1224, 1224a, 1226, 1226a, 1228 and 1228a of the groove network 1220 of the cathode flow field plate face 1130f are spaced apart further from the apertures 1136-1141 in comparison to the seal groove portions 1194, 1194a, 1196, 1196a, 1198 and 1198a of the groove network 1190 on the anode flow field plate face 1120f. Furthermore, the seal groove junction portions 1230, 1230a, 1232 and 1232a of the groove network 1220 on the cathode flow field plate face 1130f are wider than the corresponding groove junction portions 1202, 1202a, 1204 and 1204a of the groove network 1190 on the anode flow field plate face 1120f.

The inventors have found that a reduced depth may be used for the seal grooves on the anode and cathode flow field plates 1120 and 1130 based on using a sealant material with an appropriate viscosity and using an appropriate fill pressure during the seal in place process. This in turn allows for reducing the thickness of the anode and cathode flow field plates 1120 and 1130. In particular, the depth of the seal groove for the front face 1130f of the cathode flow field plate 1130 may be reduced to 0.018 inches and the depth of the seal groove for the rear face 1130r of the cathode flow field plate 1130 may be reduced to 0.02 inches while the depth of the seal groove for the front face 1120f of the anode flow field plate 1120 may be reduced to 0.017 inches. Previously, for conventional fuel cell stacks that employed gaskets, the seal groove depths presented a lower bound on the thickness of the flow field plates. However, the seal-in-place technology has allowed for the use of shallower seal grooves which in turn allows for a reduction in flow field plate thickness. This increases the power density of the fuel cell stack 1100 and reduces fabrication cost since not as much material is needed.

In another aspect of the invention, the seal groove depths, and widths have been optimized to ensure that the seal grooves on the cathode and anode flow field plates 1120 and 1130 require the same amount of time to be filled with the sealant material during the seal-in-place process. Essentially, the seal groove volume and thus the total seal volume on both sides of the cathode flow field plate 1130 and on the active side of the anode flow field plate 1120 have been made approximately the same. However, an appropriate seal pressure must also be selected to ensure that the seal filling time is approximately the same on both sides of the cathode flow field plate 1130 and on the active side of the anode flow field plate 1120. If some of the seal groove networks fill faster than others then flashing may occur and the seal material may get into unwanted areas or simply flow through the vents. In either case seal material is wasted and in the case of flashing, fuel cell efficiency, and perhaps even operability, may be affected.

The front and rear faces 1130 and 1130r of the cathode flow field plate 1130 may also include vents 1242a-1245a and 1242r-1247r that are used to vent air from the seal groove network 1220r during the seal-in-place process. This ensures that there are no bubbles in the seal when the seal material cures. The locations of the vents 1242a-1245a, 1242r-1247r have been optimized to remove the air in an appropriate fashion. On the front face of the cathode flow field plate 1130, the vents 1242a and 1244a may be located off-center with respect to the apertures that provide reactant and oxidant flow as well as be located near the corners of the cathode flow field plate 1130. The vents 1242a and 1244a are also located anti-symmetrically about the horizontal midpoint of the cathode flow field plate. The vents 1243a and 1245a are also located off-center with respect to the horizontal midpoint of the cathode flow field plate 1130 also in an anti-symmetrical fashion. The location of the vents 1242a-1245a is slightly similar to the vents on the front face of the anode flow field plate 1120 but slightly offset along the horizontal and vertical dimensions of the flow field plates. This allows one to see the sealant material to pour out of the flow field plate in different locations for the anode and cathode flow field plates so that one can determine which flow field plate was sealed first. On the rear face of the cathode flow field plate 1130, the vents 1244r and 1247r are located in a similar fashion to vents 1242a and 1244a on the front face of the cathode flow field plate 1130 as well as vents 1213 and 1214 on the front face of the anode flow field plate 1120. Vents 1242r and 1245r are also located off the midline of the apertures that provide reactant and coolant flow and they are also located in an anti-symmetrical fashion with regards to the horizontal midline of the cathode flow field plate 1130. Vents 1243r and 1246r are also located in an anti-symmetrical fashion although these vents are spaced further from the horizontal midline of the cathode flow field plate 1130 in comparison to the distance of the vents 1212 and 1215 from the horizontal midline of the anode flow field plate 1120. The longer and more complex of a seal groove path on the active side, the more air that is involved and needs to be expelled efficiently. Accordingly, a greater number of vents are needed or a long and complex seal groove path.

The depth of the vents 1242a-1245a and 1242r-1247r may be 0.003 inches and the length of these vents may be 0.4 inches. The size of the vents 1242a-1245a and 1242r-1247r are larger than those used in the cathode flow field plate 130. Also, there may or may not be a similar number of vents on either surface of the cathode flow field plate 1130. In general, the vents may be provided on the front and back faces of both flow field plates. However, for two plated surfaces that face one another, it may often be sufficient to provide vent grooves on the face of only one of those plates. These vents 1242a-1245a and 1242r-1247r are also serrated which provides numerous benefits as previously described. In addition, these vents 1242a-1245a and 1242r-1247r as well as those on the anode flow field plate, may be slightly inset from the edge of the flow field plates 1130 and 1120 respectively, so that the regions of the flow field plate around the vents have some more structural rigidity to withstand the sealing process without cracking.

The rear face 1130r of the cathode flow field plate 1130 also includes a plurality of coolant flow channels 1250 that are connected to the apertures 1138 and 1139 that are associated with coolant flow. The coolant flow channels 1250 includes inlet distribution coolant flow channels 1250i, primary coolant flow channels 1250p and outlet collection distribution flow channels 1250o. The inlet distribution coolant flow channels 1250i are connected to the aperture 1138 and the outlet distribution coolant flow channels 1250o are connected to the aperture 1139.

In this exemplary embodiment, the rear side 1130r of the cathode flow field plate 1130 now incorporates all of the coolant flow channels and seal channels that were previously part of the passive side of the anode flow field plate 120 in the fuel cell stack 100. This relaxes the tolerances for aligning the passive side of a cathode flow field plate for one fuel cell and the passive side of an anode flow field plate for another fuel cell since all of the seal grooves and coolant channels are now only on one of the plates. Further, it will be understood that providing a flat face for at least one of the flow field plates has a number of advantages. For instance, it simplifies the design and production of that flow field plate and it greatly simplifies sealing arrangements and minimizes the requirements for accurate alignment of plates.

The coolant flow channels 1250 have been optimized for reduced pressure drop, increased heat transfer rate and improved flow distribution of the coolant. This is achieved by using a more symmetrical design for the coolant flow channels 1250. The primary coolant flow channels 1250p now extend along the entire longitudinal extent of the cathode flow field plate 1130 substantially parallel to the longitudinal edges of the cathode flow field plate 1130. For previous designs, the coolant flow channels bend and consisted of vertical and horizontal runs as can be seen in FIG. 8. In addition, the width of the grooves in the coolant flow channels 1250 may be 0.0625 inches with a depth of 0.015 inches and the width of the ribs in the coolant flow channels 1250 may be 0.108 inches. This provides a coolant flow channel density of approximately 6 channels per inch. As a result of the new configuration of the coolant flow channels 1250, there is now a better flow distribution of the coolant and more uniform cooling along the surface of the flow field plates 1120 and 1130. Previously, there were hot spots on the flow field plates which affected the performance of the fuel cell stack.

In an alternative, the passive side of the cathode flow field plate 1130 may not have seal grooves. Rather, the passive side of the cathode flow field plate 1130 is bonded, or otherwise attached, directly to the passive side of the anode flow field plate 1120. This is beneficial when dealing with very thin flow field plates and will also simplify quality check processes such as checking for plate leaks, porosity checks, etc. This also eliminates the potential for backside seal blockage due to flow field plate lifting.

The rear side 1130r of the cathode flow field plate 1130 may also have an increased number of support ribs for the backside feed channels. This can be easily seen by comparing FIGS. 8 and 27b. Further, the width of the support ribs has been optimized. One of the ribs associated with aperture 1136 is labeled 1252. In this exemplary embodiment, there are 16 ribs associated with the aperture 1136. In addition, an aperture extension 1254 exists for the aperture 1136 (this is also shown for aperture 1137 as rib 1252a and aperture extension 1254a). The number and the width of the ribs have been optimized for two reasons: 1) to improve the seal groove support during seal filling, and 2) to ensure that the front side feed channels line up with the backside feed channels to enhance fluid flow and reduce the pressure drop of the reactant gases. By aligning the channels in this manner, the flow of the reactant gas from the rear to the front of the flow field plate 1130 is improved; there is not as much turbulence. Accordingly, there is not as much of a pressure variation for the reactant gas as it flows from the rear of the cathode flow field plate 1130 to the front of the cathode flow field plate 1130.

The inventors have also found that increasing the number of ribs which provide the back-side feed channels results in a better flow distribution for the reactant gas; since there are more back-side feed channels, the distribution of gas across these channels is more normalized. Further, the single, long continuous slots 1236 and 1238 maintain this pressure distribution and ensure that the reactant gas delivered to the front side of the flow field plate retains the normalized pressure distribution. This has helped to improve the flow of the reactant gas to the reactant gas flow channels that are on the front face 1130f of the cathode flow field plate 1130. The increase in the number of ribs also ensures that the plates are more adequately supported in the backside feed area. This prevents leaking, flashing or plate breaking in this area.

Pressure drop refers to the difference in pressure experienced by the reactant gases in the aperture and the reactant gas flow channels. Previously, cracking was observed in the flow field plates near the backside feed channels. However, the addition of more ribs, while reducing the width of the ribs, has resulted in a reduction in cracks and small crossover leaks in this area during sealing. The use of more ribs also provides more structural support for certain components of the fuel cell such as the MEA; the increased number of ribs helps prevent the MEA from buckling during the seal-in-place process.

In this exemplary embodiment, the ribs in the backside feed channels may have a width of approximately 0.0785 inches and the backside feed channels may have a width of approximately 0.09 inches. This provides a backside flow channel density of approximately 6 channels per inch.

In addition, for both of the cathode and anode flow field plates 1120 and 1130, the depth of the gas diffusion recess is reduced to increase the compression of the GDM in all areas. The depth of the recess is selected to maintain a certain amount of compression on the GDM since this ensures that the gas diffusion and electrical conductivity properties of the GDM are optimal. The depth of the recess may be approximately 0.013 inches.

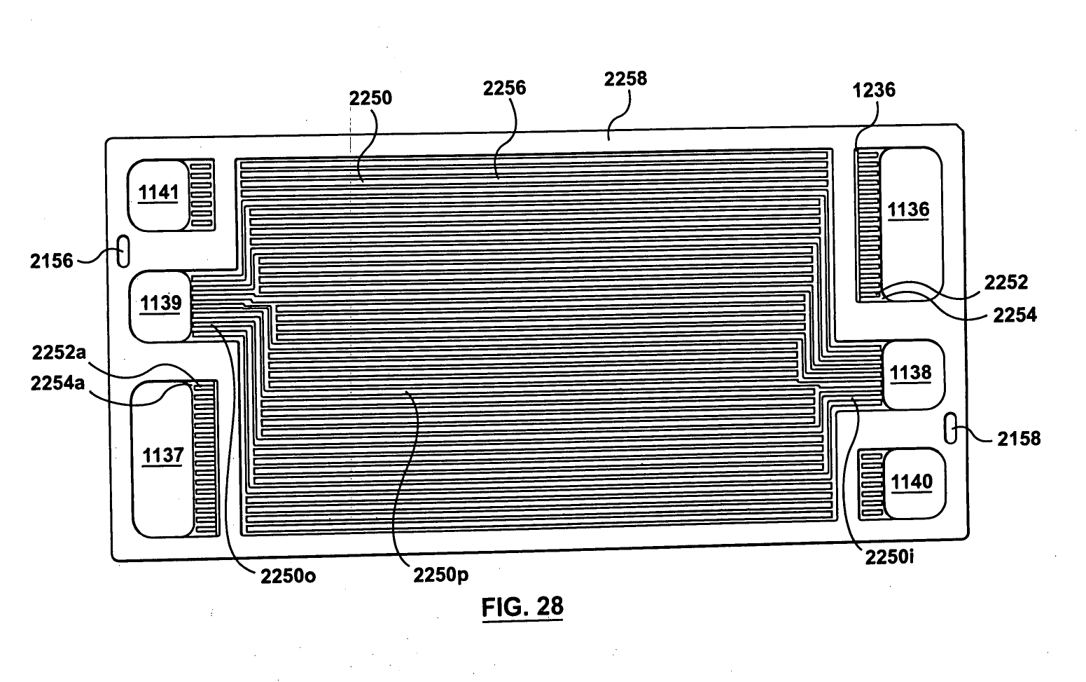

In an alternative, referring to FIG. 28, shown therein is another embodiment for the passive side 2130r of a cathode flow field plate 2130. The active side of the cathode flow field plate 2130 is not shown but may be similar to the active side of the cathode flow field plate 1130 shown in FIG. 28a. The passive side 2130r of the cathode flow field plate 2130 is similar to the passive side 1130r of cathode flow field plate 1130 except for the removal of the sealing groove network and the vents. Similar features on the rear surfaces of the cathode flow field plates 2130 and 1130 have been offset by 1000 in number.

The rear side 2130r of the cathode flow field plate 2130 does not require sealant material or gaskets for sealing. Rather, the rear side 2130r of the cathode flow field plate 2130 may be bonded to the rear side 1120r of an adjacent anode flow field plate since the rear side 1120r of the anode flow field plate 1120 is now flat. The ribs (only two of which are numbered 2252 and 2252a) in the backside feed channels and/or the ribs (only one of which is numbered 2256) of the coolant flow field channels 2250 may lie flush with the flat surface 2258 of the rear surface 2130r. Accordingly, distinct channels are made for reactant gas flow and coolant flow when the rear surface 2130r of the cathode flow field plate 2130 is bonded to the rear surface 1120r of the anode flow field plate 1120. Any suitable bonding or adhesive agent may be used. Alternatively, the ribs in the backside feed channels and/or the ribs of the coolant flow field channels 2250 may lie slightly lower than the flat surface 2258 of the rear surface 2130r. Accordingly, distinct back-side reactant gas flow channels and coolant flow field channels will be formed as well as a thin sheet of reactant gas and coolant fluid, respectively. This type of configuration also provides increased structural strength for the flow field plates.

There is a general methodology which can be used for implementing the Seal-In-Place process for constructing a fuel cell stack. To begin with, a Stack Identification Document (SID) can be created to identify the design parameters and testing protocols for the fuel cell stack. The corresponding fuel cell stack is labeled in accordance with the SID. Fuel cell components are then fabricated, or selected from prefabricated components, according to the SID. This includes using materials indicated by the SID, and verifying the dimensions of the fuel cell components. The fuel cell components may then be assembled into kits according to component type, such as anode flow field plate for example. The kits can then be used in an orderly fashion to construct the fuel cell stack. The fuel cell components can be cleaned prior to being assembled into kits. Cleaning involves washing the fuel cell components with an appropriate cleanser such as using soap with water and possibly adding a degreaser as required. The components are then rinsed using deionized water or isopropyl alcohol. The cleansed components may have a release agent applied to them as explained above if desired.

Construction of the fuel cell stack begins by affixing alignment bars to an anode end plate for aligning the fuel cell components as the fuel cell stack is built. The various fuel cell components are then sequentially stacked on top of the anode end plate. When the components for one fuel cell have been assembled, the components of the next fuel cell are rotated 180 degrees to negate tolerance issues. If this was not done, then the height of the fuel cell stack may be skewed towards one end since the flow field plates are most likely not completely parallel to one another which will affect the seal in place process, if used, as well as the operation of the fuel cell stack since leaks are more likely to occur. Once all of the fuel cell components have been stacked on the anode end plate, stack compression tie rods are then inserted through the appropriate apertures in the stack and then hand tightened to ensure that all of the components are held together. The height of the fuel cell stack may then be measured. Calipers that are calibrated to 1/1000^{th} of an inch may be used for the measurement. The measured height is recorded as the pre-compression stack height.

The fuel cell stack is then compressed by a desired amount by placing the fuel cell stack on a suitable press such as a hydraulic, Enerpac press, and centering the fuel cell stack on the press. Blocks are then applied to the cathode end plate, which includes the ports, and a load cell is applied to the stacked assembly of blocks to measure the amount of compression that is applied to the fuel cell stack. The fuel cell stack and the assembly of blocks is then centered below the cylinder pivot foot of the press and the fuel cell stack is then compressed by the desired amount. For example, the stack may be under a compression of 8 US tons However, the amount of applied compression depends on the surface of the fuel cell stack or the active area of the flow field plates. The larger the area, the higher the tonnage required to achieve the desired compression/loading. Typically 150-200 psi of loading on the active area is desired for good compression of the GDM (and gasket seals if the SIP process is not used). Cylinder and hand pumps may then applied to the ends of the fuel cell stack and locked to maintain the applied compression. Bolts may also applied to the fuel cell stack to maintain the desired amount of compression. The amount of torque applied to the bolts may be 25 inch-pounds. The height of the fuel cell stack is then taken after compression and recorded as the compressed pre-sealed stack height.

The compressed fuel cell stack is now ready to receive the sealant material. Prior to the injection of the seal material, the seal material is allowed to reach room temperature (i.e. approximately 22° C.). A static mixer, that is part of an injection machine, is filled with component A and component B seal material which may or may not include the release agent (see above for examples of component A and component B seal materials). To prepare for injection of the seal material, injection fittings are applied to the fuel cell stack and injection lines are connected to the injection machine. A pressure transducer is also affixed between the static mixer and the injection lines to monitor the injection pressure.

The stack injection lines are then purged with component A and component B seal material. The component A and B materials are preferably mixed in a 1:1 mixture. The injection machine is then set to manual mode and the injection line is continually purged until the seal material becomes a consistent grey color. This indicates that the seal material is uniform/homogenous. The amount of seal material that is used to seal the fuel cell stack is referred to as a shot size. For example, a shot size of approximately 600 grams may be used to seal a fuel cell stack. The shot size depends on the size of the fuel cell stack that must be sealed. The shot size also affects the seal time. For instance, it is possible to go from a sealing time of 20 minutes to 1.5 minutes by appropriately selecting the shot size. It is also possible to select a lower viscosity sealing solution to optimize the sealing time. Sealing time also depends on the stack size. Current sealing times for a 10 cell fuel stack is about 6 minutes and for a 60 cell fuel stack is about 8 minutes with a lower viscosity seal material. In addition, proper mixing of the component A and B materials is needed so that the seal material properly cures once inserted into the fuel cell stack.

Once the purging is complete, the injection lines are connected to the injection fittings on the fuel cell stack. Water grade Teflon tape may be applied to the injection lines to prevent seal material from escaping from any leaks at the point where the injection lines connect to the injection fittings. Injection of the seal material may then commence. At this point, the injection machine is switched to auto mode. It should be noted that it should be sufficient to perform the purging process once on per day if not too much time elapses between injections for consecutive fuel cell stacks.

At the beginning of the seal-in-place process, the injection machine is placed on “start auto cycle” and the time that is needed to reach a desired injection pressure is noted. For example, the desired injection pressure may be selected within the range of 50 to 300 psig. The selected injection pressure depends on the size of the fuel cell stack. The injection pressure is also selected based on the pre-seal compression maintained on the fuel cell stack since if the injection pressure is selected to be higher than the amount of compression, then the fuel cell components may move apart and there may be flashing of the seal material.

A number of time durations are recorded during the seal-fill process to monitor the sealing of the fuel cell stack. For instance, the amount of time that is needed to fill the entire fuel cell stack with the seal material is recorded. In addition, the amount of time that is required for the seal material to reach certain passive and active vents is recorded. This is done to determine if the fuel cell stack is being filled at a uniform rate. For instance, the fuel cell stack may be sectioned into quarters and the amount of time needed to fill each quarter of the fuel cell stack can be recorded. During this step, observations may be made at various internal points in the fuel cell stack, through the manifold, to determine if there are any problem areas. This includes determining whether there is any flashing in certain areas, whether there are any misalignments of fuel cell components, whether there are any injection pressure spikes or machine stoppages due to over-pressure conditions, etc. Pressure spikes may occur when multiple fronts of seal material meet one another on a give plate during the sealing process. If an over-pressure condition occurs, then this creates an Auto Cycle stoppage for the injection machine and the shot size is reset to zero. Accordingly, when the injection machine is started again, the short size must be reset to the correct setting.

Once the filling process is complete, the “Stop Auto Cycle” button is pressed on the injection machine and the injection shot size is recorded. At this point, once the injection pressure reaches 0 psig on the mixer pressure gauge, the injection lines are removed from the fuel stack injection fittings. The height of the fuel cell stack is then recorded while the fuel cell stack is still under compression of the press. This measurement is referred to as the first post-sealing stack height. The tie rods of the fuel cell stack are then torqued concurrently in a diagonal, cross-torquing fashion by alternating torque wrenches on the second round to 50 inch-pounds for both rounds. At this point, the height of the fuel cell stack is recorded again with the press still applying compression. This measurement is referred to as the second post-sealing stack height.

The compression applied to the fuel cell stack is then removed. This involves slowly opening the cylinder valves of the press followed by slowly opening the hand pump valve on the press. Both of these steps are done slowly to carefully remove the compression that had been previously applied to the fuel cell stack. The load cell and the compression block assemblies are then removed. The fuel cell stack height is recorded once again while the fuel cell stack has no load applied to it. This measurement is referred to as the third post-sealing stack height.

The fuel cell stack is then placed in an oven that is pre-heated to an appropriate temperature. The fuel cell stack remains in the oven for a sufficient amount of time. In one example, the oven was pre-heated to 80° C. and the stack was placed in the oven for approximately 4 hours. However, this amount of time can be drastically reduced to several minutes at room temperature if all of the inhibitor is removed from the silicone seal material components. The inhibitor is used to prevent the mixture of the seal material components from hardening or curing within the static mixer.

At this time, the injection lines of the static mixer can be hooked up to another fuel cell stack for injection. If there are no further fuel cell stacks that need to be sealed, then the injection lines can be draped over a waste material pail and the injection machine switched to “manual mode”. The seal material can then be purged until the material flows to a solid white color which indicates that the component A or B material is in its “pure” state; i.e. it is not mixed and therefore won't cure. This will prevent the mixer and the injection lines from clogging with hardened mixed material. The static mixer can then be disconnected from the mixing manifold and the pressure transducer can be removed from the static mixer. The injection lines can then be capped. The static mixer may then be placed in a cool environment, such as a freezer, to prevent any further curing of any potentially mixed material in the static mixer. The pressure transducer may be kept in a safe location at room temperature.

Once the seal material in the fuel cell stack has cured, the fuel cell stack is removed from the oven with proper protection to avoid injury. The fuel cell stack may then be placed onto a rack to cool off. Once the fuel cell stack has reached room temperature, o-ring seals and quick connect fittings may be fastened to all of the ports on the exterior of the anode end plate.

The fuel cell stack may then be tested for leaks and operational performance. In one exemplary test procedure, the fuel cell stack may be connected to a leakage test machine, such as the HyAL (Hydrogenics Automated Leak) test machine. A leak test may then be conducted with an appropriate test fluid such as Ultra High Purity (UHP) Helium gas, for example. If leaks exist, then all leak rates are recorded. The leak test may also be repeated manually with UHP or High Purity Plus (HP+) Nitrogen, for example, to correlate the automated leak test information as well as to identify flow-through rate at a certain pressure such as 5 psig for example. While completing the leak rate portion of the manual test, SNOOP, which is a form of soapy water, may be used to identify any areas where an external leak is occurring. Some possible areas are the active and passive SIP vents or the region betweens the anode starter plate, the anode current collector plate, the insulator plates, the end plates, the cathode starter plate, the active side of the plates and the injection ports. Active vents are those vents that are on the active surface of a flow field plate and passive vents are those vents that are on the passive surface of a flow field plate.

At this point, the tie-rods on the fuel cell stack may be re-torqued with an appropriate amount of torque such as 85 inch-pounds, for example. The fuel cell stack height is recorded again and is referred to as the leak test stack height. At this time, the Helium and Nitrogen tests may be performed again to determine if new leaks have developed or whether the leaks identified previously are still present. This final procedure should eliminate all leaks from the fuel cell stack and permit operational testing.

Once the fuel cell stack is ready for operational testing, the ports are covered with an appropriate means, such as masking tape for example, to prevent contaminants from entering the fluid channels of the fuel cell stack. All ports and bus bars are then labeled so that electrical connections can be easily made to the fuel cell stack.

The fuel cell stack is then checked for shorts using a power supply and a single cell voltage harness. Shorting can also be checked with an open circuit voltage (OCV) test in which hydrogen and air is metered through the fuel cell stack and the OCV is measured.

At this point, the fuel cell stack is ready for performance testing on an appropriate test stand. The fuel cell stack is connected to the test stand, broken in which includes hydration of the membrane and catalyst layers of the MEA, and the performance of the fuel cell stack is then verified.

While the invention is described in relation to a proton exchange membrane (PEM) fuel cell, it should be understood that the invention has general applicability to any type of fuel or electrochemical cell. Thus, the invention could be applied to: fuel cells with alkali electrolytes; fuel cells with phosphoric acid electrolyte; high temperature fuel cells, e.g. fuel cells with a membrane similar to a proton exchange membrane but adapted to operate at around 200° C.; electrolyzers, and regenerative fuel cells. The invention can also be applied to electrochemical cell assemblies that use gaskets or a seal-in place process to provide sealing. Further, it should be understood by those skilled in the art, that various modifications can be made to the embodiments described and illustrated herein, without departing from the invention, the scope of which is defined in the appended claims.

It should also be noted that the embodiment of FIGS. 22-28 has been shown for exemplary purposes and that the dimensions, as well as other particular structural features of the embodiment, are not meant to limit the scope of the invention.

1. An electrochemical cell assembly comprising:
a) a plurality of separate elements;
b) at least one groove network extending through a portion of the electrochemical cell assembly and including at least one filling port for the at least one groove network; and,
c) a seal within the at least one groove network that has been formed in place after assembly of said separate elements, wherein the seal provides a barrier between at least two of said separate elements to define a chamber for a fluid for operation of the electrochemical cell,
wherein the at least one groove network comprises a plurality of closed groove segments, each of which comprises at least a groove segment in one of said separate elements that faces and is closed by another of said separate elements, the volume of the closed groove segments being substantially similar such that each of the groove segments fills at the same rate.

2. The electrochemical cell assembly of claim 1, wherein at least some of said closed groove segments each comprise a first groove segment in one of said separate elements offset from a corresponding groove segment in another of said separate elements.

3. The electrochemical cell assembly of any one of claims 1 or 2, which comprises a plurality of electrochemical cells, each of which comprises an anode flow field plate, a cathode flow field plate, a membrane electrode assembly including a proton exchange membrane and located between the anode and cathode flow field plates, a first gas diffusion layer between the anode flow field plate and the membrane electrode assembly and a second gas diffusion layer between the membrane electrode assembly and the cathode flow field plate, wherein at least the anode and cathode flow field plates define apertures for fuel, oxidant and optionally coolant flow and wherein each of the separate elements include a connection aperture to form connection ducts of the groove network extending through each electrochemical cell and connected to said at least one filling port, the groove network extending through the plurality of electrochemical cells, and wherein the seal has been formed by injection of a liquid elastomeric seal material and subsequent curing of the elastomeric seal material.

4. The electrochemical assembly of claim 3, wherein the separate elements include at a first end, an anode end plate, an anode insulator plate adjacent to the anode end plate, and an anode current collector plate adjacent to the anode insulator plate, and at a second end, a cathode end plate, a cathode insulator plate adjacent to the anode end plate and a cathode current collector plate adjacent to the cathode insulator plate, and wherein only one end plate includes connection ports for connection to reactant gases and optionally coolant, the other end being a dry end with the end plate, insulator plate and current collector plate at the dry end not requiring seal grooves.

5. The electrochemical assembly of claim 3, wherein the separate elements include at a first end, an anode end plate, an anode insulator plate adjacent to the anode end plate, and an anode current collector plate adjacent to the anode insulator plate, and at a second end, a cathode end plate, a cathode insulator plate adjacent to the anode end plate and a cathode current collector plate adjacent to the cathode insulator plate, and wherein both end plates include connection ports for connection to reactant gases and optionally coolant.

6. The electrochemical cell assembly of claim 3, wherein a reduced depth in the range of approximately 0.010 to 0.0125 inches is selected for the seal grooves for enabling the anode and cathode flow field plates to be reduced in thickness.

7. The electrochemical cell assembly of claim 4, wherein the thickness of the endplates is increased to at least approximately 1.5 inches for helping to maintain the flow field plates in parallel alignment with one another.

8. The electrochemical cell assembly of claim 3, wherein each of the anode and cathode flow field plates includes, at one end thereof, a first fuel aperture, a first oxidant aperture and optionally a first coolant aperture, and at the other end thereof, a second fuel aperture, a second oxidant aperture and optionally a second coolant aperture; wherein each of the anode and cathode flow field plates includes a first connection aperture at said one end and a second connection aperture at said other end for supply of material to form said seal.

9. The electrochemical cell assembly of claim 8, wherein the cathode flow field plate includes, on a rear face away from the membrane electrode assembly, a groove network portion including groove elements that extend around the fuel and oxidant apertures and that extend only partially around the coolant apertures, thereby to enable coolant to flow between the coolant apertures across the rear face thereof, and wherein a second groove network portion is provided on the front face of the cathode flow field plate and includes groove segments extending around at least the fuel and coolant apertures, the cathode flow field plate including a channel network, on the front face thereof, to distribute oxidant gas over the second gas diffusion layer, and wherein a third groove network portion is provided on the front face of the anode flow field plate and includes groove segments extending around at least the oxidant and coolant apertures, the anode flow field plate including a channel network, on the front face thereof, to distribute fuel gas over the first gas diffusion layer.

10. The electrochemical cell assembly of claim 9, wherein the front face of the anode flow field plate includes first vents extending between the third groove network and the exterior of the electrochemical cell assembly and being located close to an edge of the front of the anode flow field plate, at least one of the first vents located generally centrally but being offset from the midpoint of the anode flow field plate and at least one of the other first vents located slightly offset with respect to a vertical midline of at least one of the fuel and coolant apertures.

11. The electrochemical cell assembly of claim 9, wherein the rear face of the cathode flow field plate includes second vents extending between the first groove network and the exterior of the electrochemical cell assembly and being located close to an edge of the rear of the cathode flow field plate, with one of the second vents located generally centrally but being offset from the midpoint of the cathode flow field plate, another of the second vents located slightly offset with respect to the midpoint of one set of the fuel and coolant apertures and another of the other second vents located slightly offset with respect to the midpoint of the other set of fuel and coolant apertures.

12. The electrochemical cell assembly of claim 9, wherein the front face of the cathode flow field plate includes third vents extending between the second groove network and the exterior of the electrochemical cell assembly and being located close to an edge of the front of the cathode flow field plate but offset from the first vents, with one of the third vents located generally centrally but being offset from the midpoint of the cathode flow field plate, and another of the third vents located slightly offset with respect to the midpoint of one set of the fuel and coolant apertures.

13. The electrochemical cell assembly of any one of claims 10, 11 and 12, wherein at least one of the first vents, second vents and third vents is a serrated vent.

14. An electrochemical cell assembly comprising:
a) a plurality of separate elements;
b) at least one groove network extending through a portion of the electrochemical cell assembly and including at least one filling port for the at least one groove network; and,
c) a seal within the at least one groove network that has been formed in place after assembly of said separate elements, wherein the seal provides a barrier between at least two of said separate elements to define a chamber for a fluid for operation of the electrochemical cell,
wherein the at least one groove network comprises a plurality of closed groove segments including a first groove segment on one side of one of said separate elements offset from a corresponding groove segment on the other side of the one of said separate elements or a facing side of adjacent one of said separate elements.

15. The electrochemical cell assembly of claim 14, wherein the electrochemical cell assembly includes a flow field plate, wherein on one side of the flow field plate, a portion of the first groove segment extends along the inner perimeter of the flow field plate being spaced apart from the edge by a first distance, and on the other side of the flow field plate, a portion of the second groove segment extends along the inner perimeter of the flow field plate being spaced apart from the edge by a second distance, the first and second distances being different thereby providing the offset.

16. The electrochemical cell assembly of claim 14, wherein the electrochemical cell assembly includes a flow field plate having apertures for fuel, oxidant and optionally coolant flow, wherein on one side of the flow field plate, a portion of the first groove segment extends around at least some of the apertures with a perimeter spacing having a first set of values, and on the other side of the flow field plate, a portion of the second groove segment extends around at least some of the apertures with a perimeter spacing having a second set of values, the first set of values being different from the second set of values thereby providing the offset.

17. The electrochemical cell assembly of claim 16, wherein the first groove segment has a first groove junction separating adjacent apertures and the second groove segment has a corresponding second groove junction separating the adjacent apertures, the first groove junction being offset from the second groove junction.

18. The electrochemical cell assembly of claim 14, wherein the electrochemical cell assembly includes anode and cathode flow field plates both having apertures for fuel, oxidant and optionally coolant flow, wherein on one side of the anode flow field plate, the first groove segment includes a first groove junction separating adjacent apertures and on a facing side of the cathode flow field plate, the second groove segment includes a second groove junction separating corresponding adjacent apertures, wherein the first and second groove junctions are offset with respect to one another.

19. The electrochemical cell assembly of claim 18, wherein the first and second groove junctions have different widths.

20. The electrochemical cell assembly of claim 14, wherein the electrochemical cell assembly includes a flow field plate having apertures for fuel, oxidant and optionally coolant flow, wherein on one side of the flow field plate, the first groove segment includes a first groove junction separating adjacent apertures, the first groove junction having a rib extending from the edge of the flow field plate past the adjacent apertures to meet another portion of the first groove segment that encircles one of the adjacent apertures.

21. A flow field plate for an electrochemical cell assembly comprising:
a) at least two apertures for reactant gas flow;
b) reactant gas flow channels on a front face including inlet distribution channels, primary flow channels and outlet collection channels, the inlet distribution and outlet collection channels being connected by the primary flow channels; and,
c) a feed structure connecting the inlet distribution channels to one of the at least two apertures and the outlet collection channels to another of the at least two apertures,
wherein, the feed structure includes a plurality of backside feed channels located on the rear face of the flow field plate and a single slot from the front face to the rear face of the flow field plate, the plurality of backside feed channels extending from the single slot to a corresponding one of the at least two apertures and the inlet distribution channels extending from the primary flow channels to the single slot.

22. The flow field plate of claim 21, wherein the backside feed channels are aligned with the inlet distribution channels.

23. The flow field plate of claim 21, wherein the flow field plate is an anode flow field plate and the density of the primary flow channels is at least approximately 9 channels per inch.

24. The flow field plate of claim 21, wherein the flow field plate is a cathode flow field plate and the density of the primary flow channels is at least approximately 13 channels per inch.

25. The flow field plate of claim 21, wherein the rear face of the flow field plate includes coolant flow channels including inlet coolant distribution channels, primary coolant flow channels and outlet coolant collection channels, the inlet coolant distribution channels being connected to the primary coolant flow channels and an inlet coolant aperture and the outlet coolant collection channels being connected to the primary coolant flow channels and outlet coolant aperture, wherein the primary coolant flow channels extend substantially parallel to the longitudinal edges of the flow field plate.

26. The flow field plate of claim 25, wherein the density of the primary coolant flow channels is at least 6 channels per inch.

27. The flow field plate of claim 21, wherein there is a groove network extending along the front of the flow field plate for allowing a seal to be formed in place after assembly of the flow field plate into an electrochemical cell assembly, wherein the groove network includes seal groove portions that encloses the at least two apertures, and wherein ribs that form the backside feed channels are located under a side of the seal groove portion for providing support during sealing in place.

28. The flow field plate of claim 27, wherein the density of the ribs that form the backside feed channels is increased for providing extra support during sealing in place, the backside feed channels having a density of approximately at least 6 channels per inch.

29. An electrochemical cell assembly comprising an anode flow field plate and a cathode flow field plate, each of the flow field plates including:
a) at least two apertures for reactant gas flow;
b) reactant gas flow channels on a front face including inlet distribution channels, primary flow channels and outlet collection channels, the inlet distribution and outlet collection channels being connected by the primary flow channels; and,
c) a feed structure connecting the inlet distribution channels to one of the at least two apertures and the outlet collection channels to another of the at least two apertures,
wherein, for one of the flow field plates the feed structure includes a plurality of backside feed channels located on the rear face of the flow field plate and a first slot from the front face to the rear face of the one of the flow field plates, the plurality of backside feed channels extending from the slot to a corresponding one of the at least two apertures and one of the inlet distribution channels and outlet collection channels extending from the primary flow channels to the slot, and wherein for another of the flow field plates the feed structure includes a second slot and an aperture extension, the backside feed channels being provided by the one of the flow field plates.

30. The electrochemical cell assembly of claim 29, wherein the backside feed channels are aligned with the inlet distribution channels for the one of the flow field plates.
